(19) United States
(12) Patent Application Publication
(10) Pub. No.: US 2009/0254696 A1
(43) Pub. Date: Oct. 8, 2009

(54) SEMICONDUCTOR INTEGRATED CIRCUIT AND METHOD OF OPERATION FOR SEMICONDUCTOR INTEGRATED CIRCUIT

(75) Inventors: Hideo KASAI, Tokyo (JP); Masamichi Fujito, Tokyo (JP); Masayuki Hirasawa, Tokyo (JP)

Correspondence Address: MILES & STOCKBRIDGE PC, 1751 PINNACLE DRIVE, SUITE 500, MCLEAN, VA, 22102-3833, US

(73) Assignee: RENESAS TECHNOLOGY CORP.

(21) Appl. No.: 12/417,704

(22) Filed: Apr. 3, 2009

(30) Foreign Application Priority Data
Apr. 7, 2008 (JP) 2008-098847
Apr. 7, 2008 (JP) 2008-098848
Feb. 23, 2009 (JP) 2009-038804

(51) Int. Cl. G06F 12/02

(52) U.S. Cl. 711/103; 711/E12.008

(57) ABSTRACT

The semiconductor IC has a nonvolatile memory including twin cells, a selector, and a sense circuit. When complementary data are written into a pair of nonvolatile memory cells of each twin cell, the pair of nonvolatile memory cells is set to be in a written state where one cell of the pair is set to one of low and high threshold voltages, and the other is set to the other threshold voltage. When non-complementary data are written into a pair of nonvolatile memory cells, for example, the memory cells both take the low threshold voltage and are made blank. The selector includes switching elements. During the blank-check action, switching elements of the selector are controlled to ON state. Then, the first total current of the twin cells forced to flow into the first input terminal of the sense circuit commonly is compared with the reference signal on the second input terminal, whereby whether the twin cells have been written or blank can be detected at a high speed. As to a semiconductor nonvolatile memory such that complementary data are written into memory cells in memory cell pairs, the blank-check time can be shortened.

### CLAIM OF PRIORITY

The Present application claims priority from Japanese application JP 2008-098847 filed on Apr. 7, 2008, JP 2008-098848 filed on Apr. 7, 2008 and JP 2009-038804 filed on Feb. 23, 2009, the content of which is hereby incorporated by reference into this application.

### FIELD OF THE INVENTION

The present invention relates to a semiconductor integrated circuit and a method of operation therefore, and particularly it relates to a technique useful for increase in the speed of blank-check required for a semiconductor integrated circuit incorporating a semiconductor nonvolatile memory in which complementary data are written into a pair of memory cells, and a technique useful for suppressing the increase in the number of command issuances by CPU even with an increase in required blank-check size.

### BACKGROUND OF THE INVENTION

It is described in JP-A-2007-87441 that a differential detector is supplied with two currents of a pair of memory cell transistors of a nonvolatile memory through a switching means, whereby the differential detector is used to judge which of the two currents is larger, and made to output two states according to a result of the judgment. Also, it is described that the current of one of the two memory cell transistors is supplied to one input terminal of a sense amplifier through a switching means, and a reference current from a reference-current generator is supplied to the other input terminal of the sense amplifier, whereby the sense amplifier is used to make a judgment on read information.

Now, in JP-A-1-263997, it is described that complementary data are written into a pair of memory cells of a semiconductor nonvolatile memory at the time of data writing, and at the time of data read, the difference of the voltages of bit lines read from the two memory cells is amplified by a differential-amplification type sense amplifier to make a judgment of the read data. With the semiconductor nonvolatile memory, the verification just after data writing is performed by using the differential-amplification type sense amplifier which is used at the time of data read. At the time of verification by the differential-amplification type sense amplifier, a pull-up transistor connected to the sense line of the differential-amplification type sense amplifier, which is connected to the memory cell in a written state (State “0”), is brought to its off state by a write latch circuit which has held write data. Hence, the potential of the sense line to which the memory cell in a non-written state is connected is pulled up so that the difference in voltage between paired sense lines of the differential-amplification type sense amplifier is made smaller according to the difference in conductance gm between the transistor of the memory cell in the written state and the transistor of the memory cell in the non-written state. As a result, the criteria of the comparison for verification by the differential-amplification type sense amplifier is made more rigorous, and re-write is performed on a memory cell which is insufficient in the amount of writing.

### SUMMARY OF THE INVENTION

Prior to the invention, the inventors had been involved in the development of a nonvolatile memory incorporated in a microcomputer, which stores various software programs for CPU (Central Processing Unit) of the microcomputer and various data resulting from the execution of the programs by CPU. As to a data flash, which is a nonvolatile memory for storing data resulting from the execution of the programs, the number of times of data rewrite is much larger than that of a program flash, which is a nonvolatile memory for storing the programs. Therefore, in the development of a nonvolatile memory, it was necessary to reduce the deterioration of the data holding property resulting from the degradation of the data retention property owing to the fatigue of the nonvolatile flash memory cells of a data flash with a large number of times of rewrite. The inventors came to the idea of constructing a data flash according to the way as described in JP-A-1-263997, which includes writing complementary data into a pair of nonvolatile memory cells (constituting a twin cell) at the time of data writing, and using a differential-amplification type sense amplifier to read the complementary data written in the two nonvolatile memory cells at the time of data read.

In general, the threshold voltage of a transistor of nonvolatile flash memory cell, which is data written in the memory cell, gradually fluctuates with time because of the fatigue of the memory cell. In case that the fluctuation of the memory cell transistor's threshold voltage owing to the elapse of time exceeds a read reference value for data reading, data to be read at the time of data read can be false.

However, according to the way as described above, the difference between the threshold voltages of the transistors of two nonvolatile memory cells (of a twin cell), which are complementary data written into the two memory cells at the time of data writing, can be maintained even in case that the nonvolatile memory cells fatigues. Hence, even if the fatigue slightly shrinks the difference between the threshold voltages of the transistors of two memory cells (of a twin cell), the differential-amplification type sense amplifier can amplify the slightly shrunk threshold voltage difference correctly. As a result, correct read data can be output at the time of data read even if an increased number of times of rewrite causes the memory cells of the data flash to somewhat fatigue.

In addition, a write-verify action to verify whether or not the complementary data written into two nonvolatile memory cells (of a twin cell) at the time of data writing to the data flash are written correctly is required. For example, in case of writing complementary data “1” into two nonvolatile memory cells (of a twin cell), write data corresponding to a low threshold voltage and write data corresponding to a high threshold voltage, for example, will be written into one memory cell (positive cell) of the twin cell, and the other (negative cell) respectively. For verify of the write of complementary data “1”, it is necessary to verify whether the high threshold voltage corresponding to write data of the data “1” has been written into the other memory cell (negative cell). For verify of the write of complementary data “0”, it is likewise necessary to verify whether the threshold voltage corresponding to write data of the data “0” has been written into the one memory cell (positive cell). A write-verify reference voltage having a voltage level corresponding to the high threshold voltage is used for both the two types of verify. As to the nonvolatile memory data flash developed prior to the invention, the inventors reached the idea that a current from either the one memory cell or the other is supplied to one input terminal of a verify-sense amplifier, whereas a write-verify reference current is fed to the other input terminal of the verify-sense amplifier as described in JP-A-2007-87441.

Also, the data flash needs an initialize-erasing action (blank-erasing action), by which e.g. data of an erased state (erase data) corresponding to the low threshold voltage is written into both the two nonvolatile memory cells (of a twin cell) before data writing. The initialize-erasing action requires an erase-verify action to verify whether or not erase data of the low threshold voltage has been written into both the two nonvolatile memory cells (of a twin cell) correctly. For verify of the erase, an erase-verify reference voltage having a voltage level corresponding to the low threshold voltage. A current from either the one memory cell or the other is supplied to the one input terminal of the verify-sense amplifier, whereas a erase-verify reference current is fed to the other input terminal of the verify-sense amplifier.

Further, the data flash of this type needs a blank-check function to check, before execution of data write on a memory region with any address, where the already-written memory region in use ends, and where the not-yet-written memory region remaining initialized and erased starts. At the time of blank-check, it must be checked that both two nonvolatile memory cells (of a twin cell) to subsequently write complementary data into have held data of the low threshold voltage corresponding to write data of data “1” as in verify of the erase.

However, it must be checked at the time of such blank-check that both the two nonvolatile memory cells (of a twin cell) to subsequently write complementary data into have data of the low threshold voltage corresponding to the data of the erased state. For that, it is necessary to sequentially check two nonvolatile memory cells forming one twin cell on whether they have data of the low threshold voltage. As data of a write size of eight bytes is written into a flash memory used as a nonvolatile memory incorporated in the developed microcomputer, 64 twin cells storing data of the write size of eight bytes are sequentially checked on whether they have data of the low threshold voltage during the blank-check. Therefore, nonvolatile memory cells to the number of 128, i.e. 64 multiplied by 2, need to be checked sequentially. Also, the problem that as a region targeted for the blank-check inside the flash memory is enlarged like 8, 32, 1024 and 2048 bytes, the time taken for check of many nonvolatile memory cells, which is executed sequentially, reaches an enormous length was cleared up.

As to a microcomputer having CPU and a nonvolatile memory developed by the inventors prior to the invention, it was examined to incorporate therein a flash sequencer having a blank-check function.

FIG. 9 is a diagram for explaining the way the blank-check function is implemented in the microcomputer having CPU and a nonvolatile memory developed by the inventors prior to the invention.

The upper half of FIG. 9 shows the action of CPU, and the lower half shows the action of the flash sequencer and the internal action of the flash memory. As in FIG. 9, CPU first issues a blank-check command for performing a blank-check in the period 10, and CPU goes into a waiting state in the period 11. In response to the blank-check command issued by CPU in the period 10, the flash sequencer starts a blank-check action inside the flash memory in the period 12. Subsequently in the period 12, the supply of voltage for blank-check to many twin cells of a memory region of a nonvolatile memory array targeted for the blank-check in the flash memory is started, and then the many twin cells are stabilized in voltage/current. Thereafter in the period 13, data are read from the twin cells of a check size of eight bytes in the flash memory and put into an internal register with e.g. a capacity of eight bytes. Then, the twin cells representing the check size of eight bytes subjected to the blank-check are brought to a read state in the period 14 so that normal data read is allowed at any time. On other words, the twin cells representing the check size of eight bytes after the blank-check are stabilized in voltage/current in the read state in the period 14. Subsequently, in the period 15, blank-check-status information is generated from the blank-check data read into the internal register with a capacity of eight bytes. If all the twin cells with the check size of eight bytes are blank, the memory region of eight bytes has been initialized and erased. However, in case that twin cells representing the check size of eight bytes, even one cell is not blank, the memory region of eight bytes has been already written and in use. The blank-check-status information first produced in the period 15 can be verified by CPU in the period 16.

Then, CPU issues a subsequent blank-check command for performing a blank-check on a next memory region in the period 171. In the period 172, CPU goes into the waiting state. In response to the blank-check command issued by CPU in the period 171, the flash sequencer starts a blank-check action inside the flash memory in the period 173. That is, in the period 173, the supply of voltage for blank-check to many twin cells of the next memory region to go through a blank-check is started in the flash memory, and then the many twin cells are stabilized in voltage/current. Subsequently, in the period 174, data are read from the twin cells representing the check size of eight bytes in the flash memory and put into an internal register with e.g. a capacity of eight bytes. Thereafter, the twin cells representing the check size of eight bytes subjected to the blank-check are brought to a read state in the period 175 so that normal data read is allowed at any time. That is, the twin cells representing the check size of eight bytes after the blank-check are stabilized in voltage/current in the read state in the period 175. Subsequently, in the period 176, blank-check-status information is generated from the blank-check data read into an internal register with the capacity of eight bytes. The blank-check of twin cells contained in a memory region of a required check size can be conducted by repeating the action like this.

However, it has been found from the study by the inventors that the blank-check of twin cells according to the procedure has the problem that the number of times CPU issues the blank-check command is increased with a rise of a required blank-check size.

Also, it has been found from the study by the inventors that the blank-check of twin cells according to the procedure has the problem that the action period required for a blank-check of a given check size, e.g. eight bytes, is made longer. This is attributed to that the twin cell which has been blank-checked is brought to the read state so that normal data read can be conducted on the blank-checked twin cell at any time after blank-check data from the twin cell has been read into the internal register.

The invention was made by the inventors after the study prior to the invention as described above.

Therefore, it is the first object of the invention to shorten an action period required for the blank-check in regard to a semiconductor integrated circuit incorporating a semiconductor nonvolatile memory in which complementary data are written into a pair of memory cells.

Further, it is the second object of the invention to arrange a semiconductor integrated circuit incorporating a semiconductor nonvolatile memory in which complementary data are written into a pair of memory cells so that the number of command issues by CPU is never increased even if a required blank-check size is increased.

The above and other objects of the invention and novel features thereof will be apparent from the description hereof and the accompanying drawings.

Of embodiments of the invention herein disclosed, preferred ones will be described below in brief.

To achieve the first object, a semiconductor integrated circuit according to a preferred embodiment of the invention, hereinafter referred to as “first aspect”, has at least a first nonvolatile memory (DFL; 21) including a plurality of twin cells, a selector (SEL_BC), and a sense circuit (BC_SA) (see FIG. 7).

The first nonvolatile memory is arranged so that complementary data are electrically written into a pair of nonvolatile memory cells (MC1, MC2) forming one twin cell, whereby the pair of nonvolatile memory cells (MC1, MC2) is set to be in a written state where one memory cell of the pair takes one of a combination of low and high threshold voltages and the other cell takes the other threshold voltage.

When electrically writing non-complementary data into each twin cell of the first nonvolatile memory before electrically writing complementary data into the twin cell, the twin cell is brought to a blank state, and one pair of nonvolatile memory cells (MC1, MC2) forming the twin cell is set to be in an erased state where the memory cells of the pair both take the low or high threshold voltage.

The selector (SEL_BC) includes a plurality of switching elements (Q_{SW1}-Q_{SW6}). The selector has a plurality of signal input terminals connected to the twin cells, and it has a plurality of signal output terminals commonly connected to a first input terminal (In1) of the sense circuit (BC_SA).

During a blank-check action, the switching elements of the selector are controlled to ON state, and currents of the twin cells flow into the first input terminal of the sense circuit in common.

During the blank-check action, a reference signal (Iref, Vref) is supplied to a second input terminal (In2) of the sense circuit. The reference signal is set to a level which enables a judgment on whether a first total current of the currents of the twin cells flowing into the first input terminal of the sense circuit comes from the written state resulting from the writing of complementary data or the erased state resulting from the writing of non-complementary data (see FIG. 7).

To achieve the second object, a semiconductor integrated circuit according to a preferred embodiment of the invention, hereinafter referred to as “second aspect”, has at least a first nonvolatile memory (DFL), and a control unit (7) electrically connected with the first nonvolatile memory (see FIG. 1).

The first nonvolatile memory is arranged so that complementary data can be electrically written into a pair of nonvolatile memory cells (MC1, MC2) in memory cell pairs. Before electrically writing the complementary data into the pair of nonvolatile memory cells, non-complementary data are electrically written into the pair of nonvolatile memory cells, thereby bringing the pair of nonvolatile memory cells to a blank state.

In response to a check request to the control unit (denoted by the numeral 20 of FIG. 10), the control unit is set to a blank-check action mode (in the period 22 of FIG. 10). The control unit set to the blank-check action mode controls a blank-check action for detecting presence of the blank state in the first nonvolatile memory (in the period 24 of FIG. 10).

In response to a cancel request to the control unit (denoted by the numeral 282 of FIG. 10), the control unit cancels the blank-check action mode (in the period 29 of FIG. 10). Between setting of the control unit to the blank-check action mode and the cancellation of the blank-check action mode, the control unit controls the blank-check action for a required memory size of the first nonvolatile memory (see FIGS. 1 and 10).

The effects offered by the preferred ones of the embodiments herein disclosed are as follows in brief.

According to the first aspect, the blank-check time can be shortened.

According to the second aspect, the number of command issues by CPU is never increased even in case that the required blank-check size is enlarged.

### BRIEF DESCRIPTION OF THE DRAWINGS

FIG. 1 is a diagram showing a configuration of a microcomputer according to an embodiment of the invention;

FIG. 2 is a diagram showing a configuration of a data flash included in a flash memory module incorporated in the microcomputer shown in FIG. 1;

FIG. 3 is a diagram showing a configuration of the program flash included in the flash memory module incorporated in the microcomputer shown in FIG. 1;

FIG. 4A is a diagram showing a configuration of the nonvolatile memory cells included in the data flash shown in FIG. 2, and the nonvolatile memory cells included in the program flash shown in FIG. 3, provided that complementary data of one bit are written into the data flash memory cells in memory cell pairs, whereas a single piece of data of one bit is written into each memory cell of the program flash. FIG. 4B is a diagram for explaining actions in connection with the nonvolatile memory cells of the data flash and program flash;

FIGS. 5A-5C are diagrams for explaining three states of each twin cell composed of a pair of nonvolatile memory cells, which are included in the data flash shown in FIG. 2 and which complementary data of one bit are written into;

FIGS. 6A and 6B are diagrams for explaining two states of the nonvolatile memory cell which is included in the program flash shown in FIG. 3 and which a single piece of data of one bit is written into;

FIG. 7 is a diagram showing a configuration of a blank-check circuit for judging, in parallel, threshold voltages of eight twin cells storing complementary data of one byte in the blank-check of the data flash DFL shown in FIG. 2;

FIG. 8 is a diagram showing another configuration of the blank-check circuit for judging, in parallel, threshold voltages of eight twin cells storing complementary data of one byte in the blank-check of the data flash DFL shown in FIG. 2;

FIG. 9 is a diagram showing the way the blank-check function is implemented in the microcomputer shown in FIG. 1 and having the flash memory module including the data flash on which the high-speed blank-check can be carried out by judging, in parallel, threshold voltages of the eight twin cells of FIG. 7 or 8;

FIG. 10 is a diagram for explaining the way the improved blank-check function which never increases in the number of command issuances is implemented in the microcomputer with a flash memory module shown in FIG. 1, provided that a high-speed blank-check according to parallel judgments of threshold voltages of eight twin cells is performed on the data flash included in the flash memory module as in the case of FIG. 9;

FIG. 11 is a diagram showing an arrangement of various types of data stored in the data flash of the flash memory module incorporated in the microcomputer shown in FIG. 1;

FIG. 12 is a flowchart showing a process flow for executing the blank-check for the various types of data shown in FIG. 11;

FIG. 13 is a diagram showing a configuration of the flash sequencer suitable to execute the blank-check according to the process flow shown in FIG. 12;

FIG. 14 is a diagram for explaining actions of the flash sequencer shown in FIG. 13, showing waveforms in the parts of the flash sequencer;

FIG. 15 is a diagram for explaining how the locations of the data flash and program flash are set appropriately in the flash memory module of MCU of FIG. 1;

FIG. 16 is a diagram showing the way a verify reference level is produced by the reference cell and then supplied to the sense amplifier of the data flash during the verify read on the data flash of FIG. 2;

FIG. 17 is a diagram showing the way the verify reference level is produced by the reference cell and then supplied to the sense amplifier of the program flash during the verify read on the program flash of FIG. 3;

FIG. 18 is a diagram showing other arrangement of various types of data stored in the data flash of the flash memory module incorporated in the microcomputer shown in FIG. 1;

FIG. 19 is a flowchart showing a process flow for executing the blank-check on the middle portions of data as shown in FIG. 18 in blank state;

FIG. 20 is a diagram showing a configuration of the flash sequencer suitable to execute the blank-check according to the process flow shown in FIG. 19; and

FIG. 21 is a diagram showing a configuration of the flash sequencer 7 suitable to handle blank-checks on two or more types of data as shown in FIG. 11 in one blank-check process.

### DETAILED DESCRIPTION OF THE PREFERRED EMBODIMENTS

### Summary of the Preferred Embodiments

First, the preferred embodiments of the invention herein disclosed will be outlined. Here, the reference characters or signs and numerals to refer to the drawings, which are accompanied with paired round brackets, only exemplify what the concepts of components referred to by the characters or signs and numerals contain.

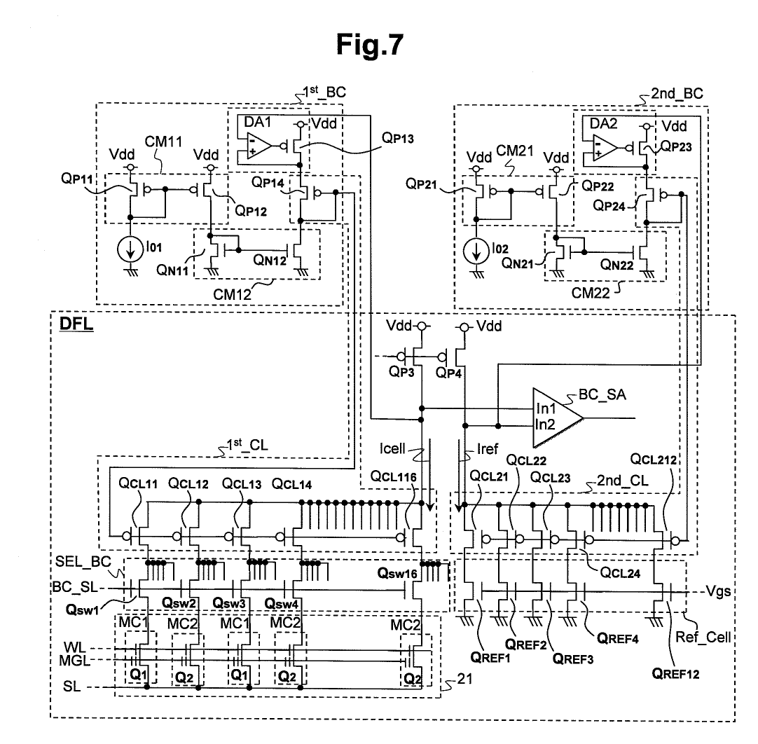

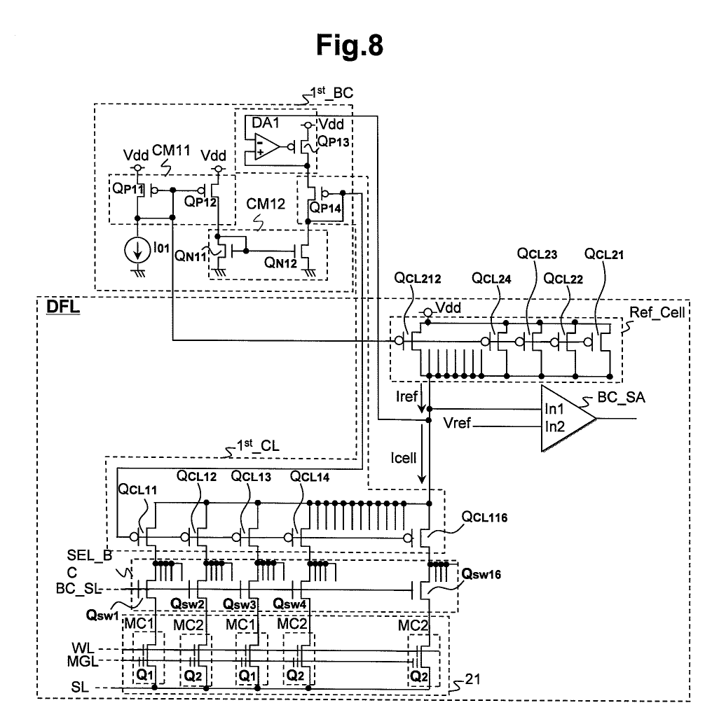

### 1. First Aspect

[1] A semiconductor integrated circuit according to a preferred embodiment of the invention has at least a first nonvolatile memory (DFL; 21) including a plurality of twin cells, a selector (SEL_BC), and a sense circuit (BC_SA) (see FIG. 7).

The first nonvolatile memory is arranged so that complementary data can be electrically written into a pair of nonvolatile memory cells (MC1, MC2) in memory cell pairs each forming one twin cell. When electrically writing the complementary data into each twin cell of the first nonvolatile memory, the pair of nonvolatile memory cells (MC1, MC2) forming one twin cell is set to be in the written state where one memory cell of the pair takes one of a combination of low and high threshold voltages and the other cell takes the other threshold voltage.

Before electrically writing complementary data into each twin cell of the first nonvolatile memory, the twin cell can be brought to a blank state by electrically writing non-complementary data into the twin cell. When electrically writing non-complementary data into each twin cell of the first nonvolatile memory, one pair of nonvolatile memory cells (MC1, MC2) forming the twin cell is set to be in an erased state where both the cells of the pair take the low or high threshold voltage.

The selector (SEL_BC) includes a plurality of signal input terminals, a common control input terminal (BC_SL), a plurality of output terminals, and a plurality of switching elements (Q_{SW1}-Q_{SW6}) connected between the signal input terminals and signal output terminals. The signal input terminals of the selector are connected to the twin cells of the first nonvolatile memory (DFL; 21), and the signal output terminals of the selector are connected to a first input terminal (In1) of the sense circuit (BC_SA) in common.

Use of the selector and sense circuit enables the execution of a blank-check action for detecting presence of the blank state of each twin cell of the first nonvolatile memory.

During the blank-check action, the switching elements of the selector are controlled to ON state in response to a select signal supplied to the common control input terminal, whereby currents of the twin cells of the first nonvolatile memory flow into the first input terminal of the sense circuit in common.

During the blank-check action, a reference signal (Iref, Vref) is supplied to a second input terminal (In2) of the sense circuit. The reference signal (Iref, Vref) is set to a level which enables a judgment on whether a first total current of the currents of the twin cells of the first nonvolatile memory flowing into the first input terminal of the sense circuit in common comes from the written state resulting from the writing of complementary data or the erased state resulting from the writing of non-complementary data (see FIG. 7).

According to the above embodiment, either the written state resulting from the writing of complementary data or the erased state resulting from the writing of non-complementary data is judged from the first total current of currents of the twin cells of the first nonvolatile memory, which flow into the first input terminal of the sense circuit in common, and therefore the blank-check time can be shortened.

According to a preferred embodiment, the semiconductor integrated circuit further has a first current limiter (1^{st}_CL) including a plurality of first current-limit transistors (Q_{CL11}-Q_{CL116}) with their limit currents set to a first predetermined value. The first current-limit transistors of the first current limiter are connected between the signal output terminals of the selector and the first input terminal of the sense circuit.

According to the above embodiment, the first total current of currents of the twin cells of the first nonvolatile memory flowing into the first input terminal of the sense circuit in common can be set accurately even in case that the twin cells of the first nonvolatile memory vary in property.

According to a more preferred embodiment, the semiconductor integrated circuit further has a reference cell (Ref_Cell) including a plurality of reference transistors (Q_{REF1}-Q_{REF116}, Q_{CL21}-Q_{CL212}) with their currents set to a second predetermined value substantially equal to the first predetermined value. A second total current of currents of the reference transistors of the reference cell is set to a value between a value of the first total current in the written state resulting from the writing of complementary data and a value of the first total current in the erased state resulting from the writing of non-complementary data.

According to a more preferred embodiment, the semiconductor integrated circuit further has a second current limiter (2^{nd}_CL) including a plurality of second current-limit transistors (Q_{CL21}-Q_{CL212}) with their limit currents set to the second predetermined value. The second current-limit transistors (Q_{CL21}-Q_{CL212}) of the second current limiter are connected between the second input terminal (In2) of the sense circuit and the reference transistors (Q_{REF1}-Q_{PEF116}) of the reference cell (Ref_Cell) (see FIG. 7).

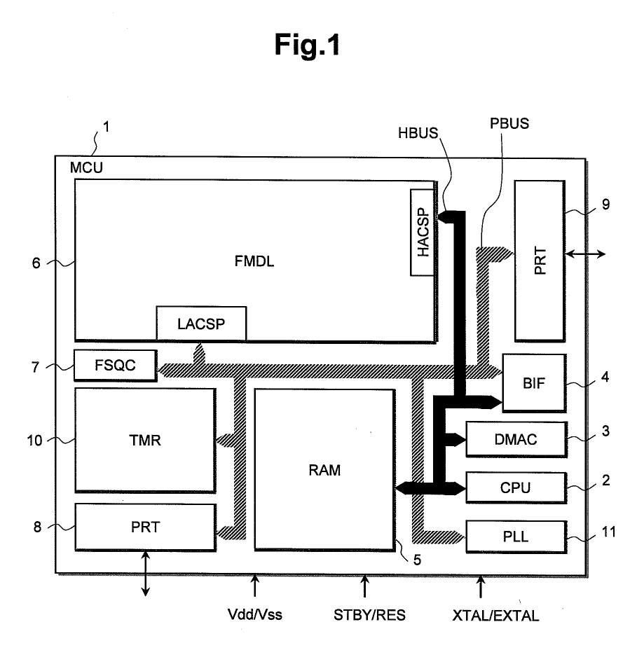

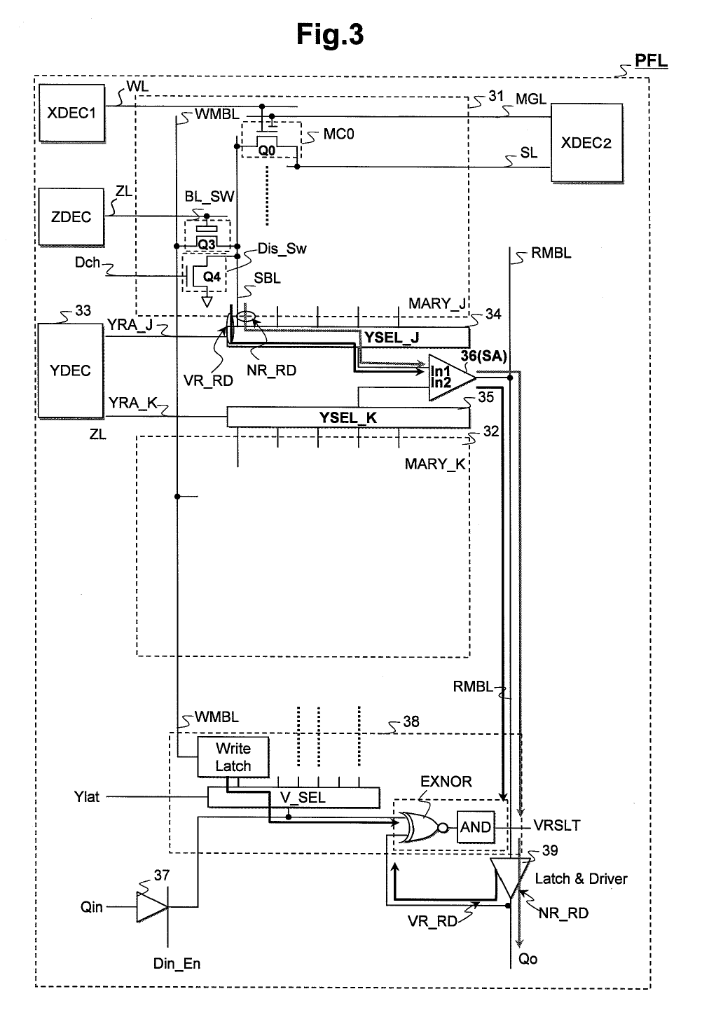

According to a preferred embodiment, the semiconductor integrated circuit further has at least a central processing unit (2) and a second nonvolatile memory (PFL) (see FIGS. 1 and 3).

The second nonvolatile memory is arranged so that data can be electrically written into nonvolatile memory cells (MC0) on a cell-by-cell basis (see FIG. 3).

A program for the central processing unit can be stored in the second nonvolatile memory (PFL).

After the central processing unit has executed a program stored in the second nonvolatile memory, data resulting from the execution can be stored in the first nonvolatile memory (DFL).

According to a more preferable embodiment, in the semiconductor integrated circuit, the first nonvolatile memory (DFL) and second nonvolatile memory (PFL) form a built-in nonvolatile memory (6).

The semiconductor integrated circuit further includes a built-in random access memory (5), a high-speed bus (HBUS), and a peripheral bus (PBUS).

The control unit (7) is connected to a low-speed access port (LACSP) of the built-in nonvolatile memory (6) through the peripheral bus.

The central processing unit is connected to the built-in random access memory, and a high-speed access port (HACSP) of the built-in nonvolatile memory through the high-speed bus.

The central processing unit can read out data stored in the first nonvolatile memory and a program stored in the second nonvolatile memory through the high-speed bus and the high-speed access port of the built-in nonvolatile memory.

In response to a direction from the central processing unit, the control unit (7) stores data, which is to be put in the first nonvolatile memory, and a program, which is to be put in the second nonvolatile memory, in the built-in nonvolatile memory through the low-speed bus and low-speed access port.

According to a specific embodiment, each cell of one pair of nonvolatile memory cells (MC1, MC2) of the first nonvolatile memory (DFL), and one nonvolatile memory cell (MC0) of the second nonvolatile memory (PFL) is arranged so that a nonvolatile storing action is conducted by injection of electrons into a charge-accumulating layer (SiN) and emission of electrons from the charge-accumulating layer.

According to another specific embodiment, a first nonvolatile storing action and a first verify-read action are repeated on one cell of each pair of nonvolatile memory cells in the first nonvolatile memory (DFL); a second nonvolatile storing action and a second verify-read action are repeated on each nonvolatile memory cell in the second nonvolatile memory (PFL).

According to a more specific embodiment, multivalued data of two bits or larger can be written into one nonvolatile memory cell of the second nonvolatile memory (PFL) electrically.

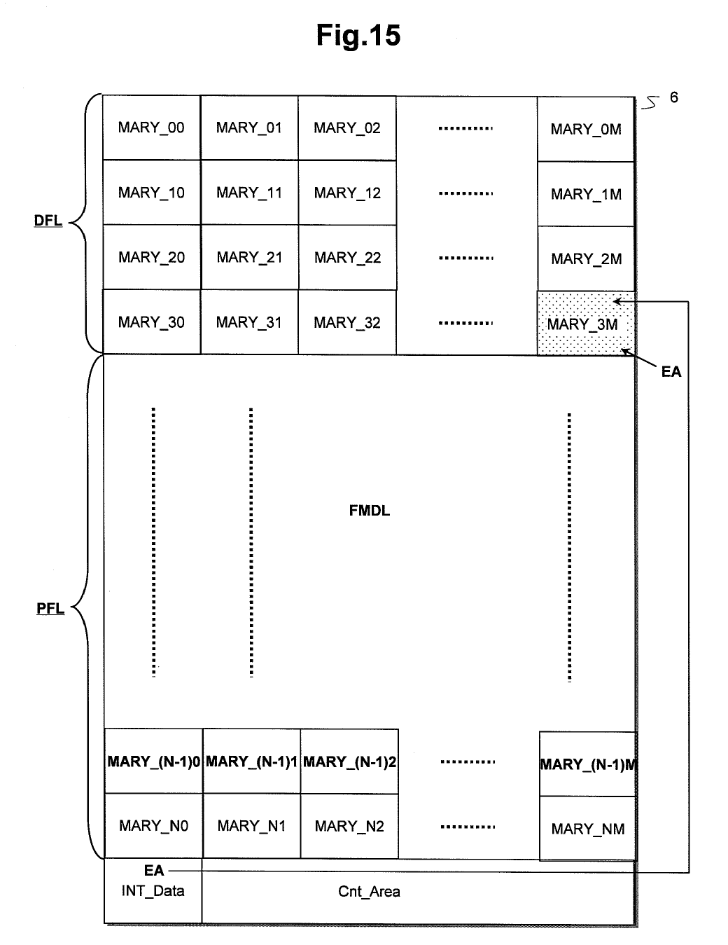

According to another specific embodiment, the location of the first nonvolatile memory (DFL), and the location of the second nonvolatile memory (PFL) in the built-in nonvolatile memory (6) can be set according to initialization-control-code data (INT_Data) used for system initialization of the semiconductor integrated circuit (see FIG. 15).

According to the most specific embodiment, the semiconductor integrated circuit is a microcomputer (see FIG. 1).

[2] A preferred embodiment based on another aspect of the invention provides a method of operation of a semiconductor integrated circuit having at least a first nonvolatile memory (DFL; 21) including a plurality of twin cells, a selector (SEL_BC), and a sense circuit (BC_SA) (see FIG. 7).

As to the first nonvolatile memory, complementary data can be electrically written into a pair of nonvolatile memory cells (MC1, MC2) forming each twin cell. When electrically writing the complementary data into each twin cell of the first nonvolatile memory, a pair of nonvolatile memory cells (MC1, MC2) forming the twin cell is set to be in the written state where one memory cell of the pair takes one of a combination of low and high threshold voltages and the other cell takes the other threshold voltage.

Before electrically writing the complementary data into each twin cell of the first nonvolatile memory, each twin cell can be made blank by electrically writing non-complementary data into the twin cell. By electrically writing the non-complementary data into each twin cell of the first nonvolatile memory, one pair of nonvolatile memory cells (MC1, MC2) forming the twin cell is set to be in an erased state, where both the cells have low or high threshold voltage.

The selector (SEL_BC) includes a plurality of signal input terminals, a common control input terminal (BC_SL), a plurality of output terminals, and a plurality of switching elements (Q_{SW1}-Q_{SW6}) connected between the signal input terminals and signal output terminals. The signal input terminals of the selector are connected with the twin cells of the first nonvolatile memory (DFL; 21), and the signal output terminals of the selector are connected with a first input terminal (In1) of the sense circuit (BC_SA) in common.

Use of the selector and sense circuit enables the execution of a blank-check action for detecting presence of the blank state of each twin cell of the first nonvolatile memory.

During the blank-check action, the switching elements of the selector are controlled to ON state in response to a select signal supplied to the common control input terminal, whereby currents of the twin cells of the first nonvolatile memory flow into the first input terminal of the sense circuit in common.

During the blank-check action, a reference signal (Iref, Vref) is supplied to a second input terminal (In2) of the sense circuit. The reference signal (Iref, Vref) is set to a level which enables a judgment on whether a first total current of the currents of the twin cells of the first nonvolatile memory flowing into the first input terminal of the sense circuit in common comes from the written state resulting from the writing of complementary data or the erased state resulting from the writing of non-complementary data (see FIG. 7).

According to the above embodiment, either the written state resulting from the writing of complementary data or the erased state resulting from the writing of non-complementary data is judged from the first total current of currents of the twin cells of the first nonvolatile memory, which flow into the first input terminal of the sense circuit in common, and therefore the blank-check time can be shortened.

### 2. Second Aspect

A semiconductor integrated circuit as a specific embodiment according to a preferred embodiment of the invention has at least a first nonvolatile memory (DFL) and a control unit (7) electrically connected with the first nonvolatile memory (see FIG. 1).

As to the first nonvolatile memory, complementary data can be electrically written into a pair of nonvolatile memory cells (MC1, MC2).

Before electrically writing the complementary data into the pair of nonvolatile memory cells, the pair of nonvolatile memory cells can be brought to a blank state by electrically writing non-complementary data into the pair of nonvolatile memory cells.

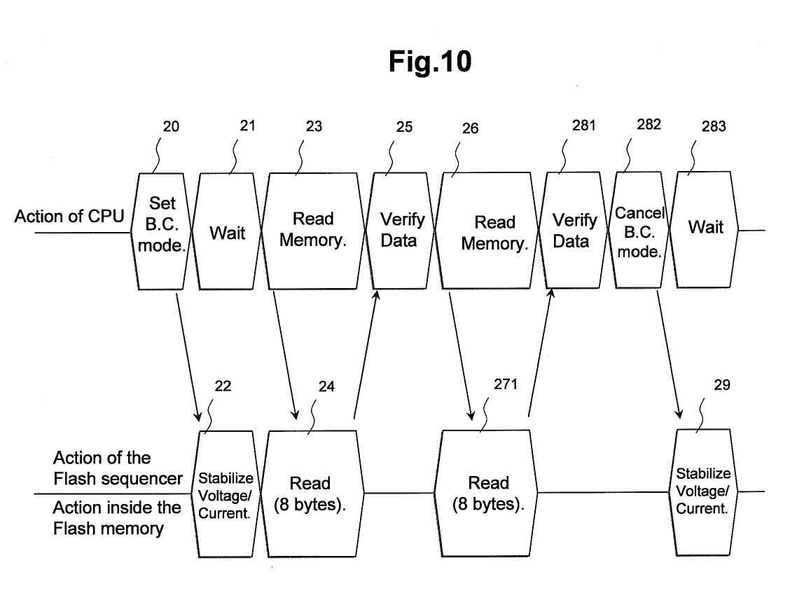

In response to a check request to the control unit (denoted by the numeral 20 of FIG. 10), the control unit is set to a blank-check action mode (in the period 22 of FIG. 10).

The control unit set to the blank-check action mode can control a blank-check action for detecting presence of the blank state in the first nonvolatile memory (in the period 24 of FIG. 10).

In response to a cancel request to the control unit (denoted by the numeral 282 of FIG. 10), the control unit cancels the blank-check action mode (in the period 29 of FIG. 10).

Between setting of the control unit to the blank-check action mode and the cancellation of the mode, the control unit controls the blank-check action on a portion of the first nonvolatile memory of a required memory size (see FIGS. 1 and 10).

According to the above embodiment, the number of command issues by CPU can be prevented from being increased even in case that the required blank-check size is enlarged.

According to a preferred embodiment, normal data read of the first nonvolatile memory is enabled after the cancellation of the blank-check action mode (in the period 29 of FIG. 10).

According to a more preferred embodiment, access information about a target region of the blank-check action in the first nonvolatile memory is set on the control unit before control of the blank-check action by the control unit (in the period 20 of FIG. 10).

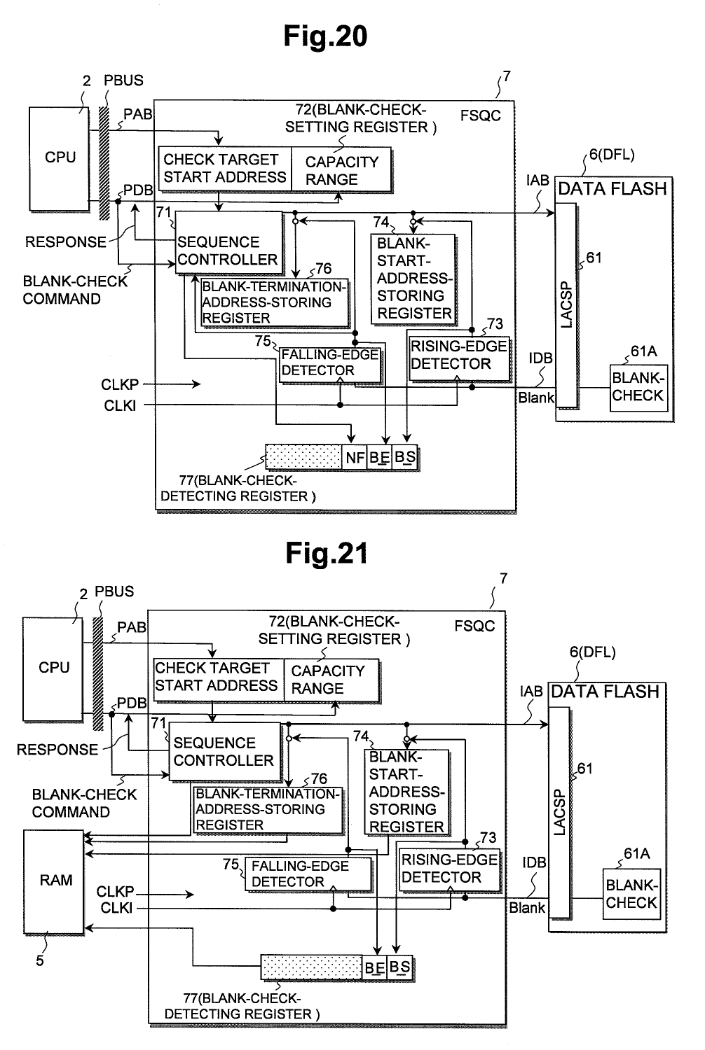

After setting of the access information on the control unit (in the period 20 of FIG. 20), the control unit starts the execution of the blank-check action on the target region of the first nonvolatile memory (in the period 22 of FIG. 10).

According to the more preferred embodiment, the blank-check action can be executed on any check target in the first nonvolatile memory. In addition, the blank-check action can be executed on a plurality of target regions in the first nonvolatile memory readily.

According to a still more preferred embodiment, the semiconductor integrated circuit further includes at least a central processing unit (2) and a second nonvolatile memory (PFL) (see FIG. 1).

The second nonvolatile memory is arranged so that data can be electrically written into nonvolatile memory cells (MC0) on a cell-by-cell basis.

A program for the central processing unit can be stored in the second nonvolatile memory (PFL).

After the central processing unit has executed a program stored in the second nonvolatile memory, data resulting from the execution can be stored in the first nonvolatile memory (DFL).

According to another still more preferred embodiment, in the semiconductor integrated circuit, the first nonvolatile memory (DFL) and second nonvolatile memory (PFL) form a built-in nonvolatile memory (6).

The semiconductor integrated circuit further includes a built-in random access memory (5), a high-speed bus (HBUS), and a peripheral bus (PBUS).

The control unit (7) is connected to a low-speed access port (LACSP) of the built-in nonvolatile memory (6) through the peripheral bus.

The central processing unit is connected to the built-in random access memory, and a high-speed access port (HACSP) of the built-in nonvolatile memory through the high-speed bus.

The central processing unit can read out data stored in the first nonvolatile memory and a program stored in the second nonvolatile memory through the high-speed bus and the high-speed access port of the built-in nonvolatile memory.

In response to a direction from the central processing unit, the control unit (7) stores data, which is to be put in the first nonvolatile memory, and a program, which is to be put in the second nonvolatile memory, in the built-in nonvolatile memory through the low-speed bus and low-speed access port.

According to a specific embodiment, each cell of one pair of nonvolatile memory cells (MC1, MC2) of the first nonvolatile memory (DFL), and one nonvolatile memory cell (MC0) of the second nonvolatile memory (PFL) is arranged so that a nonvolatile storing action is conducted by injection of electrons into a charge-accumulating layer (SiN) and emission of electrons from the charge-accumulating layer.

According to another specific embodiment, a first nonvolatile storing action and a first verify-read action are repeated on one cell of each pair of nonvolatile memory cells in the first nonvolatile memory (DFL); a second nonvolatile storing action and a second verify-read action are repeated on each nonvolatile memory cell in the second nonvolatile memory (PFL).

According to a more specific embodiment, multivalued data of two bits or larger can be written into one nonvolatile memory cell of the second nonvolatile memory (PFL) electrically.

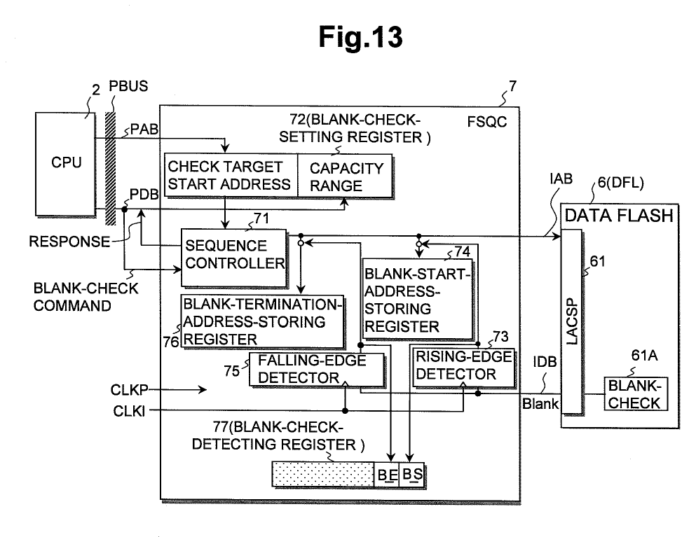

According to the most specific embodiment, the location of the first nonvolatile memory (DFL), and the location of the second nonvolatile memory (PFL) in the built-in nonvolatile memory (6) can be set according to initialization-control-code data (INT_Data) used for system initialization of the semiconductor integrated circuit (see FIG. 15).

[2] A semiconductor integrated circuit according to a preferred embodiment based on another aspect of the invention has at least a first nonvolatile memory (DFL), and a control unit (7) electrically connected with the first nonvolatile memory (see FIG. 13).

As to the first nonvolatile memory, complementary data can be electrically written into a pair of nonvolatile memory cells (MC1, MC2).

Before electrically writing the complementary data into the pair of nonvolatile memory cells, the pair of nonvolatile memory cells can be brought to a blank state by electrically writing non-complementary data into the pair of nonvolatile memory cells.

The control unit (7) includes a controller (71), a blank-check-setting register (72), blank-check-signal detector circuits (73, 75), and blank-address-storing registers (74, 76).

The controller (71) stores access information about a target region for the blank-check action in the first nonvolatile memory, which is supplied to the control unit, in the blank-check-setting register (72).

In response to a request to the control unit and the access information stored in the blank-check-setting register, the controller creates a blank-check address to be supplied to the first nonvolatile memory.

In the first nonvolatile memory, a blank-check action for detecting presence of a memory cell of the blank state is executed according to the blank-check address. The first nonvolatile memory keeps producing a blank-check signal (Blank) having a predetermined signal level while a memory cell of the blank state is present.

The blank-check signal produced in the first nonvolatile memory is supplied to the blank-check-signal detector circuit of the control unit.

In response to an output signal of the blank-check-signal detector circuit, address information of the nonvolatile memory cell of the blank state located in the target region for the blank-check action in the first nonvolatile memory is stored in the blank-address-storing register.

According to the above embodiment, the number of command issues by CPU can be prevented from being increased even in case that the required blank-check size is enlarged.

According to a preferred embodiment, the semiconductor integrated circuit further includes at least a central processing unit (2) and a second nonvolatile memory (PFL) (see FIG. 1).

As to the second nonvolatile memory, data can be written into one nonvolatile memory cell (MC0) electrically.

A program for the central processing unit can be stored in the second nonvolatile memory (PFL).

After the central processing unit has executed a program stored in the second nonvolatile memory, data resulting from the execution can be stored in the first nonvolatile memory (DFL).

According to a more preferred embodiment, in the semiconductor integrated circuit, the first nonvolatile memory (DFL) and second nonvolatile memory (PFL) form a built-in nonvolatile memory (6).

The semiconductor integrated circuit further includes a built-in random access memory (5), a high-speed bus (HBUS), and a peripheral bus (PBUS).

The control unit (7) is connected to a low-speed access port (LACSP) of the built-in nonvolatile memory (6) through the peripheral bus.

The central processing unit is connected to the built-in random access memory, and a high-speed access port (HACSP) of the built-in nonvolatile memory through the high-speed bus.

The central processing unit can read out data stored in the first nonvolatile memory and a program stored in the second nonvolatile memory through the high-speed bus and the high-speed access port of the built-in nonvolatile memory.

In response to a direction from the central processing unit, the control unit (7) stores data, which is to be put in the first nonvolatile memory, and a program, which is to be put in the second nonvolatile memory, in the built-in nonvolatile memory through the low-speed bus and low-speed access port.

According to a specific embodiment, each cell of one pair of nonvolatile memory cells (MC1, MC2) of the first nonvolatile memory (DFL) and one nonvolatile memory cell (MC0) of the second nonvolatile memory (PFL) is arranged so that a nonvolatile storing action is conducted by injection of electrons into a charge-accumulating layer (SiN) and emission of electrons from the charge-accumulating layer.

According to another specific embodiment, a first nonvolatile storing action and a first verify-read action are repeated on one cell of each pair of nonvolatile memory cells in the first nonvolatile memory (DFL); a second nonvolatile storing action and a second verify-read action are repeated on each nonvolatile memory cell in the second nonvolatile memory (PFL).

According to a more specific embodiment, multivalued data of two bits or larger can be written into one nonvolatile memory cell of the second nonvolatile memory (PFL) electrically.

According to the most specific embodiment, the location of the first nonvolatile memory (DFL), and the location of the second nonvolatile memory (PFL) in the built-in nonvolatile memory (6) can be set according to initialization-control-code data (INT_Data) used for system initialization of the semiconductor integrated circuit (see FIG. 15).

[3] A preferred embodiment based on another aspect of the invention offers a method of operation of a semiconductor integrated circuit having at least a first nonvolatile memory (DFL), and a control unit (7) electrically connected with the first nonvolatile memory (see FIG. 13).

As to the first nonvolatile memory, complementary data can be electrically written into a pair of nonvolatile memory cells (MC1, MC2).

Before electrically writing the complementary data into the pair of nonvolatile memory cells, the pair of nonvolatile memory cells can be brought to a blank state by electrically writing non-complementary data into the pair of nonvolatile memory cells.

The control unit (7) includes a controller (71), a blank-check-setting register (72), blank-check-signal detector circuits (73, 75), and blank-address-storing registers (72, 76).

The controller (71) stores access information about a target region for the blank-check action in the first nonvolatile memory, which is supplied to the control unit, in the blank-check-setting register (72).

In response to a request to the control unit and the access information stored in the blank-check-setting register, the controller creates a blank-check address to be supplied to the first nonvolatile memory.

In the first nonvolatile memory, a blank-check action for detecting presence of a memory cell of the blank state is executed according to the blank-check address. The first nonvolatile memory keeps producing a blank-check signal (Blank) having a predetermined signal level while a memory cell of the blank state is present.

The blank-check signal arising from the first nonvolatile memory is supplied to the blank-check-signal detector circuit of the control unit.

In response to an output signal of the blank-check-signal detector circuit, address information of the nonvolatile memory cell of the blank state located in the target region for the blank-check action in the first nonvolatile memory is stored in the blank-address-storing register.

According to the above embodiment, the number of command issues by CPU can be prevented from being increased even in case that the required blank-check size is enlarged.

### Further Detailed Description of the Preferred Embodiments

Next, the embodiments will be described further in detail. It is noted that as to all the drawings to which reference is made in describing the preferred embodiments, the parts or members having identical functions are identified by the same reference numeral, character or sign, and the repeated description thereof is avoided herein.

### 1. First Aspect

### <<Microcomputer>>

FIG. 1 is a diagram showing a configuration of a microcomputer (MCU) 1 according to an embodiment of the invention. The microcomputer 1 shown in FIG. 1 is formed in one semiconductor chip formed from monocrystalline silicon by a fine-structure CMOS semiconductor manufacturing process.

The microcomputer 1 has a two-hierarchical bus structure having a high-speed bus HBUS and a peripheral bus PBUS. The high-speed bus HBUS and peripheral bus PBUS each have a data bus, an address buss and a control bus. Thus separating the bus in the two-hierarchical bus structure, the load on the bus is lightened in comparison to the case of connecting all circuits to a common bus in common, whereby a high-speed access action is enabled.

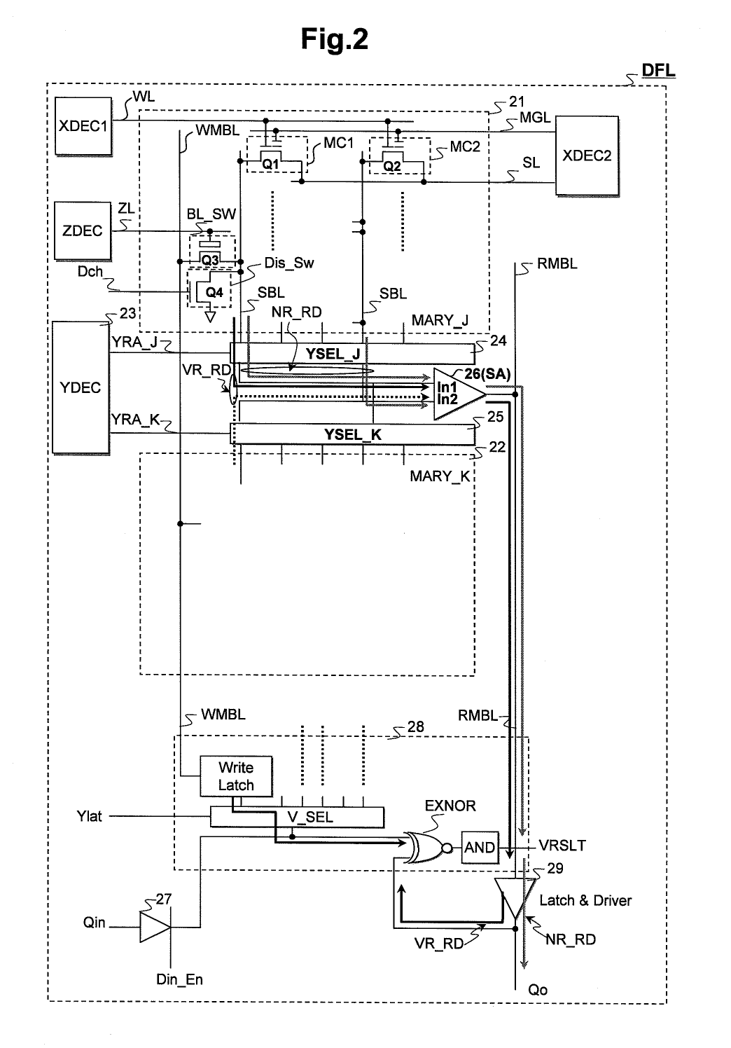

To the high-speed bus HBUS, a central processing unit (CPU) 2 which includes an instruction-control section and an execution section and executes an instruction, a direct memory access controller (DMAC) 3, and a bus interface circuit (BIF) 4 which performs bus-interface control or bus-bridge control of the high-speed bus HBUS and peripheral bus PBUS are connected. Further, to the high-speed bus HBUS, a random access memory (RAM) 5 used for a work region of the central processing unit 2, etc. and a flash memory module (FMDL) 6 serving as a nonvolatile memory module operable to store data and a program are connected. The flash memory module (FMDL) 6 includes a data flash DFL as shown in FIG. 2 and a program flash PFL as shown in FIG. 3. The program flash PFL stores various software program for the central processing unit (CPU) 2, whereas the data flash DFL stores various data resulting from the execution of the programs by the central processing unit (CPU) 2.

To the peripheral bus PBUS, a flash sequencer (FSQC) 7 operable to perform command access control for the flash memory module (FMDL) 6, externally input/output ports (PRT) 8 and 9, a timer (TMR) 10, and a phase-locked loop (PLL) 11 operable to produce an internal clock signal of a microcomputer are connected. To the clock terminal XTAL/EXTAL, an oscillator is connected, or an external clock signal is supplied. A standby-state-directing signal is supplied to the external hardware standby terminal STBY, and a reset-directing signal is supplied to the external reset terminal RES. An operation source voltage is supplied to between the external source terminal Vdd and external ground terminal Vss.

Herein, the flash sequencer 7 is designed as a logic circuit by logical synthesis, and the flash memory module 6 taking a memory array structure is designed with a CAD tool. Therefore, they are shown as separate circuit blocks in the drawing for the sake of convenience. However, the flash sequencer 7 and flash memory module 6 are substantially integrated into one flash memory. The flash memory module 6 is connected to the high-speed bus HBUS through the read-only, high-speed access port (HACSP). Hence, CPU 2 and DMAC 3 can access the flash memory module 6 for read through the high-speed bus HBUS and high-speed access port (HACSP). When accessing the flash memory module 6 for write and erase, CPU 2 and DMAC 3 issue commands to the flash sequencer 7 through the bus interface 4 and peripheral bus PBUS. In response to them, the flash sequencer 7 controls write and erasing actions on the flash memory module through the peripheral bus PBUS and low-speed access port (LACSP).

The program flash PFL in the flash memory module (FMDL) 6 includes a plurality of single cells, for which a one-cell-to-one-bit writing method by which a single piece of data of one bit is written into a nonvolatile memory forming each single cell is adopted. Hence, the program flash PFL with a small number of times of data rewrite, which is included in the flash memory module (FMDL) 6, is capable of storing various software programs for the central processing unit (CPU) 2 of the microcomputer (MCU) 1 at a high density.

The data flash DFL in the flash memory module (FMDL) 6 includes a plurality of twin cells, and complementary data can be written into a pair of nonvolatile memories forming each twin cell. In response to a direction (command) from CPU 2, the flash sequencer 7 conducts a nonvolatile storing action for write or erase on the data flash DFL and program flash PFL, both included in the flash memory module (FMDL) 6. In parallel, the flash sequencer 7 executes a blank-check action on the data flash DFL in response to a request from CPU 2. In other words, the flash sequencer 7 actually offers a blank-check function to check the twin cells up to which the data flash DFL included in the flash memory module (FMDL) 6 has been already written and in use, and the twin cells from which the data flash DFL has not been written yet and remains initialized and erased.

As described above, the flash sequencer 7 goes into the blank-check action mode in response to a request for a blank-check on the twin cells of the data flash DFL from CPU 2. According to a more preferred embodiment of the invention, before the shift to the blank-check action mode, the flash sequencer 7 is supplied with the start address and capacity (termination address) of a blank-check-target region by CPU2. Hence, it becomes easier to execute the blank-check action on a plurality of target regions in the data flash DFL. As a result, it becomes possible to conduct the blank-check action on any target region in the data flash DFL. Specifically, at the time of start of the blank-check action of the flash sequencer 7 after completion of the shift to the blank-check action mode, a blank-check on twin cells of between the start address and termination address of a blank-check-target region is started. During the blank-check action, the flash sequencer 7 supplies CPU with blank-check-status information based on blank-check data of twin cells of e.g. eight bytes form the data flash DFL in response to a memory-read request from CPU. In parallel, the flash sequencer 7 supplies CPU with subsequent blank-check-status information based on blank-check data of another eight bytes of twin cells from the data flash DFL in response to a subsequent memory-read request from CPU. In this way, after completion of the blank-check action on the twin cells of the data flash DFL of between the start address and termination address of the target region, CPU 2 issues a request for cancel of the blank-check action mode to the flash sequencer 7.

### <<Flash Memory Module>>

FIG. 2 is a diagram showing a configuration of the data flash DFL included in the flash memory module (FMDL) 6 incorporated in the microcomputer (MCU) 1 shown in FIG. 1.

Various data resulting from the execution of the programs by the central processing unit (CPU) 2 of the microcomputer (MCU) 1 as in FIG. 1 are stored in the data flash DFL of the flash memory module 6 shown in FIG. 2. To make it possible to read data correctly even in case that the data flash DFL as shown in FIG. 2 has been fatigued owing to a large number of times of data rewrite thereof, a two-cell-to-one-bit writing method by which complementary data of one bit are written into a twin cell composed of a pair of nonvolatile memory cells MC1 and MC2 is adopted for the data flash DFL as shown in FIG. 2.

FIG. 3 is a diagram showing a configuration of the program flash PFL included in the flash memory module (FMDL) 6 incorporated in the microcomputer (MCU) 1 shown in FIG. 1.

Various software programs for the central processing unit (CPU) 2 of the microcomputer (MCU) 1 shown in FIG. 1 are stored in the program flash PFL of the flash memory module 6 shown in FIG. 3. To enable high-density storing on the program flash PFL shown in FIG. 3 with a small number of times of data rewrite, a one-cell-to-one-bit writing method by which a single piece of data of one bit is written into one nonvolatile memory cell MC0 is adopted for the program flash PFL of FIG. 3.

### <<Nonvolatile Memory Cell>>

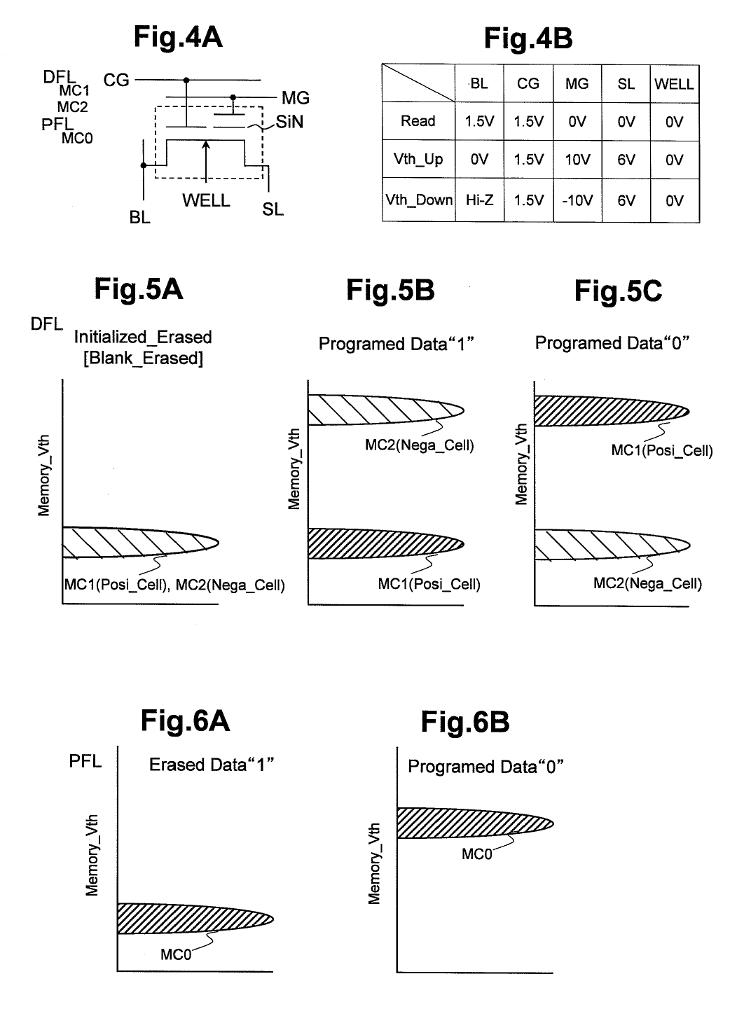

FIG. 4A is a diagram showing a configuration of the nonvolatile memory cells MC1 and MC2 included in the data flash DFL shown in FIG. 2, and the nonvolatile memory cells MC0 included in the program flash PFL shown in FIG. 3, provided that complementary data of one bit are written into the data flash memory cells in memory cell pairs, whereas a single piece of data of one bit is written into each memory cell of the program flash. FIG. 4B is a diagram for explaining an action of the nonvolatile memory cells MC1 and MC2 and nonvolatile memory cell MC0. FIG. 4B is a diagram for explaining actions in connection with the nonvolatile memory cells MC1 and MC2, and MC0.

As shown in FIG. 4A, the nonvolatile memory cells MC1 and MC2, and MC0 are each composed of a split-gate type flash memory device. This type of memory device has a control gate (CG) and a memory gate (MG) formed on a gate-insulating layer over a channel region between a source and a drain. A charge-trap region (SiN) of e.g. silicon nitride is formed between the memory gate (MG) and gate-insulating layer. The source or drain region on the side of the control gate (CG) is connected to a bit line (BL), whereas the source or drain region on the side of the memory gate (MG) is connected to a source line (SL).

Now, referring to FIG. 4B, how the various actions in connection with the nonvolatile memory cells shown in FIG. 4A are executed will be described.

First, to lower the threshold voltage (Vth) of the memory cell, the bit line voltage BL, control gate voltage CG, memory gate voltage MG, source line voltage SL, and well region's voltage WELL are set so as to meet the conditions of BL=Hi-Z (high impedance state), CG=1.5 volts, MG=−10 volts, SL=6 volts, and WELL=0 volt, whereby electrons are drawn from the charge-trap region (SiN) into the well region (WELL) by a high electric field between the well region (WELL) and memory gate MG. This is performed in groups of memory cells sharing one memory gate.

Second, to raise the threshold voltage (Vth) of the memory cell, the voltage conditions of BL=0 volt, CG=1.5 volts, MG=10 volts, SL=6 volts, and WELL=0 volt are set, thereby causing a write current to flow from the source line SL to the bit line BL. As a result, hot electrons arising in a boundary portion between the control gate and memory gate are injected into the charge-trap region (SiN). This can be controlled in bits because the electron injection depends on whether or not current is passed through the bit line.

Further, a read action is conducted under the conditions of BL=1.5 volts, CG=1.5 volts, MG=0 volt, SL=0 volt, and WELL=0 volt. The memory cell is turned on when the threshold voltage of the memory cell is low, whereas it is turned off when the threshold voltage is high. The nonvolatile memory cells MC1 and MC2, and MC0 are not limited to the split-gate type flash memory device as shown in FIG. 4A, and they may be stacked-gate flash memory devices. Such stacked-gate flash memory device is formed by stacking a floating gate (FG) and a control gate (WL) on a gate-insulating layer formed on the channel region between the source and drain regions. The threshold voltage can be raised by the hot-carrier-writing method or FN tunnel-writing method, whereas the threshold voltage can be lowered by electron emission into the well region (WELL) or bit line (BL).

### <<A Pair of Nonvolatile Memory Cells Included in the Data Flash>>

FIGS. 5A-5C are diagrams for explaining three states of each twin cell composed of a pair of nonvolatile memory cells MC1 and MC2 which are included in the data flash DFL shown in FIG. 2 and which complementary data of one bit are written into.

The states of information storage of a twin cell composed of a pair of nonvolatile memory cells MC1 (positive cell) and MC2 (negative cell), which complementary data of one bit are written into, are classified into the following three types: an initialized-and-erased state (blank-erased state) shown in FIG. 5A; a state of Programmed Data “1” shown in FIG. 5B; and a state of Programmed Data “0” shown in FIG. 5C.

The initialized-and-erased state of a twin cell composed of a pair of nonvolatile memory cells MC1 (positive cell) and MC2 (negative cell) of the data flash DFL shown in FIG. 5A can be materialized by lowering the threshold voltage (Vth) of the memory cells in groups of the memory cells sharing a memory gate (MG).

The state of Programmed Data “1” of a twin cell composed of a pair of nonvolatile memory cells MC1 and MC2 of the data flash DFL, which is shown in FIG. 5B, can be achieved by raising the threshold voltage (Vth) of the nonvolatile memory cell MC2 (negative cell) from the initialized-and-erased state shown in FIG. 5A under control on a bit-by-bit basis.

The state of Programmed Data “0” of a twin cell composed of a pair of nonvolatile memory cells MC1 and MC2 of the data flash DFL, which is shown in FIG. 5C, can be realized by raising the threshold voltage (Vth) of the nonvolatile memory cell MC1 (positive cell) from the initialized-and-erased state shown in FIG. 5A under control on a bit-by-bit basis.

### <<Nonvolatile Memory Cells Included in the Program Flash PFL>>

FIGS. 6A and 6B are diagrams for explaining two states of the nonvolatile memory cell MC0 which is included in the program flash PFL shown in FIG. 3 and which a single piece of data of one bit is written into.

The states of information storage of the nonvolatile memory cell MC0 which a single piece of data of one bit is written into are classified into the following two states: a state of Erased Data “1” shown in FIG. 6A; and a state of Programmed Data “0” shown in FIG. 6B.

The state of Erased Data “1” shown in FIG. 6A can be achieved by lowing memory cells' threshold voltage (Vth) in groups of memory cells sharing one memory gate (MG).

The state of Programmed Data “0” shown in FIG. 6B can be realized by raising the threshold voltage (Vth) of the nonvolatile memory cell MC0 from the state of Erased Data “1” shown in FIG. 6A under control on a bit-by-bit basis.

### <<Architecture of the Data Flash>>

Now, the architecture of the data flash DFL will be shown with reference to FIG. 2. The data flash DFL includes many twin cells each composed of one pair of nonvolatile memory cells MC1 and MC2, which complementary data of one bit are written into as described with reference to FIG. 5. In the data flash DFL, various data resulting from the execution of the programs by CPU 2 of MCU 1 as shown in FIG. 1 are stored.

The data flash DFL shown in FIG. 2 includes: a first nonvolatile memory array (MARY_J) 21; a second nonvolatile memory array (MARY_K) 22; a Y-decoder (YDEC) 23; a first Y-selector (YSEL_J) 24; a second Y-selector (YSEL_K) 25; and a sense amplifier (SA) 26. The data flash DFL further includes: a write-data-input buffer 27; a data-write-verify circuit 28; and a data-output-latch driver 29.

The first nonvolatile memory array (MARY_J) 21 and second nonvolatile memory array (MARY_K) 22 each include many twin cells, each composed of a pair of nonvolatile memory cells MC1 (positive cell) and MC 2 (negative cell), and therefore they can store various data resulting from the execution of programs by CPU 2. The control gates (CG), memory gates (MG) and sources of a pair of nonvolatile memory cells MC1 (positive cell) and MC2 (negative cell) arrayed in the X direction are connected to a word line (WL), a memory gate line (MGL) and a source line (SL), respectively.

To speed up data write and data read and lower power consumption, the layered-bit-line architecture is adopted for the first nonvolatile memory array (MARY_J) 21 and second nonvolatile memory array (MARY_K) 22. Specifically, a write main bit line WMBL and a read main bit line RMBL are connected to the first and second nonvolatile memory arrays (MARY_J and MARY_K) 21 and 22.

Sub-bit lines SBL connected to the nonvolatile memory cells MC1 and MC2 are each connected to the write main bit line WMBL through the source and drain of a switching MOS transistor Q3 of a bit line switch BL_SW. In case that data is written into the nonvolatile memory cell MC1 (positive cell), the switching MOS transistor Q3 of the bit line switch BL_SW between the sub-bit line SBL connected with the nonvolatile memory cell MC1 (positive cell) and the write main bit line WMBL is controlled through a control-signal line ZL into ON state. At the time of writing data into the data flash DFL shown in FIG. 2, the write data Qin is supplied to the write main bit line WMBL through the write-data-input buffer 27, a selector V_SEL of the data-write-verify circuit 28, and a write latch Write Latch. The write data supplied to the write main bit line WMBL is passed through the bit line switches BL_SW in each of the first and second nonvolatile memory arrays 21 and 22 and then written into the nonvolatile memory cell MC1 (positive cell) or nonvolatile memory cell MC2 (negative cell) of the data flash DFL. In MCU 1 shown in FIG. 1, the write data Qin provided to the write-data-input buffer 27 is supplied together with a write command to the data flash DFL of the flash memory module 6 from the flash sequencer 7 through the peripheral bus PBUS and low-speed access port (LACSP) in response to a write request from CPU 2.

The sub-bit lines SBL, to which the nonvolatile memory cells MC1 and MC2 of the first and second nonvolatile memory arrays (MARY_J and MARY_K) 21 and 22 are connected, are connected to the read main bit line RMBL through the first and second Y-selectors (YSEL_J and YSEL_K) 24 and 25, and the sense amplifier (SA) 26. To each sub-bit line SBL is further connected a discharge switch Dis_Sw, which is controlled by a discharge-control signal Dch for discharge of the potential of the sub-bit line SBL at the ends of read and write actions.

### <<Normal Data Read on the Data Flash>>

In MCU 1 of FIG. 1, an action to read the data flash DFL of FIG. 2 is started according to a read command to the data flash DFL of the flash memory module 6 through the high-speed bus HBUS and high-speed access port (HACSP) in response to a read request from CPU 2.

Specifically, an action to read normal data from a pair of nonvolatile memory cells MC1 (positive cell) and MC2 (negative cell), which constitute one twin cell of one of the first and second nonvolatile memory arrays 21 and 22 of the data flash DFL of FIG. 2 is started. The data which is read according to the normal data read is data of the state of Programmed Data “1” shown in FIG. 5B or data of the state of Programmed Data “0” shown in FIG. 5C. That is, the data which is read according to the normal data read are complementary data from a pair of nonvolatile memory cells MC1 (positive cell) and MC2 (negative cell), forming one twin cell.

As indicated by a signal path NR_RD for normal data read in FIG. 2, complementary data from a pair of nonvolatile memory cells MC1 and MC2 of the first nonvolatile memory array 21 are supplied, in parallel, to first and second input terminals In1 and In2 of the sense amplifier 26 through the two sub-bit lines SBL and first selector 24. Even in case that fatigue of the data flash DFL of FIG. 2 owing to a large number of times of data rewrite somewhat shrinks the difference between the threshold voltages of transistors of the pair of nonvolatile memory cells MC1 and MC2, the sense amplifier 26, which is a differential-amplification type sense amplifier, can amplify the shrunk difference of the threshold voltages correctly. Thus, even in case that an increased number of times of rewrite of the data flash DFL of FIG. 2 causes a memory cell of the data flash DFL to fatigue more or less, the sense amplifier 26 and data-output-latch driver 29 can output correct read data at the time of data read. The data, which have been read from the nonvolatile memory arrays 21 and 22 of the data flash DFL of FIG. 2 by the sense amplifier 26 and data-output-latch driver 29 in normal data read, can be provided to CPU 2 through the read-only high-speed access port (HACSP) and high-speed bus (HBUS) in MCU 1 of FIG. 1.

As described above, in normal data read of the data flash DFL, the Y-selectors 24 and 25 can supply complementary data from positive and negative cells constituting a twin cell of the nonvolatile memory arrays 21 and 22 to the first and second input terminals In1 and In2 of the sense amplifier 26 in parallel.

### <<Verify-Read of the Data Flash>>

In MCU 1 of FIG. 1, a write action on the data flash DFL of FIG. 2 is started according to a write command from the flash sequencer 7 to the data flash DFL of the flash memory module 6 through the peripheral bus PBUS and low-speed access port (LACSP) in response to a write request from CPU 2. In an action for write to a nonvolatile memory of the data flash DFL, a step of write-verify read to verify whether data has been written into a nonvolatile memory correctly is also conducted.

Specifically, the write of complementary data to a pair of nonvolatile memory cells MC1 (positive cell) and MC2 (negative cell) forming a twin cell of either the first or second nonvolatile memory array 21 or 22 of the data flash DFL of FIG. 2 is performed by raising the threshold voltage (Vth) of the one of the positive and negative cells from the initialized-and-erased state shown in FIG. 5A to the state as shown in FIG. 5B or 5C, followed by executing write-verify read.

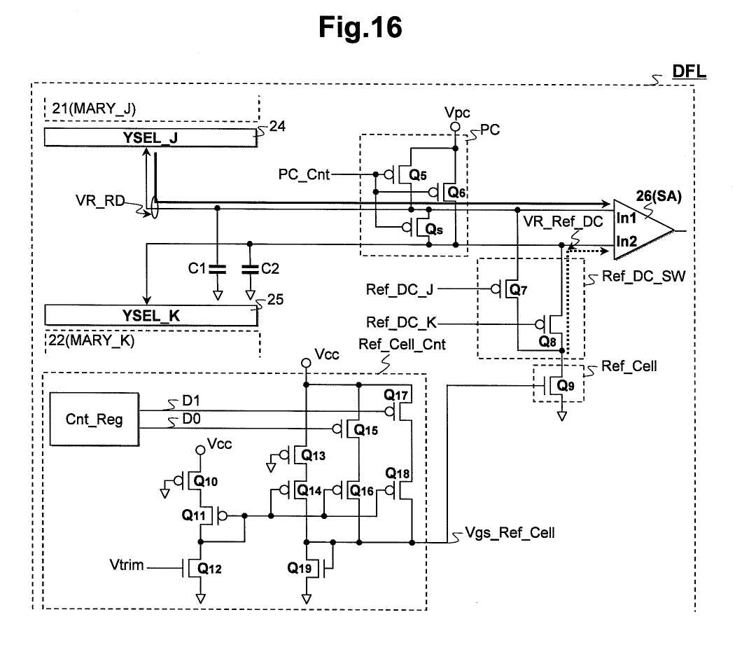

Now, the action of write-verify read will be described in detail. As indicated by a verify-read signal path VR_RD of FIG. 2, write-verify read data from the memory cell whose threshold voltage (Vth) is raised at the time of writing complementary data is supplied to the first input terminal In1 of the sense amplifier 26 through one sub-bit line SBL and the first selector 24. In parallel, a write-verify reference level VR_Ref_DC arising from a reference cell Ref_Cell included in the data flash DFL is supplied to the second input terminal In2 of the sense amplifier 26 as shown in FIG. 16.

To raise the threshold voltage (Vth) of one of positive and negative cells at the time of writing complementary data, a write pulse is applied under the voltage conditions: BL=0 volt, CG=1.5 volts, MG=10 volts, SL=6 volts, and WELL=0 volt. After application of the write pulse, if it is judged from the result of verify read using the signal path VR_RD that the threshold voltage (Vth) of one of a pair of memory cells is below the write-verify reference level, the write is judged to be insufficient. In this case, a subsequent write pulse is applied to the one memory cell again under the same voltage conditions. In contrast, if after the application of the subsequent write pulse, it is judged from the result of write-verify read using the signal path VR_RD that the threshold voltage (Vth) of the one memory cell is above the write-verify reference level, the write is judged to be sufficient.

The action of write-verify read will be described further in detail. In case of insufficient write, an exclusive-NOR circuit EXNOR of the data-write-verify circuit 28 produces an output of Low level “0”. In case that the unit of write is eight bits of twin cells, at least one of eight exclusive-NOR circuits EXNOR produces an output of Low level “0”, the AND circuit AND produces an output of Low level “0”, and then a subsequent write pulse is applied to the twin cells corresponding to the unit of write of eight bits. In case of sufficient write, the exclusive-NOR circuit EXNOR of the data-write-verify circuit 28 produces an output of High level “1”. In case that the unit of write is eight bits of twin cells, eight exclusive-NOR circuits EXNOR produce outputs of High level “1”, the AND circuits AND produce outputs of High level “1”, and then the write to the twin cells of eight bits corresponding to the unit of write is completed.

As described above, in the write-verify read of the data flash DFL, the Y-selectors 24 and 25 can supply write-verify read data form one of twin cells of nonvolatile memory array 21 or 22, to which write is performed, and the write-verify reference level to the first and second input terminals of the sense amplifier 26 in parallel.

In MCU 1 of FIG. 1, an erasing action on the data flash DFL of FIG. 2 is started according to an erase command from the flash sequencer 7 to the data flash DFL of the flash memory module 6 through the peripheral bus PBUS and low-speed access port (LACSP) in response to a request for erase from CPU 2. The action to erase a nonvolatile memory of the data flash DFL includes a step of erase-verify read to verify whether or not the nonvolatile memory is erased correctly.

In writing complementary data into a pair of nonvolatile memory cells MC1 (positive cell) and MC2 (negative cell), which forms one twin cell, the data flash DFL of FIG. 2 requires an action (initialize-erasing action) to write erase data corresponding to the low threshold voltage into the pair of nonvolatile memory cells before writing the complementary data. The initialize-erasing action needs a step of erase-verify read to verify whether or not the erase data of low threshold voltage is written into the pair of nonvolatile memory cells correctly.

In any of the initialize-erasing action before the write of complementary data and the erasing action according to an erase command, a pair of nonvolatile memory cells MC1 (positive cell) and MC2 (negative cell) of twin cells sharing a control gate (CG) and a memory gate (MG) is treated as a unit of handling of the erasing actions. To lower the threshold voltage (Vth) of a pair of nonvolatile memory cells MC1 (positive cell) and MC2 (negative cell) of twin cells, which is the unit of handling of the erasing actions, an erasing pulse is applied under the voltage conditions of BL=Hi-Z (high-impedance state), CG=1.5 volts, MG=−10 volts, SL=6 volts and WELL=0 volt. After application of the erasing pulse, the erase-verify read is conducted according to the signal path VR_RD. In case that as a result of the erase-verify read, the threshold voltage (Vth) of the memory cells judged to be above an erase-verify reference level, the erase is judged to be insufficient, and then the erasing pulse is applied to the memory cells again under the above voltage conditions. In contrast, in case that as a result of the erase-verify read, the threshold voltage (Vth) of the memory cells is judged to be below the verify reference level, the erase is regarded as sufficient.

Now, the action of erase-verify read will be described further in detail. In case of insufficient erase, the exclusive-NOR circuit EXNOR of the data-write-verify circuit 28 produces an output of Low level “0”. In case that the unit of erase is eight bits of twin cells, when at least one of eight exclusive-NOR circuits EXNOR produces an output of Low level “0”, the AND circuit AND produces an output of Low level “0”, the AND circuit AND produces an output of Low level “0”, and then a subsequent erasing pulse is applied to the twin cells corresponding to the unit of erase of eight bits. In case of sufficient erase, the exclusive-NOR circuit EXNOR of the data-write-verify circuit 28 produces an output of High level “1”. In case that the unit of erase is eight bits of twin cells, eight exclusive-NOR circuits EXNOR produce outputs of High level “1”, the AND circuits AND produce outputs of High level “1”, and then erase of the twin cells of eight bits corresponding to the unit of erase is completed.

Hence, in the erase-verify read on the data flash DFL, the Y-selectors 24 and 25 can supply erase-verify read data from, of twin cells of nonvolatile memory array 21 or 22 of the unit of erase, the cell subjected to the erase, and the erase-verify reference level to the first and second input terminals of the sense amplifier 26 in parallel.

### <<Blank-Check in the Data Flash>>

In MCU 1 of FIG. 1, a blank-check on the data flash DFL of FIG. 2 is started according to a blank-check command from the flash sequencer 7 to the data flash DFL of the flash memory module 6 through the peripheral bus PBUS and low-speed access port (LACSP) in response to a request for a blank-check from CPU 2.

To perform the blank-check, CPU 2 first issues a request for a blank-check action mode of the flash sequencer 7, and then goes into the waiting state. In response to the blank-check request issued by CPU 2, the flash sequencer 7 transfers the data flash DFL of FIG. 2 to the blank-check action mode. Before such transfer, the flash sequencer 7 is supplied with the start address and capacity (termination address) of a blank-check-target region from CPU 2.

In blank-check inside the data flash DFL incorporated in the microcomputer developed prior to the invention, the selectors 24 and 25, verify-read signal path VR_RD and sense amplifier 26 were used. For instance, blank-check data from one of a pair of nonvolatile memory cells forming one twin cell in the nonvolatile memory array 21, i.e. MC1 (positive cell) and blank-check data from the other memory cell i.e. MC2 (negative cell) are supplied to the first input terminal In1 of the sense amplifier 26 through the first selector 24 and verify-read signal path VR_RD in turn. During the supply, the second input terminal In2 of the sense amplifier 26 continues to accept supply of a reference voltage of a level substantially intermediate between the low threshold voltage of the state of Programmed Data “1” shown in FIG. 5B and the high threshold voltage. In case that a pair of nonvolatile memory cells MC1 (positive cell) and MC2 (negative cell) forming one twin cell are judged to have a low threshold voltage below the reference voltage level, the twin cell constituted by the paired nonvolatile memory cells is judged to be blank in the initialized-and-erased state. In this way, 64 twin cells storing data of a write size of eight bits undergo a sequential check, in turn, on whether the cells have the low threshold voltage, and therefore the blank-check developed prior to the invention takes an enormous amount of checking time.

In contrast, in blank-check for the data flash DFL according to an embodiment of the invention, which is shown in FIG. 2, the threshold voltages of eight twin cells (16 nonvolatile memory cells) storing complementary data of one byte are judged in parallel.

FIG. 7 is a diagram showing a configuration of a blank-check circuit for judging, in parallel, threshold voltages of eight twin cells storing complementary data of one byte in the blank-check of the data flash DFL shown in FIG. 2.

As to the blank-check circuit of the data flash DFL shown in FIG. 7, one byte representing the unit of write of the nonvolatile memory array 21 including eight twin cells, each composed of a pair of nonvolatile memory cells MC1 (positive cell) and MC2 (negative cell) is made a target region for a blank-check.

A lower left portion of FIG. 7 shows eight twin cells (16 nonvolatile memory cells) which are target regions for blank-check on the nonvolatile memory array 21 of the data flash DFL shown in FIG. 2. The 16 nonvolatile memory cells constituting eight twin cells are connected with 16 N-channel switching MOS transistors Q_{SW1}, Q_{SW2}, Q_{SW3}, Q_{SW4}, . . . , Q_{SW16} of the blank-check selector SEL_BC. The 16 switching MOS transistors Q_{SW1} to Q_{SW16} of the blank-check selector SEL_BC are connected with 16 P-channel MOS transistors Q_{CL11}, Q_{CL12}, Q_{CL13}, Q_{CL14}, . . . , Q_{CL116} of the first current limiter 1st_CL. Between sources of the 16 P-channel MOS transistors Q_{CL11} to Q_{CL116} of the first current limiter 1^{st}_CL and a source voltage Vdd, a P-channel MOS transistor Q_{P3} is connected as a first load. A voltage drop of the transistor Q_{P3} is supplied to the first input terminal In1 of the blank-check sense amplifier BC_SA.

A lower right portion of FIG. 7 shows a reference cell Ref_Cell including 12 reference N-channel switching MOS transistors Q_{REF1}, Q_{REF2}, Q_{REF3}, Q_{REF4}, . . . , Q_{REF12} to be compared with the eight twin cells as target regions for blank-check. The gates of the 12 reference N-channel switching MOS transistors Q_{REF1} to Q_{REF12} of the reference cell Ref_Cell are supplied with a substantially fixed gate-bias voltage Vgs, and therefore the drain currents of the 12 reference N-channel switching MOS transistors Q_{REF1} to Q_{REF12} are set to 15 μA. The 12 reference N-channel switching MOS transistors Q_{REF1} to Q_{REF12} of the reference cell Ref_Cell are connected with 12 P-channel MOS transistors Q_{CL21}, Q_{CL22}, Q_{CL23}, Q_{CL24}, . . . , Q_{CL212} of the second current limiter 2^{nd}_CL. Between sources of the 12 P-channel MOS transistors Q_{CL21} to Q_{CL212} of the second current limiter 2^{nd}_CL and the source voltage Vdd, a P-channel MOS transistor Q_{P4} is connected as a second load. A voltage drop of the transistor Q_{P4} is supplied to the second input terminal In2 of the blank-check sense amplifier BC_SA.

Gates of the 16 P-channel MOS transistors Q_{CL11} to Q_{CL116} of the first current limiter 1^{st}_CL drawn in a left lower portion of FIG. 7 are supplied with a gate voltage of the P-channel MOS transistor Q_{P14} of a first bias circuit 1^{st}_BC drawn in a upper left portion of FIG. 7. The first bias circuit 1^{st}_BC includes a first current source I₀₁, P-channel MOS transistors Q_{P11} and Q_{P12} of a first current mirror CM11, N-channel MOS transistors Q_{N11} and Q_{N12} of a second current mirror CM12, a first differential amplifier DA1, and P-channel MOS transistors Q_{P13} and Q_{P14}. The source voltage of the P-channel MOS transistor Q_{P14} is set to be substantially equal to the source voltage of the 16 P-channel MOS transistors Q_{CL11} to Q_{CL116} of the first current limiter 1^{st}_CL by the first differential amplifier DA1 and P-channel MOS transistor Q_{P13}. The current of the P-channel MOS transistor Q_{P14} of the first bias circuit 1^{st}_BC is set to be substantially equal to the constant current of the first current source I₀₁ by the first and second current mirrors CM11 and CM12. Limit currents of the 16 P-channel MOS transistors Q_{CL11} to Q_{CL116} of the first current limiter 1^{st}_CL are set to 15 μA by the gate voltage of the P-channel MOS transistor Q_{P14} of the first bias circuit 1^{st}_BC.

Gates of 12 P-channel MOS transistors Q_{CL21} to Q_{CL212} of the second current limiter 2^{nd}_CL drawn in a lower right portion of FIG. 7 are supplied with a gate voltage of the P-channel MOS transistor Q_{P24} of the second bias circuit 2^{nd}_BC drawn in an upper right portion of FIG. 7. The second bias circuit 2^{nd}_BC includes a second current source I₀₂, P-channel MOS transistors Q_{P21} and Q_{P22} of a third current mirror CM21, N-channel MOS transistors Q_{N21} and Q_{N22} of a fourth current mirror CM22, a second differential amplifier DA2, and P-channel MOS transistors Q_{P23} and Q_{P24}. The source voltage of the P-channel MOS transistor Q_{P24} is set to be substantially equal to the source voltage of the 12 P-channel MOS transistors Q_{CL21} to Q_{CL212} of the second current limiter 2^{nd}_CL by the second differential amplifier DA2 and P-channel MOS transistor Q_{P23}. The current of the P-channel MOS transistor Q_{P24} of the second bias circuit 2^{nd} BC is set to be substantially equal to the constant current of the second current source 102 by the third and fourth current mirrors CM21 and CM22. Limit currents of the 12 P-channel MOS transistors Q_{CL21} to Q_{CL212} of second current limiter 2^{nd}_CL are set to 15 μA by the gate voltage of the P-channel MOS transistor Q_{P24} of the second bias circuit 2^{nd}_BC.

In the blank-check for the data flash DFL of FIG. 7, a common select-control signal BC_SL of the blank-check selector SEL_BC is made High level “1”, and therefore 16 N-channel switching MOS transistors Q_{SW1} to Q_{SW16} of the blank-check selector SEL_BC are controlled to ON state. Also, in the blank-check for the data flash DFL of FIG. 7, the same bias conditions as those of the read action as shown in an upper portion of FIG. 4B are set for eight twin cells (16 nonvolatile memory cells), which are target regions for blank-check of the nonvolatile memory array 21. Specifically, as bias conditions at the time of the blank-check, the memory gate line (MGL), to which the memory gates (MG) of the eight twin cells are connected, is set to 0 volt, and the word line (WL), to which the control gates (CG) of the eight twin cells are connected, is set to 1.5 volts.

As described with reference to FIG. 5A, in the initialized-and-erased state (blank state), two nonvolatile memory cells MC1 (positive cell) and MC2 (negative cell) forming one twin cell are both in the condition of the low threshold voltage (Vth). Further, as described with reference to FIGS. 5B and 5C, one of two nonvolatile memory cells MC1 (positive cell) and MC2 (negative cell) forming one twin cell of the state of Programmed Data “1” or Programmed Data “0” is in the condition of the low threshold voltage (Vth), and the other is in the condition of the high threshold voltage (Vth).

Hence, it is assumed that eight twin cells (16 nonvolatile memory cells) checked, in parallel, in the blank-check on the nonvolatile memory array 21 of the data flash DFL of FIG. 7, are out of use in the blank state. In the case of the blank state, the eight twin cells (16 nonvolatile memory cells) in the condition of the low threshold voltage (Vth) are turned on by the 1.5-volt bias voltage of the word line (WL). Therefore, in this case, the sum of 15-μA limit currents of the 16 P-channel MOS transistors Q_{CL11}-Q_{CL116} of the first current limiter 1^{st}_CL, i.e. a total limit current of 240 μA goes through the P-channel MOS transistor Q_{P3} of the first load as a cell current I cell. On the other hand, the sum of 15-μA limit currents of the 12 P-channel MOS transistors Q_{CL21} to Q_{CL212} of the second current limiter 2^{nd}_CL, i.e. a total limit current of 180 μA goes through the P-channel MOS transistor Q_{P4} of the second load as a reference current Iref. The impedance of the P-channel MOS transistor Q_{P3} used as the first load, and the impedance of the P-channel MOS transistor Q_{P4} used as the second load a reset to be substantially equal to each other. Therefore, the voltage of the first input terminal In1 of the blank-check sense amplifier BC_SA is lower than the voltage of the second input terminal In2. Form an output of the blank-check sense amplifier BC_SA in this condition, it turns out that the eight twin cells (16 nonvolatile memory cells), which are made target regions for blank-check, are out of use in the blank state.

Next, it is assumed that eight twin cells (16 nonvolatile memory cells) to be checked in parallel in the blank-check of the nonvolatile memory array 21 in the data flash DFL of FIG. 7 are in use. In such case, by a bias voltage of 1.5 volts of the word line (WL), half of the eight twin cells (16 nonvolatile memory cells) are turned on, whereas the rest are turned off, provided that with the eight twin cells, the cells of the low threshold voltage and the cells of the high threshold voltage are in the proportion of 1:1. Therefore, in this case, the cell current Icell of 120 μA, which is half of 240 μA, representing the total limit current of 15-μA limit currents of the 16 P-channel MOS transistors Q_{CL11}-Q_{CL116} of the first current limiter 1^{st}_CL, flows through the first load, i.e. the P-channel MOS transistor Q_{P3}. On the other hand, the reference current Iref of 180 μA, which represents the total limit current of 15-μA limit currents of the 12 P-channel MOS transistors Q_{CL21} to Q_{CL212} of the second current limiter 2^{nd}_CL, goes through the second load, i.e. the P-channel MOS transistor Q_{P4}. Hence, the voltage of the first input terminal In1 of the blank-check sense amplifier BC_SA is made larger than that of the second input terminal In2. Form an output of the blank-check sense amplifier BC_SA in this condition, it turns out that the eight twin cells (16 nonvolatile memory cells), which are target regions for blank-check, are in use.

Thus, the blank-check for the data flash DFL of FIG. 7 allows threshold voltages of eight twin cells storing complementary data of one byte to be judged in parallel, whereby the blank-check time can be shortened.

Here, it is assumed that the first current limiter 1^{st}_CL is omitted from the data flash DFL of FIG. 7. In this case, when being turned on by a voltage of 1.5 volts of the word line (WL), transistors of eight twin cells (16 nonvolatile memory cells) of the blank state treated as target regions for blank-check fluctuate in currents because the transistors have variations in properties. Further, half of the eight twin cells (16 nonvolatile memory cells), which are in use and treated as target regions for blank-check, i.e. eight nonvolatile memory cell transistors turned on by a voltage of 1.5 volts of the word line (WL) fluctuate in currents because the transistors have variations in properties.

However, the first current limiter 1^{st}_CL is used in the data flash DFL of FIG. 7. Therefore, even in case that the target regions for the check are in the blank state or in use, the cell current Icell flowing through the first load transistor Q_{P3} can be set to 240 μA, the total limit current of 15-μA limit currents of the 16 transistors Q_{CL11}-Q_{CL116} of the first current limiter 1^{st}_CL, or 120 μA, half of that with high accuracy. Likewise, 12 transistors Q_{CL21} to Q_{CL212} of the second current limiter 2^{nd}_CL of the data flash DFL of FIG. 7 have the effect that the variation in the reference current Iref flowing through the second load transistor Q_{P4} owing to variations of the 12 reference transistors Q_{REF1} to Q_{REF12} of the reference cell Ref_Cell is reduced.

Particularly, as to the data flash DFL shown in FIG. 2, the connections between the first and second nonvolatile memory arrays 21 and 22 and the first and the second Y-selectors 24 and 25 are disabled under the control of the flash sequencer 7 which has responded to a request for a blank-check from CPU 2. As a result, it becomes impossible to perform normal data read and verify read on the first and second nonvolatile memory arrays 21 and 22. However, almost concurrently with this, the connections of the first and second nonvolatile memory arrays 21 and 22 with the blank-check sense amplifier BC_SA through the blank-check selector SEL_BC are established. By establishment of the connections, the blank-check using the blank-check circuit shown in FIG. 7 is started on the first and second nonvolatile memory arrays 21 and 22 of the data flash DFL shown in FIG. 2.

FIG. 8 is a diagram showing another configuration of the blank-check circuit for judging, in parallel, threshold voltages of eight twin cells storing complementary data of one byte in the blank-check of the data flash DFL shown in FIG. 2.

Unlike the blank-check circuit of FIG. 7, the P-channel MOS transistor Q_{P3} for the first load, the P-channel MOS transistor Q_{P4} for the second load, and the second bias circuit 2^{nd}_BC are omitted in the blank-check circuit shown in FIG. 8. As in FIG. 8, the place where the reference cell Ref_Cell is connected corresponds to the place of the P-channel MOS transistor Q_{P3} for the first load in the blank-check circuit of FIG. 7. In the reference cell Ref_Cell of FIG. 8, the 12 P-channel MOS transistors Q_{CL21} to Q_{CL212} of the second current limiter 2^{nd}_CL of FIG. 7 are used as alternatives of the 12 reference N-channel MOS transistors Q_{REF1} to Q_{REF12} of the reference cell Ref_Cell of FIG. 7. Gates of the 12 P-channel MOS transistors Q_{CL21} to Q_{CL212} of the reference cell Ref_Cell of FIG. 8 are supplied with the gate voltage of the P-channel MOS transistor Q_{P11} of the first bias circuit 1^{st}_BC.

Here, it is assumed that in the data flash DFL of FIG. 8, eight twin cells (16 nonvolatile memory cells) checked, in parallel, in the blank-check for the nonvolatile memory array 21 are out of use in the blank state. In this case, the cell current Icell of 240 μA representing the total limit current of 15-μA limit currents of the 16 P-channel MOS transistors Q_{CL11}-Q_{CL116} flows through the first current limiter 1^{st}_CL as in the case of FIG. 7. On the other hand, the reference current Iref of 180 μA representing the total limit current of 15-μA limit currents of the 12 P-channel MOS transistors Q_{CL21} to Q_{CL212} flows through the reference cell Ref_Cell of FIG. 8. Therefore, the voltage of the first input terminal In1 of the blank-check sense amplifier BC_SA is pulled down to a voltage below the reference voltage Vref of the second input terminal In2. From an output of the blank-check sense amplifier BC_SA in this condition, it turns out that the eight twin cells (16 nonvolatile memory cells), which are made target regions for blank-check, are out of use in the blank state.

Next, it is assumed for the data flash DFL of FIG. 8 that eight twin cells (16 nonvolatile memory cells) to be checked in parallel in the blank-check of the nonvolatile memory array 21 are in use. In this case, as in the case of the data flash described with reference to FIG. 7, the cell current Icell of 120 μA, which is half of 240 μA, representing the total limit current of 15-μA limit currents of the 16 P-channel MOS transistors Q_{CL11}-Q_{CL116} flows through the first current limiter 1^{st}_CL. On the other hand, the reference current Iref of 180 μA, which represents the total limit current of 15-μA limit currents of the 12 P-channel MOS transistors Q_{CL21} to Q_{CL212}, goes through the reference cell Ref_Cell of FIG. 8. Hence, the voltage of the first input terminal In1 of the blank-check sense amplifier BC_SA is pulled up to a voltage above the reference voltage Vref of the second input terminal In2. Form an output of the blank-check sense amplifier BC_SA in this condition, it turns out that the eight twin cells (16 nonvolatile memory cells), which are target regions for blank-check, are in use.

Thus, the blank-check for the data flash DFL of FIG. 8 also allows threshold voltages of eight twin cells storing complementary data of one byte to be judged in parallel, whereby the blank-check time can be shortened.

As described above, with the data flash DFL (FIG. 2) of the flash memory module 6 included in the microcomputer 1 as shown in FIG. 1, the threshold voltages of the eight twin cells are judged in parallel as described with reference to FIG. 7 or 8, whereby the blank-check is executed at a higher speed.

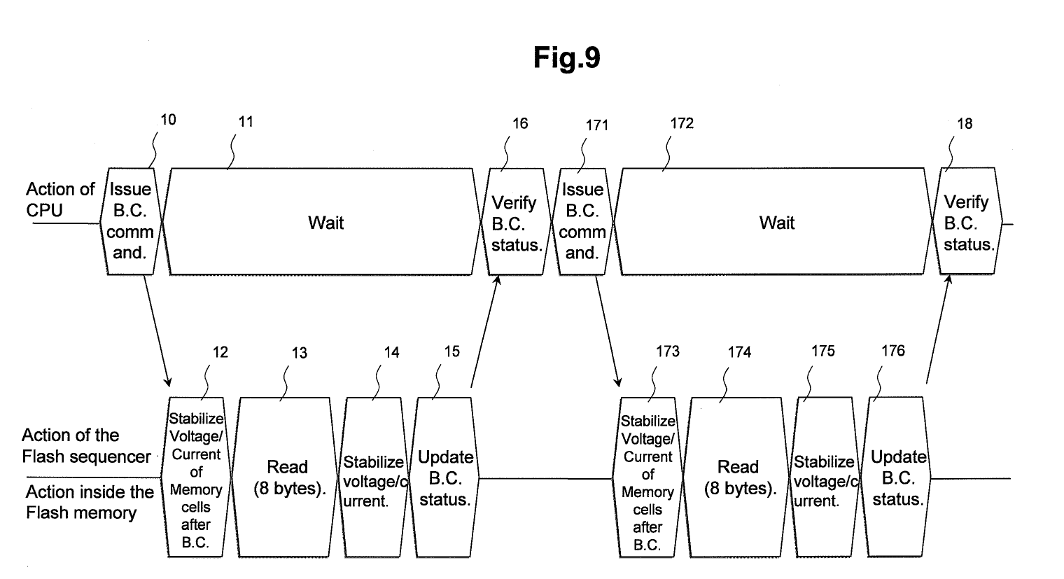

FIG. 9 is a diagram for explaining the way the blank-check function is implemented in the microcomputer shown in FIG. 1 and having the flash memory module 6 including the data flash DFL on which the high-speed blank-check can be carried out by judging, in parallel, threshold voltages of the eight twin cells of FIG. 7 or 8.

The upper half of FIG. 9 shows the action of CPU, and the lower half shows the action of the flash sequencer and the internal action of the flash memory. As in FIG. 9, CPU first issues a blank-check command for performing a blank-check in the period 10. Then, CPU goes into awaiting state in the period 11. In response to the blank-check command issued by CPU in the period 10, the flash sequencer starts a blank-check action on the flash memory DFL in the period 12. Subsequently in the period 12, the supply of voltage for blank-check to many twin cells of a memory region of a nonvolatile memory array targeted for the blank-check in the flash memory DFL is started, and then the many twin cells are stabilized in voltage/current. Thereafter in the period 13, data are read from the twin cells of a check size of eight bytes in the flash memory and put into an internal register with e.g. a capacity of eight bytes. Then, the twin cells representing the check size of eight bytes subjected to the blank-check are brought to the read state in the period 14 so that normal data read is allowed at any time. Hence, the twin cells representing the check size of eight bytes after the blank-check are stabilized in voltage/current in the read state in the period 14. Further, in the period 15, blank-check-status information is generated from the blank-check data read into the internal register with a capacity of eight bytes. If all the twin cells with the check size of eight bytes are blank, the memory region of eight bytes has been initialized and erased. However, in case that twin cells representing the check size of eight bytes, even one cell is not blank, the memory region of eight bytes has been already written and in use. The blank-check-status information first produced in the period 15 can be verified by CPU in the period 16.

Then, CPU issues a subsequent blank-check command for performing a blank-check on a next memory region in the period 171. In the period 172, CPU goes into the waiting state. In response to the blank-check command issued by CPU in the period 171, the flash sequencer starts a blank-check action on the flash memory DFL in the period 173. That is, in the period 173, the supply of voltage for blank-check to many twin cells of the next memory region to go through a blank-check is started in the flash memory DFL, and then the many twin cells are stabilized in voltage/current. Subsequently, in the period 174, data are read from the twin cells representing the check size of eight bytes in the flash memory and put into an internal register with e.g. a capacity of eight bytes. Thereafter, the twin cells representing the check size of eight bytes subjected to the blank-check are brought to a read state in the period 175 so that normal data read is allowed at any time. Hence, the twin cells representing the check size of eight bytes after the blank-check are stabilized in voltage/current in the read state. Further, in the period 176, blank-check-status information is generated from the blank-check data read into the internal register with the capacity of eight bytes. The blank-check of twin cells contained in a memory region of a required check size can be conducted by repeating the action like this.

In this way, in the data flash DFL, blank-check data are read out from twin cells representing the check size of eight bytes starting with the start address of a blank-check-target region, and put into the internal register with the capacity of eight bytes under the control of the flash sequencer 7. In addition, blank-check-status information generated from the blank-check data of eight bytes read out and put into the internal register is supplied to CPU 2 from the data flash DFL. The CPU 2 verifies the blank-check-status information thus supplied.

However, with a method of blank-checking twin cells according to the procedure as described with reference to FIG. 9, the rise in the required blank-check size increases the number of times that CPU issues a blank-check command. Further, in the case of a method of blank-checking twin cells according to this procedure, the action period required for blank-check with a predetermined check size, e.g. eight bytes is made longer. This is attributed to that a twin cell which has been blank-checked is brought to the read state so that normal data read can be conducted on the blank-checked twin cell at any time after blank-check data from the twin cell has been read into the internal register.

Like FIG. 9, FIG. 10 is also a diagram for explaining the way an improved blank-check function which never raises the number of times of command creation is put into action in the microcomputer shown in FIG. 1 and having the flash memory module 6 including the data flash DFL on which the high-speed blank-check can be carried out by judging threshold voltages of twin cells in parallel.

As in FIG. 10, CPU first issues a blank-check command for performing a blank-check in the period 20. Then, CPU goes into a waiting state in the period 21. In response to the blank-check command issued by CPU in the period 20, the flash sequencer transfers the data flash DFL included in the flash memory module to the blank-check action mode in the period 22. Subsequently in the period 22, the supply of voltage for blank-check to many twin cells of a memory region of a nonvolatile memory array targeted for the blank-check in the data flash DFL is started, and then the many twin cells are stabilized in voltage/current. In the period 23, CPU issues a memory-read request. In response to the memory-read request, blank-check data are read out from twin cells representing the check size of eight bytes starting with a predetermined start address, and put into the internal register with the capacity of eight bytes under the control of the flash sequencer in the data flash DFL in the period 24. Also, in the period 24, blank-check-status information generated from the blank-check data of eight bytes which have been read into the internal register is supplied to CPU from the data flash DFL. In the period 25, CPU verifies the blank-check-status information thus supplied. In the period 26, CPU issues a subsequent memory-read request. In response to the subsequent memory-read request, blank-check data for twin cells of another eight bytes of the data flash DFL are read into the internal register with the capacity of eight bytes under the control of the flash sequencer in the period 271. Also, in the period 271, blank-check-status information generated from the blank-check data of eight bytes read out into the internal register is supplied to CPU from the data flash DFL. In the period 281, CPU verifies the blank-check-status information thus supplied. After the blank-check on all the twin cells of the data flash DFL is completed in this way, CPU issues a request for cancel of the blank-check action mode to the flash sequencer in the period 282. Thereafter in the period 29, the blank-checked data flash DFL is brought to the read state so that normal data read is allowed at any time. The twin cells of the data flash DFL after the blank-check are stabilized in voltage/current in the read state.

Unlike the blank-check function as described with reference to FIG. 9, the improved blank-check function as described with reference to FIG. 10 can prevent the number of command issues by CPU from being increased even in case that the blank-check size is enlarged.

### <<Architecture of the Program Flash>>

Now, referring to FIG. 3, the architecture of the program flash PFL will be described. The program flash PFL includes many nonvolatile memory cells MC0, which a single piece of data of one bit is written into as described with reference to FIGS. 6A and 6B, and serves to store various software programs for CPU 2 of MCU 1 of FIG. 1.

The program flash PFL of FIG. 3 has a remarkable similarity in configuration to the data flash DFL of FIG. 2. Specifically, the program flash PFL of FIG. 3 includes a third nonvolatile memory array (MARY_J) 31, a fourth nonvolatile memory array (MARY_K) 32, a Y-decoder (YDEC) 33, a third Y-selector (YSEL_J) 34, a fourth Y-selector (YSEL_K) 35 and a sense amplifier (SA) 36. The program flash PFL further includes a write-data-input buffer 37, a data-write-verify circuit 38 and a data-output-latch driver 39.

The third nonvolatile memory array (MARY_J) 31 and fourth nonvolatile memory array (MARY_K) 32 each include many nonvolatile memory cells MC0, and therefore the third and fourth arrays can store various software programs for CPU 2. Control gates (CG), memory gates (MG) and sources of the many nonvolatile memory cells MC0 arrayed in the X direction are connected to a word line (WL), a memory gate line (MGL) and a source line (SL) respectively.

To speed up data write and data read and lower power consumption, the layered-bit-line architecture is adopted for the third nonvolatile memory array (MARY_J) 31 and fourth nonvolatile memory array (MARY_K) 32. Specifically, one write main bit line WMBL and one read main bit line RMBL are connected to the third and fourth nonvolatile memory arrays (MARY_J and MARY_K) 31 and 32.

The sub-bit lines SBL connected with nonvolatile memory cells MC0 are connected to the only write main bit line WMBL through the sources and drains of the switching MOS transistors Q3 of the bit line switches BL_SW. In case that data is written into a nonvolatile memory cell MC0, the switching MOS transistor Q3 of the bit line switch BL_SW between the sub-bit line SBL connected with the nonvolatile memory cell MC0 and the write main bit line WMBL is controlled through a control-signal line ZL into ON state. At the time of writing data into the program flash PFL shown in FIG. 3, the write data Qin is supplied to the write main bit line WMBL through the write-data-input buffer 37, the selector V_SEL of the data-write-verify circuit 38 and the write latch Write Latch. The write data supplied to the write main bit line WMBL is passed through the bit line switches BL_SW in each of the third and fourth nonvolatile memory arrays 31 and 32 and then written into the nonvolatile memory cell MC0 of the program flash PFL. Besides, in MCU 1 shown in FIG. 1, the write data Qin provided to the write-data-input buffer 37 is supplied together with a write command from the flash sequencer 7 to the program flash PFL of the flash memory module 6 through the peripheral bus PBUS and low-speed access port (LACSP) in response to a write request from CPU 2.

The sub-bit lines SBL, to which the nonvolatile memory cells MC0 of the third and fourth nonvolatile memory arrays (MARY_J and MARY_K) 31 and 32 are connected, are connected to the read main bit line RMBL through the third and fourth Y-selectors (YSEL_J and YSEL_K) 34 and 35, and the sense amplifier (SA) 36. To each sub-bit line SBL is further connected a discharge switch Dis_Sw, which is controlled by a discharge-control signal Dch for discharge of the potential of the sub-bit line SBL at the ends of read and write actions.

### <<Normal Data Read on the Program Flash>>

In MCU 1 of FIG. 1, a read action on the program flash PFL of FIG. 3 is started according to a read command to the program flash PFL of the flash memory module 6 through the high-speed bus HBUS and high-speed access port (HACSP) in connection with a read request from CPU 2.

Specifically, the action to read normal data, i.e. a single piece of data of one bit, from one nonvolatile memory cell MC0 of one of the third and fourth nonvolatile memory arrays 31 and 32 of the program flash PFL of FIG. 3 is started. The data which is read according to the normal data read is of the state of Programmed Data “0” shown in FIG. 6B or the state of Erased Data “1” of FIG. 6A.

As indicated by the signal path NR_RD of the normal data read of FIG. 3, a single piece of data from one nonvolatile memory cell MC0 of the third nonvolatile memory array 31 is supplied to the first input terminal In1 of the sense amplifier 36 through the corresponding sub-bit line SBL and third selector 34. In parallel with this, a normal-data-read reference level generated by the reference cell, which is not shown, is supplied to the second input terminal In2 of the sense amplifier 36. The normal-data-read reference level corresponds to a threshold voltage substantially intermediate in level between the low threshold voltage of the state of Erased Data “1” shown in FIG. 6A and the high threshold voltage of the state of Programmed Data “0” shown in FIG. 6B. As to the program flash PFL of FIG. 3 which is relatively small in the number of times of rewrite, high-density storing on the program flash PFL of FIG. 3 can be achieved. This is because the one-cell-to-one-bit writing method by which a single piece of data of one bit is written into one nonvolatile memory cell MC0 is adopted for the program flash PFL. Program data which is read in normal data read from the nonvolatile memory arrays 31 and 32 of the program flash PFL of FIG. 3 with the sense amplifier 36 and data-output-latch driver 39 can be supplied to CPU 2 through the read-only high-speed access port (HACSP) and high-speed bus (HBUS) in MCU 1 of FIG. 1.

As described above, in the normal data read from the program flash PFL, the Y-selector 34/35 supplies a single piece of data from one nonvolatile memory cell MC0 of the nonvolatile memory array 31/32 to one of the first and second input terminals In1 and In2 of the sense amplifier 36. On the other hand, in this normal data read, the Y-selectors 34 and 35 can supply the normal-data-read reference level to the other input terminal of the first and second input terminals In1 and In2 of the sense amplifier 36.

### <<Verify Read on the Program Flash>>

In MCU 1 of FIG. 1, CPU 2 or DMAC 3 issues a request for program write to the flash memory module 6 with a relatively low frequency. The program-write action on the program flash PFL of FIG. 3 is started according to a program-write command from the flash sequencer 7 to the program flash PFL of the flash memory module 6 through the peripheral bus PBUS and low-speed access port (LACSP) in connection with a request for program write. With the program flash PFL, in the program-write action on the nonvolatile memory, it is required to execute a step of write-verify read to verify whether or not program data have been written into the nonvolatile memory correctly.

Hence, in writing a single piece of data of one bit into a nonvolatile memory cell MC0 of one of the third and fourth nonvolatile memory arrays 31 and 32 of the program flash PFL of FIG. 3, the write-verify read is performed. As described above, the write of a single piece of data to a nonvolatile memory cell MC0 can be achieved by raising the threshold voltage (Vth) of the nonvolatile memory cell MC0 from the erased state of FIG. 6A to the state shown in FIG. 6B.

As indicated by the verify-read signal path VR_RD shown in FIG. 3, a single piece of data from one nonvolatile memory cell MC0 of the third nonvolatile memory array 31 is supplied to the first input terminal In1 of the sense amplifier 36 through one sub-bit line SBL and the third selector 34 as with the signal path NR_RD in the normal data read. In parallel with this, a write-verify reference level generated by the reference cell, which is not shown, is supplied to the second input terminal In2 of the sense amplifier 36. The write-verify reference level corresponds to a threshold voltage substantially intermediate in level between the low threshold voltage of the state of Erased Data “1” shown in FIG. 6A and the high threshold voltage of the state of Programmed Data “0” shown in FIG. 6B. It is preferable that the write-verify reference level is closer to the high threshold voltage of the state of Programmed Data “0” shown in FIG. 6B rather than a threshold voltage of the intermediate level.

To raise the threshold voltage (Vth) of the nonvolatile memory cell MC0 in writing a single piece of data, a write pulse is applied under the voltage conditions of BL=0 volt, CG=1.5 volts, MG=10 volts, SL=6 volts and WELL=0 volt. After application of the write pulse, if the result of the verify read using the signal path VR_RD shows that the threshold voltage (Vth) of the nonvolatile memory cell MC0 is below the write-verify reference level, the write is regarded as insufficient. In this case, a subsequent write pulse meeting the same voltage conditions is applied to the nonvolatile memory cell MC0 again. After application of this subsequent write pulse, if it is judged from the result of the write-verify read using the signal path VR_RD that the threshold voltage (Vth) of the nonvolatile memory cell MC0 is above the write-verify reference level, the write is judged to be sufficient.

In case of insufficient write, the exclusive-NOR circuit EXNOR of the data-write-verify circuit 38 produces an output of Low level “0”. In case that the unit of write is eight bits of nonvolatile memory cells MC0, at least one of eight exclusive-NOR circuits EXNOR produces an output of Low level “0”, the AND circuit AND produces an output of Low level “0”, and then a subsequent write pulse is applied to the nonvolatile memory cells MC0 corresponding to the unit of write of eight bits again. In case of sufficient write, the exclusive-NOR circuit EXNOR of the data-write-verify circuit 38 produces an output of High level “1”. In case that the unit of write is eight bits of nonvolatile memory cells MC0, eight exclusive-NOR circuits EXNOR produce outputs of High level “1”, the AND circuits AND produce outputs of High level “1”, and then the write on the nonvolatile memory cells MC0 of eight bits corresponding to the unit of write is completed.

As described above, in the write-verify read on the program flash PFL, a single piece of data from one nonvolatile memory cell MC0 of the third nonvolatile memory array 31 is supplied to the first input terminal In1 of the sense amplifier 36 through the corresponding sub-bit line SBL and the third selector 34 using the verify-read signal path VR_RD, which is exactly the same as the signal path NR_RD used in the normal data read. In parallel with this, a write-verify reference level produced by the reference cell, which is not shown, is supplied to the second input terminal In2 of the sense amplifier 36.

In MCU 1 of FIG. 1, the erasing action on the program flash PFL of FIG. 3 is started according to an erase command from the flash sequencer 7 to the program flash PFL of the flash memory module 6 through the peripheral bus PBUS and low-speed access port (LACSP) in connection with an erase request from CPU 2, the frequency of which is relatively low. In the erasing action on the nonvolatile memory of the program flash PFL, it is required to perform the erase-verify read to verify whether the nonvolatile memory has been erased correctly.

Further, for the program flash PFL of FIG. 3, it is required to perform the erasing action on all of the nonvolatile memory cells MC0 included in the third and fourth nonvolatile memory arrays 31 and 32 before writing a single piece of data into one nonvolatile memory cell MC0. All the nonvolatile memory cells MC0 included in the third and fourth nonvolatile memory arrays 31 and 32 are made the low threshold voltage of the state of Erased Data “1” shown in FIG. 6A by the erasing action. This erasing action needs the erase-verify action to verify whether Erased Data “1” of the low threshold voltage has been written into the nonvolatile memory cells MC0 correctly. In the erasing action, the nonvolatile memory cells MC0 are handled in groups of memory cells sharing a control gate (CG) and a memory gate (MG). To lower the threshold voltage (Vth) of a group of nonvolatile memory cells MC0, which correspond to the handling unit of the erasing action, an erasing pulse is applied under the voltage conditions of BL=Hi-Z (high-impedance state), CG=1.5 volts, MG=−10 volts, SL=6 volts and WELL=0 volt. After application of the erasing pulse, if it is judged from the result of the erase-verify read using the signal path VR_RD that that the threshold voltage (Vth) of the memory cells is above the verify reference level, the erase is judged to be insufficient. In this case, the erasing pulse is applied again to the group of nonvolatile memory cells MC0, which corresponds to the handling unit of the erasing action, under the above voltage conditions. Further, after application of an additional erasing pulse, if it is judged from the result of the erase-verify read using the erasing signal path VR_RD that the threshold voltage (Vth) of the memory cells are above the verify reference level, the erase is judged to be sufficient.

In case of insufficient erase, the exclusive-NOR circuit EXNOR of the data-write-verify circuit 38 produces an output of Low level “0”. In case that the unit of erase is eight bits of nonvolatile memory cells MC0, at least one of eight exclusive-NOR circuits EXNOR produces an output of Low level “0”, the AND circuit AND produces an output of Low level “0”, and then a subsequent erasing pulse is applied to the nonvolatile memory cells MC0 corresponding to the unit of erase of eight bits again. In case of sufficient erase, the exclusive-NOR circuit EXNOR of the data-write-verify circuit 38 produces an output of High level “1”. In case that the unit of erase is eight bits of nonvolatile memory cells MC0, eight exclusive-NOR circuits EXNOR produce outputs of High level “1”, the AND circuits AND produce outputs of High level “1”, and then the erase on the nonvolatile memory cells MC0 of eight bits corresponding to the unit of erase is completed.

A single piece of data from one nonvolatile memory cell MC0 of the first nonvolatile memory array 31 is supplied to the first input terminal In1 of the sense amplifier 36 through the corresponding sub-bit line SBL and the third selector 34 as indicated by the verify-read signal path VR_RD of FIG. 3 exactly in the same way as in the case of normal data read using the signal path NR_RD. In parallel with this, an erase-verify reference level generated by the reference cell, which is not shown, is supplied to the second input terminal In2 of the sense amplifier 36. The erase-verify reference level corresponds to a threshold voltage substantially intermediate in level between the low threshold voltage of the state of Erased Data “1” shown in FIG. 6A and the high threshold voltage of the state of Programmed Data “0” shown in FIG. 6B. It is preferable that the erase-verify reference level is closer to the low threshold voltage of the state of Erased Data “1” shown in FIG. 6A rather than a threshold voltage of the intermediate level.

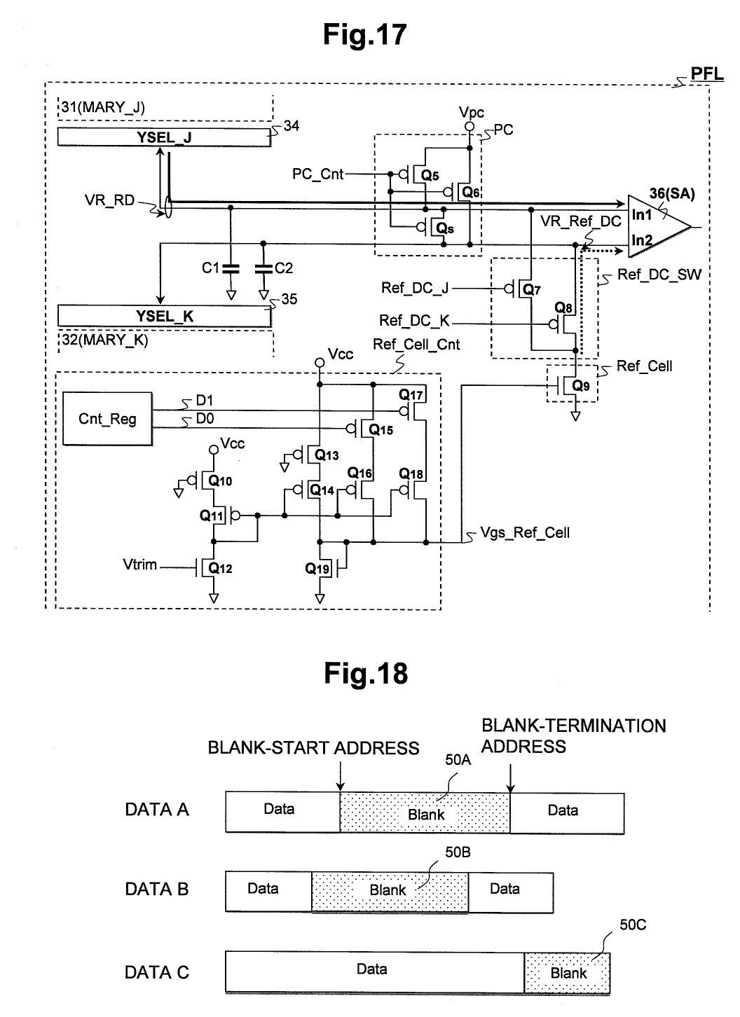

As described above, in the erase-verify read on the program flash PFL, a single piece of data from one nonvolatile memory cell MC0 of the third nonvolatile memory array 31 is supplied to the first input terminal In1 of the sense amplifier 36 through the corresponding sub-bit line SBL and the third selector 34 using the verify-read signal path VR_RD, which is exactly the same as the signal path NR_RD used in the normal data read. In parallel with this, an erase-verify reference level VR_Ref_DC generated by the reference cell Ref_Cell, which is included in the program flash PFL, is supplied to the second input terminal In2 of the sense amplifier 36 as shown in FIG. 17.

### <<Details of the Blank-Check on the Data Flash>>

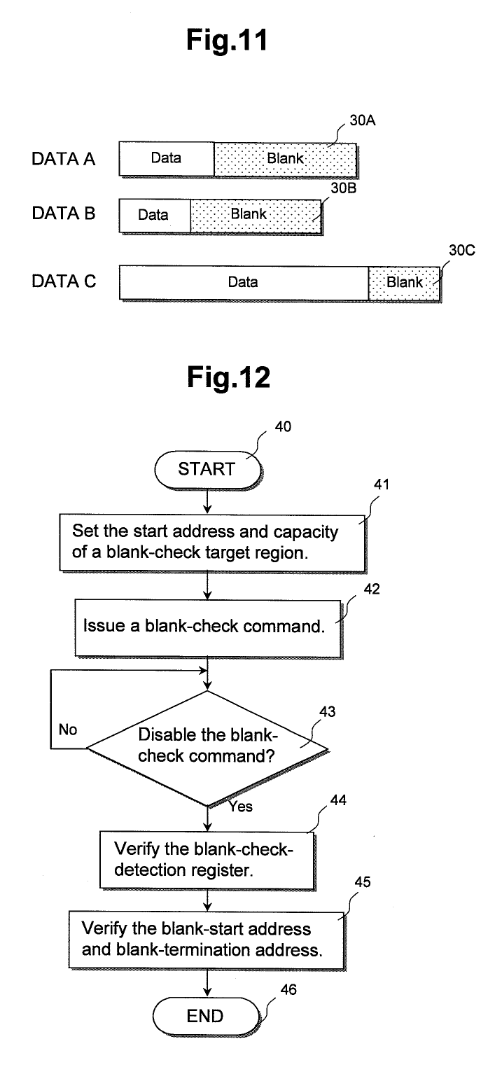

FIG. 11 is a diagram showing an arrangement of various types of data stored in the data flash DFL of the flash memory module (FMDL) 6 incorporated in the microcomputer (MCU) 1 shown in FIG. 1.

Referring to FIG. 11, three types of data 30A, data 30B, and data 30C are shown. Write data Data written into one twin cell, which consist of complementary data, are contained in the first or leftmost portion of each type of data, and the second portion is blank, which is denoted by “Blank”. New complementary data can be additionally written into the many twin cells in a memory region, which correspond to the second portions in the blank state.

FIG. 12 is a flowchart showing a process flow for executing the blank-check for the various types of data shown in FIG. 11.

FIG. 13 is a diagram showing a configuration of the flash sequencer 7 suitable to execute the blank-check according to the process flow shown in FIG. 12.

The flash sequencer 7 shown in FIG. 13 is connected between CPU 2 and the data flash DFL of the flash memory module 6. Particularly, the flash sequencer 7 is connected with CPU 2 through a peripheral address bus PAB of the peripheral bus PBUS and a peripheral data bus PDB thereof. The flash sequencer 7 includes a sequence controller 71, a blank-check-setting register 72, a rising-edge detector 73, a blank-start-address-storing register 74, a falling-edge detector 75, a blank-termination-address-storing register 76 and a blank-check-detection register 77. The blank-check-setting register 72 can store the start address of a blank-check-target region and the capacity range (termination address) thereof in the data flash DFL sent from CPU 2. The flash sequencer 7 is supplied with an access-base clock CLKP generated by PLL 11 incorporated in the microcomputer (MCU) 1 shown in FIG. 1 and a detection clock CLKI. The detection clock CLKI is supplied to latch control input terminals of the rising-edge detector 73 and falling-edge detector 75. In response to a rising-edge-detection signal from the rising-edge detector 73, a blank-check address from the sequence controller 71 is stored in the blank-start-address-storing register 74. On the other hand, in response to a falling-edge-detection signal from the falling-edge detector 75, the blank-check address from the sequence controller 71 is stored in the blank-termination-address-storing register 76. Besides, in response to a rising-edge-detection signal from the rising-edge detector 73, the blank-start signal B_S of the blank-check-detection register 77 is set to High level “1”, whereas in response to a rising-edge-detection signal from the rising-edge detector 73, the blank-termination signal B_E of the blank-check-detection register 77 is set to High level “1”.

First, in Step 40 of the process flow of FIG. 12, CPU 2 sends a request for a blank-check concerning, of various types of data stored in the data flash DFL, e.g. the data 30A of FIG. 11 to the flash sequencer 7.

In Step 41 of FIG. 12, the start address and capacity range of a blank-check-target region concerning the data 30A of FIG. 11 sent from CPU 2 are put in the blank-check-setting register 72 inside the flash sequencer 7.

In Step 42 of FIG. 12, CPU 2 issues a blank-check command to the sequence controller 71 inside the flash sequencer 7. Then, the sequence controller 71 inside the flash sequencer 7 outputs, in turn, the addresses of twin cells of the nonvolatile memory array of the data flash DFL checked in blank according to the start address of a blank-check-target region stored in the blank-check-setting register 72 to an internal address bus IAB. The check addresses of the twin cells output in turn to the internal address bus IAB are supplied to the twin cells of the nonvolatile memory array through the low-speed access port (LACSP) 61 of the data flash DFL in turn. The twin cells undergo the blank-check in turn, and thus a result 61A of the blank-check is created in the data flash DFL.

The result 61A of the blank-check of the data flash DFL is supplied, as a blank signal Blank, to the rising-edge detector 73 and falling-edge detector 75 in the flash sequencer 7 through the low-speed access port (LACSP) 61 and internal data bus IDB. Write data to one twin cell, which consist of complementary data, are contained in the first portion of the data 30A of FIG. 11. Therefore, blank signals Blank from a twin cell at the start address of a blank-check-target region, and a twin cell at the subsequent address show Low level “0” (Being used). In contrast, the second portion of the data 30A of FIG. 11 is blank, which is denoted by “Blank”. Therefore, blank signals Blank from twin cells at and after a certain address between the start and termination addresses are of High level “1” (Unused blank state).

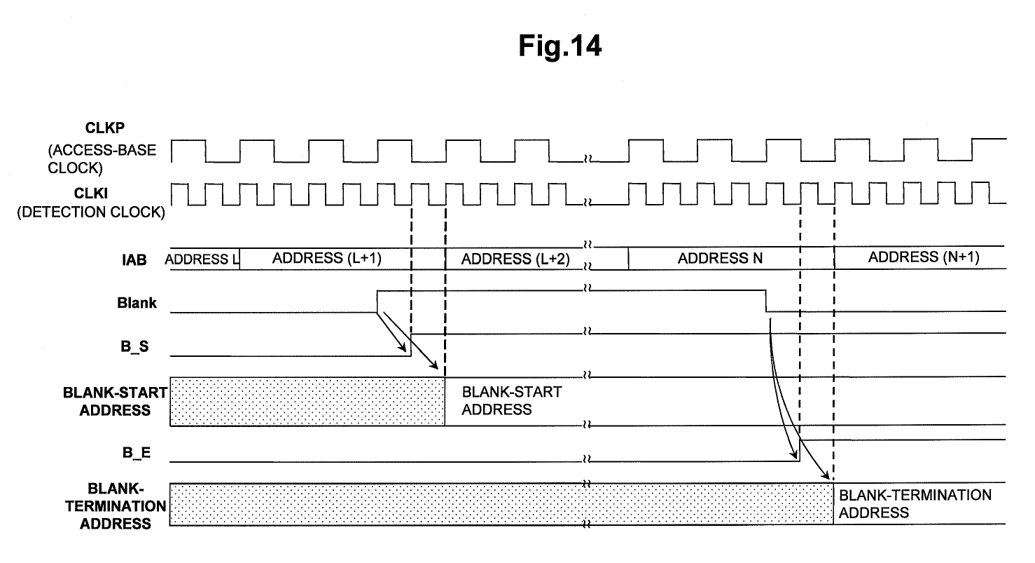

FIG. 14 is a diagram for explaining actions of the flash sequencer 7 shown in FIG. 13, showing waveforms in the parts of the flash sequencer 7.

The top two portions of FIG. 14 present the access-base clock CLKP generated by PLL 11 incorporated in the microcomputer (MCU) 1 shown in FIG. 1 and the detection clock CLKI, respectively.

The third portion of FIG. 14 from the top shows an address signal for a blank-check, which is output from the sequence controller 71 to the internal address bus IAB sequentially. The fourth portion of FIG. 14 shows the change of the blank signal Blank which is output from the data flash DFL to the internal data bus IDB.

The fifth and seventh portions of FIG. 14 show the change of the blank-start signal B_S and blank-termination signal B_E of the blank-check-detection register 77, respectively.

The sixth and eighth portions of FIG. 14 show a blank-start address stored in the blank-start-address-storing register 74 and a blank-termination address stored in the blank-termination-address-storing register 76, respectively. In the example shown in FIG. 14, an address signal (L+1) for a blank-check output to the internal address bus IAB corresponds to the start address of the blank of the second portion of the data 30A of FIG. 11. Also, in the example of FIG. 14, an address signal (N) for a blank-check output to the internal address bus IAB represents the termination address of the blank of the second portion of the data 30A of FIG. 11.

When the start and termination addresses of the blank of the second portion of the data 30A of FIG. 11 are detected, the blank-check on the data 30A of FIG. 11 is completed. Then, the blank-start signal B_S of the blank-check-detection register 77 is set to High level “1”. The blank-termination signal B_E of the blank-check-detection register 77 is set to High level “1” in response to the rising-edge-detection signal from the rising-edge detector 73. The sequence controller 71 then supplies a response of blank-check completion to CPU 2 through the peripheral data bus PDB of the peripheral bus PBUS. In Step 43 of FIG. 12, CPU 2 reacts to the response, and disables the blank-check command, which CPU 2 has issued in Step 42 of FIG. 12.

In case that the blank-check command is terminated in Step 43 of FIG. 12, CPU 2 verifies the blank-start signal B_S and blank-termination signal B_E of the blank-check-detection register 77 through the peripheral data bus PDB of the peripheral bus PBUS in the subsequent Step 44. Subsequently in Step 45, CPU 2 verifies the blank-start address stored in the blank-start-address-storing register 74 and the blank-termination address stored in the blank-termination-address-storing register 76 through the peripheral data bus PDB of the peripheral bus PBUS.

After the completion of the steps described above, the process of blank-check is finished in Step 46 of FIG. 12.

### <<Partition of the Data Flash and Program Flash>>

As described above, the program flash PFL shown in FIG. 3 has a remarkable similarity in configuration to the data flash DFL shown in FIG. 2. Hence, in a preferred embodiment of the invention, the layout of the data flash DFL of FIG. 2 and program flash PFL of FIG. 3 in the flash memory module 6 of MCU 1 of FIG. 1 can be set appropriately.

FIG. 15 is a diagram for explaining how the locations of the data flash DFL and program flash PFL are set appropriately in the flash memory module (FMDL) 6 of MCU 1 of FIG. 1. The lowest portion of the flash memory module (FMDL) 6 shown in FIG. 15 includes a control-management area Cnt_Area. The control-management area Cnt_Area can hold various control codes of MCU 1, and its head portion includes initialization-control-code data INT_Data of MCU 1.

In system initialization at the time of system reset, e.g. power-on, of MCU 1 of FIG. 1, CPU 2 reads initialization-control-code data INT_Data included in the control-management area Cnt_Area of the lowest portion of the flash memory module (FMDL) 6 shown in FIG. 15 in response to an external reset signal RES.

The initialization-control-code data INT_Data thus read out is supplied to peripheral modules, e.g. the externally input/output ports 8 and 9, timer 10 and clock-pulse generator 11, whereby the action modes of the peripheral modules can be initialized. The initialization-control-code data INT_Data which CPU 2 reads out at that time contains the end address EA of the data flash DFL laid out in the flash memory module (FMDL) 6 of FIG. 15.

In system initialization at the time of system reset, e.g. power-on, of MCU 1 of FIG. 1, CPU 2 uses the read end address EA to appropriately set the locations of the data flash DFL and program flash PFL in the flash memory module (FMDL) 6. In the example of FIG. 15, a portion including a series of nonvolatile memory arrays, starting with the nonvolatile memory array MARY_00 specified by the first address in an upper left portion of the flash memory module 6 and ending with the nonvolatile memory array MARY_3M specified by the end address EA, is handled as the data flash DFL, the action mode of which is set initially. Therefore, the series of nonvolatile memory arrays of this portion will function as a data flash DFL for which the highly-reliable two-cell-to-one-bit writing method is adopted. Incidentally, according to the two-cell-to-one-bit writing method, complementary data of one bit are written into a twin cell composed of a pair of nonvolatile memory cells.

Next, CPU 2 sends, as the program flash PFL, a portion including a series of nonvolatile memory arrays, starting with the nonvolatile memory array MARY_40 subsequent to the nonvolatile memory array MARY_3M specified by the end address EA and ending with the last nonvolatile memory array MARY_NM, and fixes the action mode thereof initially. Hence, the series of nonvolatile memory arrays of this portion will function as a program flash PFL for which the one-cell-to-one-bit high-density writing method is adopted. Incidentally, according to the one-cell-to-one-bit writing method, a single piece of data of one bit is written into one nonvolatile memory cell.

As described above, partitioning of the data flash DFL and program flash PFL in the flash memory module (FMDL) 6 can be completed in system initialization at the time of power-on. Now, in the case of changing the partition between the data flash DFL and program flash PFL, CPU 2 rewrites the end address EA contained by the initialization-control-code data INT_Data in the control-management area Cnt_Area of the lowest portion of the flash memory module (FMDL) 6 shown in FIG. 15.

### 2. Second Aspect

### <Microcomputer>

FIG. 1 shows a configuration of a microcomputer (MCU) 1 according to an embodiment of the invention. The microcomputer 1 shown in FIG. 1 is formed in one semiconductor chip formed from monocrystalline silicon by a fine-structure CMOS semiconductor manufacturing process.

The microcomputer 1 has a two-hierarchical bus structure having a high-speed bus HBUS and a peripheral bus PBUS. The high-speed bus HBUS and peripheral bus PBUS each have a data bus, an address buss and a control bus. Thus separating the bus in the two-hierarchical bus structure, the load on the bus is lightened in comparison to the case of connecting all circuits to a common bus in common, whereby a high-speed access action is enabled.

To the high-speed bus HBUS, a central processing unit (CPU) 2 which includes an instruction-control section and an execution section and executes an instruction, a direct memory access controller (DMAC) 3, and a bus interface circuit (BIF) 4 which performs bus-interface control or bus-bridge control of the high-speed bus HBUS and peripheral bus PBUS are connected. Further, to the high-speed bus HBUS, a random access memory (RAM) 5 used for a work region of the central processing unit 2, etc. and a flash memory module (FMDL) 6 serving as a nonvolatile memory module operable to store data and a program are connected. The flash memory module (FMDL) 6 includes a data flash DFL as shown in FIG. 2 and a program flash PFL as shown in FIG. 3. The program flash PFL stores various software program for the central processing unit (CPU) 2, whereas the data flash DFL stores various data resulting from the execution of the programs by the central processing unit (CPU) 2.

To the peripheral bus PBUS, a flash sequencer (FSQC) 7 operable to perform command access control for the flash memory module (FMDL) 6, externally input/output ports (PRT) 8 and 9, a timer (TMR) 10, and a phase-locked loop (PLL) 11 operable to produce an internal clock signal of a microcomputer are connected. To the clock terminal XTAL/EXTAL, an oscillator is connected, or an external clock signal is supplied. A standby-state-directing signal is supplied to the external hardware standby terminal STBY, and a reset-directing signal is supplied to the external reset terminal RES. An operation source voltage is supplied to between the external source terminal Vcc and external ground terminal Vss.

Herein, the flash sequencer 7 is designed as a logic circuit by logical synthesis, and the flash memory module 6 taking a memory array structure is designed with a CAD tool. Therefore, they are shown as separate circuit blocks in the drawing for the sake of convenience. However, the flash sequencer 7 and flash memory module 6 are substantially integrated into one flash memory. The flash memory module 6 is connected to the high-speed bus HBUS through the read-only, high-speed access port (HACSP). Hence, CPU 2 and DMAC 3 can access the flash memory module 6 for read through the high-speed bus HBUS and high-speed access port (HACSP). When accessing the flash memory module 6 for write and erase, CPU 2 and DMAC 3 issue commands to the flash sequencer 7 through the bus interface 4 and peripheral bus PBUS. In response to them, the flash sequencer 7 controls write and erasing actions on the flash memory module through the peripheral bus PBUS and low-speed access port (LACSP).

The program flash PFL in the flash memory module (FMDL) 6 includes a plurality of single cells, for which a one-cell-to-one-bit writing method by which a single piece of data of one bit is written into a nonvolatile memory forming each single cell is adopted. Hence, the program flash PFL with a small number of times of data rewrite, which is included in the flash memory module (FMDL) 6, is capable of storing various software programs for the central processing unit (CPU) 2 of the microcomputer (MCU) 1 at a high density.

The data flash DFL in the flash memory module (FMDL) 6 includes a plurality of twin cells, and complementary data can be written into a pair of nonvolatile memories forming each twin cell. In response to a direction (command) from CPU 2, the flash sequencer 7 conducts a nonvolatile storing action for write or erase on the data flash DFL and program flash PFL, both included in the flash memory module (FMDL) 6.

In parallel, the flash sequencer 7 executes a blank-check action on the data flash DFL in response to a request from CPU 2. In other words, the flash sequencer 7 is set to the blank-check action mode. Then, the flash sequencer 7 actually offers a blank-check function to check the twin cell up to which the data flash DFL included in the flash memory module (FMDL) 6 has been already written and in use, and the twin cell from which the data flash DFL has not been written yet and remains initialized and erased.

In response to a cancel request from CPU 2, the flash sequencer 7 cancels the blank-check action mode, which has been set. On cancellation of the blank-check action mode, the normal read action on the data flash DFL is enabled. Between setting of the flash sequencer 7 to the blank-check action mode and the cancellation of the mode, the flash sequencer 7 controls the blank-check action on a portion of the data flash DFL of a required memory size.

As described above, the flash sequencer 7 goes into the blank-check action mode in response to a request for a blank-check on the twin cells of the data flash DFL from CPU 2. According to a more preferred embodiment of the invention, before the shift to the blank-check action mode, the flash sequencer 7 is supplied with the start address and capacity (termination address) of a blank-check-target region by CPU2. Hence, it becomes easier to execute the blank-check action on a plurality of target regions in the data flash DFL. As a result, it becomes possible to conduct the blank-check action on any target region in the data flash DFL. Specifically, at the time of start of the blank-check action of the flash sequencer 7 after completion of the shift to the blank-check action mode, a blank-check on twin cells of between the start address and termination address of a blank-check-target region is started. During the blank-check action, the flash sequencer 7 supplies CPU with blank-check-status information based on blank-check data of twin cells of e.g. eight bytes form the data flash DFL in response to a memory-read request from CPU. In parallel, the flash sequencer 7 supplies CPU with subsequent blank-check-status information based on blank-check data of another eight bytes of twin cells from the data flash DFL in response to a subsequent memory-read request from CPU. In this way, after completion of the blank-check action on the twin cells of the data flash DFL of between the start address and termination address of the target region, CPU 2 issues a request for cancel of the blank-check action mode to the flash sequencer 7.

### <<Blank-Check Action Mode>>

FIG. 10 is a diagram for explaining the way the blank-check function is implemented in the microcomputer (MCU) 1 according to an embodiment of the invention, which is shown in FIG. 1.

As in FIG. 10, CPU 2 of MCU 1 shown in FIG. 1 first issues a request for the blank-check action mode in connection with the flash sequencer 7 to perform a blank-check first in the period 20. Then, CPU 2 goes into the waiting state in the period 21. In response to the request for setting the blank-check action mode, which has been issued by CPU 2 in the period 20, the flash sequencer 7 brings the data flash DFL included in the flash memory module 6 to the blank-check action mode in the period 22. According to a more preferred embodiment of the invention, before the shift to the blank-check action mode, CPU 2 supplies the flash sequencer 7 is supplied with the start address of a blank-check-target region and the capacity (termination address) thereof in the period 20. In the period 22, the supply of voltage for blank-check to many twin cells of a memory region of a nonvolatile memory array targeted for the blank-check in the flash memory DFL is started, and then the many twin cells are stabilized in voltage/current. In the period 23, CPU issues a memory-read request. In response to the memory-read request, blank-check data are read out from twin cells representing the check size of eight bytes starting with a predetermined start address, and put into the internal register with the capacity of eight bytes under the control of the flash sequencer 7 in the data flash DFL in the period 24. Also, in the period 24, blank-check-status information generated from the blank-check data of eight bytes which have been read into the internal register is supplied to CPU 2 from the data flash DFL. In the period 25, CPU 2 verifies the blank-check-status information thus supplied. In the period 26, CPU 2 issues to a subsequent memory-read request. In response to the subsequent memory-read request, blank-check data for twin cells of another eight bytes of the data flash DFL are read into the internal register with the capacity of eight bytes under the control of the flash sequencer 7 in the period 271. Also, in the period 271, blank-check-status information generated from the blank-check data of eight bytes read out into the internal register is supplied to CPU 2 from the data flash DFL. In the period 281, CPU 2 verifies the blank-check-status information thus supplied. After the required blank-check on all the twin cells of the data flash DFL is completed in this way, CPU 2 issues a request for cancel of the blank-check action mode to the flash sequencer 7 in the period 282. Thereafter in the period 29, the blank-checked data flash DFL is brought to the read state so that normal data read is allowed at any time. The twin cells of the data flash DFL after the blank-check are stabilized in voltage/current in the read state.

### <<Flash Memory Module>>

FIG. 2 is a diagram showing a configuration of the data flash DFL included in the flash memory module (FMDL) 6 incorporated in the microcomputer (MCU) 1 shown in FIG. 1.

Various data resulting from the execution of the programs by the central processing unit (CPU) 2 of the microcomputer (MCU) 1 as in FIG. 1 are stored in the data flash DFL of the flash memory module 6 shown in FIG. 2. To make it possible to read data correctly even in case that the data flash DFL as shown in FIG. 2 has been fatigued owing to a large number of times of data rewrite thereof, a two-cell-to-one-bit writing method by which complementary data of one bit are written into a twin cell composed of a pair of nonvolatile memory cells MC1 and MC2 is adopted for the data flash DFL as shown in FIG. 2.

FIG. 3 is a diagram showing a configuration of the program flash PFL included in the flash memory module (FMDL) 6 incorporated in the microcomputer (MCU) 1 shown in FIG. 1.

Various software programs for the central processing unit (CPU) 2 of the microcomputer (MCU) 1 shown in FIG. 1 are stored in the program flash PFL of the flash memory module 6 shown in FIG. 3. To enable high-density storing on the program flash PFL shown in FIG. 3 with a small number of times of data rewrite, a one-cell-to-one-bit writing method by which a single piece of data of one bit is written into one nonvolatile memory cell MC0 is adopted for the program flash PFL of FIG. 3.

### <<Nonvolatile Memory Cell>>

FIG. 4A is a diagram showing a configuration of the nonvolatile memory cells MC1 and MC2 included in the data flash DFL shown in FIG. 2, and the nonvolatile memory cells MC0 included in the program flash PFL shown in FIG. 3, provided that complementary data of one bit are written into the data flash memory cells in memory cell pairs, whereas a single piece of data of one bit is written into each memory cell of the program flash. FIG. 4B is a diagram for explaining an action of the nonvolatile memory cells MC1 and MC2 and nonvolatile memory cell MC0. FIG. 4B is a diagram for explaining actions in connection with the nonvolatile memory cells MC1 and MC2, and MC0.

As shown in FIG. 4A, the nonvolatile memory cells MC1 and MC2, and MC0 are each composed of a split-gate type flash memory device. This type of memory device has a control gate (CG) and a memory gate (MG) formed on a gate-insulating layer over a channel region between a source and a drain. A charge-trap region (SiN) of e.g. silicon nitride is formed between the memory gate (MG) and gate-insulating layer. The source or drain region on the side of the control gate (CG) is connected to a bit line (BL), whereas the source or drain region on the side of the memory gate (MG) is connected to a source line (SL).

Now, referring to FIG. 4B, how the various actions in connection with the nonvolatile memory cells shown in FIG. 4A are executed will be described.

First, to lower the threshold voltage (Vth) of the memory cell, the bit line voltage BL, control gate voltage CG, memory gate voltage MG, source line voltage SL, and well region's voltage WELL are set so as to meet the conditions of BL=Hi-Z (high impedance state), CG=1.5 volts, MG=−10 volts, SL=6 volts, and WELL=0 volt, whereby electrons are drawn from the charge-trap region (SiN) into the well region (WELL) by a high electric field between the well region (WELL) and memory gate MG. This is performed in groups of memory cells sharing one memory gate.

Second, to raise the threshold voltage (Vth) of the memory cell, the voltage conditions of BL=0 volt, CG=1.5 volts, MG=10 volts, SL=6 volts, and WELL=0 volt are set, thereby causing a write current to flow from the source line SL to the bit line BL. As a result, hot electrons arising in a boundary portion between the control gate and memory gate are injected into the charge-trap region (SiN). This can be controlled in bits because the electron injection depends on whether or not current is passed through the bit line.

Further, a read action is conducted under the conditions of BL=1.5 volts, CG=1.5 volts, MG=0 volt, SL=0 volt, and WELL=0 volt. The memory cell is turned on when the threshold voltage of the memory cell is low, whereas it is turned off when the threshold voltage is high. The nonvolatile memory cells MC1 and MC2, and MC0 are not limited to the split-gate type flash memory device as shown in FIG. 4A, and they may be stacked-gate flash memory devices. Such stacked-gate flash memory device is formed by stacking a floating gate (FG) and a control gate (WL) on a gate-insulating layer formed on the channel region between the source and drain regions. The threshold voltage can be raised by the hot-carrier-writing method or FN tunnel-writing method, whereas the threshold voltage can be lowered by electron emission into the well region (WELL) or bit line (BL).

### <<A Pair of Nonvolatile Memory Cells Included in the Data Flash>>

FIGS. 5A-5C are diagrams for explaining three states of each twin cell composed of a pair of nonvolatile memory cells MC1 and MC2 which are included in the data flash DFL shown in FIG. 2 and which complementary data of one bit are written into.

The states of information storage of a twin cell composed of a pair of nonvolatile memory cells MC1 (positive cell) and MC2 (negative cell), which complementary data of one bit are written into, are classified into the following three types: an initialized-and-erased state (blank-erased state) shown in FIG. 5A; a state of Programmed Data “1” shown in FIG. 5B; and a state of Programmed Data “0” shown in FIG. 5C.

The initialized-and-erased state of a twin cell composed of a pair of nonvolatile memory cells MC1 (positive cell) and MC2 (negative cell) of the data flash DFL shown in FIG. 5A can be materialized by lowering the threshold voltage (Vth) of the memory cells in groups of the memory cells sharing a memory gate (MG) as shown in FIG. 2.

The state of Programmed Data “1” of a twin cell composed of a pair of nonvolatile memory cells MC1 and MC2 of the data flash DFL, which is shown in FIG. 5B, can be achieved by raising the threshold voltage (Vth) of the nonvolatile memory cell MC2 (negative cell) from the initialized-and-erased state shown in FIG. 5A under control on a bit-by-bit basis as described with reference to FIG. 2.

The state of Programmed Data “0” of a twin cell composed of a pair of nonvolatile memory cells MC1 and MC2 of the data flash DFL, which is shown in FIG. 5C, can be realized by raising the threshold voltage (Vth) of the nonvolatile memory cell MC1 (positive cell) from the initialized-and-erased state shown in FIG. 5A under control on a bit-by-bit basis as described with reference to FIG. 2.

### <<Nonvolatile Memory Cells Included in the Program Flash PFL>>

FIGS. 6A and 6B are diagrams for explaining two states of the nonvolatile memory cell MC0 which is included in the program flash PFL shown in FIG. 3 and which a single piece of data of one bit is written into.

The states of information storage of the nonvolatile memory cell MC0 which a single piece of data of one bit is written into are classified into the following two states: a state of Erased Data “1” shown in FIG. 6A; and a state of Programmed Data “0” shown in FIG. 6B.

The state of Erased Data “1” shown in FIG. 6A can be achieved by lowing memory cells' threshold voltage (Vth) in groups of memory cells sharing one memory gate (MG) as described with reference to FIG. 4A.

The state of Programmed Data “0” shown in FIG. 6B can be realized by raising the threshold voltage (Vth) of the nonvolatile memory cell MC0 from the state of Erased Data “1” shown in FIG. 6A under control on a bit-by-bit basis as described with reference to FIG. 2.

### <<Architecture of the Data Flash>>

Now, the architecture of the data flash DFL will be shown with reference to FIG. 2. The data flash DFL includes many twin cells each composed of one pair of nonvolatile memory cells MC1 and MC2, which complementary data of one bit are written into as described with reference to FIG. 5. In the data flash DFL, various data resulting from the execution of the programs by CPU 2 of MCU 1 as shown in FIG. 1 are stored.

The data flash DFL shown in FIG. 2 includes: a first nonvolatile memory array (MARY_J) 21; a second nonvolatile memory array (MARY_K) 22; a Y-decoder (YDEC) 23; a first Y-selector (YSEL_J) 24; a second Y-selector (YSEL_K) 25; and a sense amplifier (SA) 26. The data flash DFL further includes: a write-data-input buffer 27; a data-write-verify circuit 28; and a data-output-latch driver 29.

The first nonvolatile memory array (MARY_J) 21 and second nonvolatile memory array (MARY_K) 22 each include many twin cells, each composed of a pair of nonvolatile memory cells MC1 (positive cell) and MC 2 (negative cell), and therefore they can store various data resulting from the execution of programs by CPU 2. The control gates (CG), memory gates (MG) and sources of a pair of nonvolatile memory cells MC1 (positive cell) and MC2 (negative cell) arrayed in the X direction are connected to a word line (WL), a memory gate line (MGL) and a source line (SL), respectively.

To speed up data write and data read and lower power consumption, the layered-bit-line architecture is adopted for the first nonvolatile memory array (MARY_J) 21 and second nonvolatile memory array (MARY_K) 22. Specifically, a write main bit line WMBL and a read main bit line RMBL are connected to the first and second nonvolatile memory arrays (MARY_J and MARY_K) 21 and 22.

Sub-bit lines SBL connected to the nonvolatile memory cells MC1 and MC2 are each connected to the write main bit line WMBL through the source and drain of a switching MOS transistor Q3 of a bit line switch BL_SW. In case that data is written into the nonvolatile memory cell MC1 (positive cell), the switching MOS transistor Q3 of the bit line switch BL_SW between the sub-bit line SBL connected with the nonvolatile memory cell MC1 (positive cell) and the write main bit line WMBL is controlled through a control-signal line ZL into ON state. At the time of writing data into the data flash DFL shown in FIG. 2, the write data Qin is supplied to the write main bit line WMBL through the write-data-input buffer 27, a selector V_SEL of the data-write-verify circuit 28, and a write latch Write Latch. The write data supplied to the write main bit line WMBL is passed through the bit line switches BL_SW in each of the first and second nonvolatile memory arrays 21 and 22 and then written into the nonvolatile memory cell MC1 (positive cell) or nonvolatile memory cell MC2 (negative cell) of the data flash DFL. In MCU 1 shown in FIG. 1, the write data Qin to be provided to the write-data-input buffer 27 is supplied together with a write command to the data flash DFL of the flash memory module 6 from the flash sequencer 7 through the peripheral bus PBUS and low-speed access port (LACSP) in response to a write request from CPU 2.

The sub-bit lines SBL, to which the nonvolatile memory cells MC1 and MC2 of the first and second nonvolatile memory arrays (MARY_J and MARY_K) 21 and 22 are connected, are connected to the read main bit line RMBL through the first and second Y-selectors (YSEL_J and YSEL_K) 24 and 25, and the sense amplifier (SA) 26. To each sub-bit line SBL is further connected a discharge switch Dis_Sw, which is controlled by a discharge-control signal Dch for discharge of the potential of the sub-bit line SBL at the ends of read and write actions.

### <<Normal Data Read on the Data Flash>>

In MCU 1 of FIG. 1, an action to read the data flash DFL of FIG. 2 is started according to a read command to the data flash DFL of the flash memory module 6 through the high-speed bus HBUS and high-speed access port (HACSP) in response to a read request from CPU 2.

Specifically, an action to read normal data from a pair of nonvolatile memory cells MC1 (positive cell) and MC2 (negative cell), which constitute one twin cell of one of the first and second nonvolatile memory arrays 21 and 22 of the data flash DFL of FIG. 2 is started. The data which is read according to the normal data read is data of the state of Programmed Data “1” shown in FIG. 5B or data of the state of Programmed Data “0” shown in FIG. 5C. That is, the data which is read according to the normal data read are complementary data from a pair of nonvolatile memory cells MC1 (positive cell) and MC2 (negative cell), forming one twin cell.

As indicated by a signal path NR_RD for normal data read in FIG. 2, complementary data from a pair of nonvolatile memory cells MC1 and MC2 of the first nonvolatile memory array 21 are supplied, in parallel, to first and second input terminals In1 and In2 of the sense amplifier 26 through the two sub-bit lines SBL and first selector 24. Even in case that fatigue of the data flash DFL of FIG. 2 owing to a large number of times of data rewrite somewhat shrinks the difference between the threshold voltages of transistors of the pair of nonvolatile memory cells MC1 and MC2, the sense amplifier 26, which is a differential-amplification type sense amplifier, can amplify the shrunk difference of the threshold voltages correctly. Thus, even in case that an increased number of times of rewrite of the data flash DFL of FIG. 2 causes a memory cell of the data flash DFL to fatigue more or less, the sense amplifier 26 and data-output-latch driver 29 can output correct read data at the time of data read. The data, which have been read from the nonvolatile memory arrays 21 and 22 of the data flash DFL of FIG. 2 by the sense amplifier 26 and data-output-latch driver 29 in normal data read, can be provided to CPU 2 through the read-only high-speed access port (HACSP) and high-speed bus (HBUS) in MCU 1 of FIG. 1.

As described above, in normal data read of the data flash DFL, the Y-selectors 24 and 25 can supply complementary data from positive and negative cells constituting a twin cell of the nonvolatile memory arrays 21 and 22 to the first and second input terminals In1 and In2 of the sense amplifier 26 in parallel.

### <<Verify-Read of the Data Flash>>

In MCU 1 of FIG. 1, a write action on the data flash DFL of FIG. 2 is started according to a write command from the flash sequencer 7 to the data flash DFL of the flash memory module 6 through the peripheral bus PBUS and low-speed access port (LACSP) in response to a write request from CPU 2. In an action for write to a nonvolatile memory of the data flash DFL, a step of write-verify read to verify whether data has been written into a nonvolatile memory correctly is also conducted.

Specifically, write-verify read is performed in the write of complementary data to a pair of nonvolatile memory cells MC1 (positive cell) and MC2 (negative cell) forming a twin cell of either the first or second nonvolatile memory array 21 or 22 of the data flash DFL of FIG. 2. As described above, the write of complementary data to a pair of nonvolatile memory cells MC1 (positive cell) and MC2 (negative cell) is performed by raising the threshold voltage (Vth) of the one of the positive and negative cells from the initialized-and-erased state shown in FIG. 5A to the state as shown in FIG. 5B or 5C, followed by executing write-verify read.

Now, the action of write-verify read will be described in detail. As indicated by a verify-read signal path VR_RD of FIG. 2, write-verify read data from the memory cell whose threshold voltage (Vth) is raised at the time of writing complementary data is supplied to the first input terminal In1 of the sense amplifier 26 through one sub-bit line SBL and the first selector 24. In parallel with this, a write-verify reference level VR_Ref_DC arising from a reference cell Ref_Cell included in the data flash DFL is supplied to the second input terminal In2 of the sense amplifier 26 as shown in FIG. 16.

To raise the threshold voltage (Vth) of one of positive and negative cells at the time of writing complementary data, a write pulse is applied under the voltage conditions: BL=0 volt, CG=−1.5 volts, MG=10 volts, SL=6 volts, and WELL=0 volt. After application of the write pulse, if it is judged from the result of verify read using the signal path VR_RD that the threshold voltage (Vth) of one of a pair of memory cells is below the write-verify reference level, the write is judged to be insufficient. In this case, a subsequent write pulse is applied to the one memory cell again under the same voltage conditions. In contrast, if after the application of the subsequent write pulse, it is judged from the result of write-verify read using the signal path VR_RD that the threshold voltage (Vth) of the one memory cell is above the write-verify reference level, the write is judged to be sufficient.

The action of write-verify read will be described further in detail. In case of insufficient write, an exclusive-NOR circuit EXNOR of the data-write-verify circuit 28 produces an output of Low level “0”. In case that the unit of write is eight bits of twin cells, at least one of eight exclusive-NOR circuits EXNOR produces an output of Low level “0”, the AND circuit AND produces an output of Low level “0”, and then a subsequent write pulse is applied again to the twin cells corresponding to the unit of write of eight bits. In case of sufficient write, the exclusive-NOR circuit EXNOR of the data-write-verify circuit 28 produces an output of High level “1”. In case that the unit of write is eight bits of twin cells, eight exclusive-NOR circuits EXNOR produce outputs of High level “1”, the AND circuits AND produce outputs of High level “1”, and then the write to the twin cells of eight bits corresponding to the unit of write is completed.

As described above, in the write-verify read of the data flash DFL, the Y-selectors 24 and 25 can supply write-verify read data form one of twin cells of nonvolatile memory array 21 or 22, to which write is performed, and the write-verify reference level to the first and second input terminals of the sense amplifier 26 in parallel.

In MCU 1 of FIG. 1, an erasing action on the data flash DFL of FIG. 2 is started according to an erase command from the flash sequencer 7 to the data flash DFL of the flash memory module 6 through the peripheral bus PBUS and low-speed access port (LACSP) in response to a request for erase from CPU 2. The action to erase a nonvolatile memory of the data flash DFL includes a step of erase-verify read to verify whether or not the nonvolatile memory is erased correctly.

In writing complementary data into a pair of nonvolatile memory cells MC1 (positive cell) and MC2 (negative cell), which forms one twin cell, the data flash DFL of FIG. 2 requires an action (initialize-erasing action) to write erase data corresponding to the low threshold voltage into the pair of nonvolatile memory cells before writing the complementary data. The initialize-erasing action needs a step of erase-verify read to verify whether or not the erase data of low threshold voltage is written into the pair of nonvolatile memory cells correctly.

In any of the initialize-erasing action before the write of complementary data and the erasing action according to an erase command, a pair of nonvolatile memory cells MC1 (positive cell) and MC2 (negative cell) of twin cells sharing a control gate (CG) and a memory gate (MG) is treated as a unit of handling of the erasing actions. To lower the threshold voltage (Vth) of a pair of nonvolatile memory cells MC1 (positive cell) and MC2 (negative cell) of twin cells, which is the unit of handling of the erasing actions, an erasing pulse is applied under the voltage conditions of BL=Hi-Z (high-impedance state), CG=1.5 volts, MG=−10 volts, SL=6 volts and WELL=0 volt. After application of the erasing pulse, the erase-verify read is conducted according to the signal path VR_RD. In case that as a result of the erase-verify read, the threshold voltage (Vth) of the memory cells is judged to be above an erase-verify reference level, the erase is judged to be insufficient, and then the erasing pulse is applied to the memory cells again under the above voltage conditions. In contrast, in case that as a result of the erase-verify read, the threshold voltage (Vth) of the memory cells is judged to be below the verify reference level, the erase is regarded as sufficient.

Now, the action of erase-verify read will be described further in detail. In case of insufficient erase, the exclusive-NOR circuit EXNOR of the data-write-verify circuit 28 produces an output of Low level “0”. In case that the unit of erase is eight bits of twin cells, when at least one of eight exclusive-NOR circuits EXNOR produces an output of Low level “0”, the AND circuit AND produces an output of Low level “0”, and then a subsequent erasing pulse is applied again to the twin cells corresponding to the unit of erase of eight bits.

In case of sufficient erase, the exclusive-NOR circuit EXNOR of the data-write-verify circuit 28 produces an output of High level “1”. In case that the unit of erase is eight bits of twin cells, eight exclusive-NOR circuits EXNOR produce outputs of High level “1”, the AND circuits AND produce outputs of High level “1”, and then erase of the twin cells of eight bits corresponding to the unit of erase is completed.

Hence, in the erase-verify read on the data flash DFL, the Y-selectors 24 and 25 can supply erase-verify read data from, twin cells of nonvolatile memory array 21 or 22 of the unit of erase, the cell subjected to the erase, and the erase-verify reference level to the first and second input terminals of the sense amplifier 26 in parallel. <<Blank-check in the data flash>>

In MCU 1 of FIG. 1, a blank-check on the data flash DFL of FIG. 2 is started according to a blank-check command from the flash sequencer 7 to the data flash DFL of the flash memory module 6 through the peripheral bus PBUS and low-speed access port (LACSP) in response to a request for a blank-check from CPU 2.

To perform the blank-check, CPU 2 first issues a request for a blank-check action mode of the flash sequencer 7, and then goes into the waiting state. In response to the blank-check request issued by CPU 2, the flash sequencer 7 transfers the data flash DFL of FIG. 2 to the blank-check action mode. Before such transfer, the flash sequencer 7 is supplied with the start address and capacity (termination address) of a blank-check-target region from CPU 2. The supply of voltage for blank-check to many twin cells of a memory region of the nonvolatile memory array 21 targeted for the blank-check in the data flash DFL of FIG. 2 is started, and then the many twin cells are stabilized in voltage/current. Blank-check data from a memory cell MC1 (positive cell), which is one of a pair nonvolatile memory cells of forming one twin cell, and blank-check data from the other memory cell MC2 (negative cell) are supplied to the first input terminal In1 of the sense amplifier 26 through the first selector 24 and verify-read signal path VR_RD sequentially. During the supply, a reference voltage substantially intermediate in level between the low threshold voltage of the state of Programmed Data “1” shown in FIG. 5B, and the high threshold voltage is supplied to the second input terminal In2 of the sense amplifier 26.

Subsequently, the read action to verify whether or not twin memory cells are in the blank state is performed. In case that a memory cell MC1 (positive cell), which is one of a pair of nonvolatile memory cells forming a twin cell, and the other memory cell MC2 (negative cell) are judged to have a threshold voltage lower than the reference voltage in level, the twin cell is judged to be blank, i.e. in the initialized-and-erased state. However, in case that at least one of a pair of nonvolatile memory cells MC1 (positive cell) and MC2 (negative cell) forming a twin cell is judged to have a threshold voltage higher than the reference voltage in level, the twin cell is judged not to be blank, i.e. in the initialized-and-erased state.

In this way, blank-check data from twin cells representing the check size of eight bytes at addresses starting with the start address of a blank-check-target region in the data flash DFL are read out into the internal register with a capacity of eight bytes under the control of the flash sequencer 7. The blank-check-status information generated from the eight bytes of blank-check data thus read out into the internal register is provided to CPU 2 from the data flash DFL. CPU 2 verifies the supplied blank-check-status information.

### <<Architecture of the Program Flash>>

Now, referring to FIG. 3, the architecture of the program flash PFL will be described. The program flash PFL includes many nonvolatile memory cells MC0, which a single piece of data of one bit is written into as described with reference to FIGS. 6A and 6B, and serves to store various software programs for CPU 2 of MCU 1 of FIG. 1.

The program flash PFL of FIG. 3 has a remarkable similarity in configuration to the data flash DFL of FIG. 2. Specifically, the program flash PFL of FIG. 3 includes a third nonvolatile memory array (MARY_J) 31, a fourth nonvolatile memory array (MARY_K) 32, a Y-decoder (YDEC) 33, a third Y-selector (YSEL_J) 34, a fourth Y-selector (YSEL_K) 35 and a sense amplifier (SA) 36. The program flash PFL further includes a write-data-input buffer 37, a data-write-verify circuit 38 and a data-output-latch driver 39.

The third nonvolatile memory array (MARY_J) 31 and fourth nonvolatile memory array (MARY_K) 32 each include many nonvolatile memory cells MC0, and therefore the third and fourth arrays can store various software programs for CPU 2. Control gates (CG), memory gates (MG) and sources of the many nonvolatile memory cells MC0 arrayed in the X direction are connected to a word line (WL), a memory gate line (MGL) and a source line (SL) respectively.

To speed up data write and data read and lower power consumption, the layered-bit-line architecture is adopted for the third nonvolatile memory array (MARY_J) 31 and fourth nonvolatile memory array (MARY_K) 32. Specifically, one write main bit line WMBL and one read main bit line RMBL are connected to the third and fourth nonvolatile memory arrays (MARY_J and MARY_K) 31 and 32.

The sub-bit lines SBL connected with nonvolatile memory cells MC0 are connected to the only one write main bit line WMBL through the sources and drains of the switching MOS transistors Q3 of the bit line switches BL_SW. In case that data is written into a nonvolatile memory cell MC0, the switching MOS transistor Q3 of the bit line switch BL_SW between the sub-bit line SBL connected with the nonvolatile memory cell MC0 and the write main bit line WMBL is controlled through a control-signal line ZL into ON state. At the time of writing data into the program flash PFL shown in FIG. 3, the write data Qin is supplied to the one write main bit line WMBL through the write-data-input buffer 37, the selector V_SEL of the data-write-verify circuit 38 and the write latch Write Latch. The write data supplied to the write main bit line WMBL is passed through the bit line switches BL_SW in each of the third and fourth nonvolatile memory arrays 31 and 32 and then written into the nonvolatile memory cell MC0 of the program flash PFL. Besides, in MCU 1 shown in FIG. 1, the write data Qin to be provided to the write-data-input buffer 37 is supplied together with a write command from the flash sequencer 7 to the program flash PFL of the flash memory module 6 through the peripheral bus PBUS and low-speed access port (LACSP) in response to a write request from CPU 2.

The sub-bit lines SBL, to which the nonvolatile memory cells MC0 of the third and fourth nonvolatile memory arrays (MARY_J and MARY_K) 31 and 32 are connected, are connected to the read main bit line RMBL through the third and fourth Y-selectors (YSEL_J and YSEL_K) 34 and 35, and the sense amplifier (SA) 36. To each sub-bit line SBL is further connected a discharge switch Dis_Sw, which is controlled by a discharge-control signal Dch for discharge of the potential of the sub-bit line SBL at the ends of read and write actions.

### <<Normal Data Read on the Program Flash>>

In MCU 1 of FIG. 1, a read action on the program flash PFL of FIG. 3 is started according to a read command to the program flash PFL of the flash memory module 6 through the high-speed bus HBUS and high-speed access port (HACSP) in connection with a read request from CPU 2.

Specifically, the action to read normal data, i.e. a single piece of data of one bit, from one nonvolatile memory cell MC0 of one of the third and fourth nonvolatile memory arrays 31 and 32 of the program flash PFL of FIG. 3 is started. The data which is read according to the normal data read is of the state of Programmed Data “0” shown in FIG. 6B or the state of Erased Data “1” of FIG. 6A.

As indicated by the signal path NR_RD of the normal data read of FIG. 3, a single piece of data from one nonvolatile memory cell MC0 of the third nonvolatile memory array 31 is supplied to the first input terminal In1 of the sense amplifier 36 through the one corresponding sub-bit line SBL and third selector 34. In parallel with this, a normal-data-read reference level generated by the reference cell, which is not shown, is supplied to the second input terminal In2 of the sense amplifier 36. The normal-data-read reference level corresponds to a threshold voltage substantially intermediate in level between the low threshold voltage of the state of Erased Data “1” shown in FIG. 6A and the high threshold voltage of the state of Programmed Data “0” shown in FIG. 6B. As to the program flash PFL of FIG. 3 which is relatively small in the number of times of rewrite, high-density storing on the program flash PFL of FIG. 1 can be achieved. This is because the one-cell-to-one-bit writing method by which a single piece of data of one bit is written into one nonvolatile memory cell MC0 is adopted for the program flash PFL. Program data which is read in normal data read from the nonvolatile memory arrays 31 and 32 of the program flash PFL of FIG. 3 with the sense amplifier 36 and data-output-latch driver 39 can be supplied to CPU 2 through the read-only high-speed access port (HACSP) and high-speed bus (HBUS) in MCU 1 of FIG. 1.

As described above, in the normal data read from the program flash PFL, the Y-selector 34/35 supplies a single piece of data from one nonvolatile memory cell MC0 of the nonvolatile memory array 31/32 to one of the first and second input terminals In1 and In2 of the sense amplifier 36. On the other hand, in this normal data read, the Y-selectors 34 and 35 can supply the normal-data-read reference level to the other input terminal of the first and second input terminals In1 and In2 of the sense amplifier 36.

### <<Verify Read on the Program Flash>>

In MCU 1 of FIG. 1, CPU 2 or DMAC 3 issues a request for program write to the flash memory module 6 with a relatively low frequency. The program-write action on the program flash PFL of FIG. 3 is started according to a program-write command from the flash sequencer 7 to the program flash PFL of the flash memory module 6 through the peripheral bus PBUS and low-speed access port (LACSP) in connection with a request for program write. With the program flash PFL, in the program-write action on the nonvolatile memory, it is required to execute a step of write-verify read to verify whether or not program data have been written into the nonvolatile memory correctly.

Hence, in writing a single piece of data of one bit into a nonvolatile memory cell MC0 of one of the third and fourth nonvolatile memory arrays 31 and 32 of the program flash PFL of FIG. 3, the write-verify read is performed. As described above, the write of a single piece of data to a nonvolatile memory cell MC0 can be achieved by raising the threshold voltage (Vth) of the nonvolatile memory cell MC0 from the erased state of FIG. 6A to the state shown in FIG. 6B.

As indicated by the verify-read signal path VR_RD shown in FIG. 3, a single piece of data from one nonvolatile memory cell MC0 of the third nonvolatile memory array 31 is supplied to the first input terminal In1 of the sense amplifier 36 through one sub-bit line SBL and the third selector 34 as with the signal path NR_RD in the normal data read. In parallel with this, a write-verify reference level generated by the reference cell, which is not shown, is supplied to the second input terminal In2 of the sense amplifier 36. The write-verify reference level corresponds to a threshold voltage substantially intermediate in level between the low threshold voltage of the state of Erased Data “1” shown in FIG. 6A and the high threshold voltage of the state of Programmed Data “0” shown in FIG. 6B. It is preferable that the write-verify reference level is closer to the high threshold voltage of the state of Programmed Data “0” shown in FIG. 6B rather than a threshold voltage of the intermediate level.

To raise the threshold voltage (Vth) of the nonvolatile memory cell MC0 in writing a single piece of data, a write pulse is applied under the voltage conditions of BL=0 volt, CG=1.5 volts, MG=10 volts, SL=6 volts and WELL=0 volt. After application of the write pulse, if the result of the verify read using the signal path VR_RD shows that the threshold voltage (Vth) of the nonvolatile memory cell MC0 is below the write-verify reference level, the write is regarded as insufficient. In this case, a subsequent write pulse meeting the same voltage conditions is applied to the nonvolatile memory cell MC0 again. After application of this subsequent write pulse, if it is judged from the result of the write-verify read using the signal path VR_RD that the threshold voltage (Vth) of the nonvolatile memory cell MC0 is above the write-verify reference level, the write is judged to be sufficient.

In case of insufficient write, the exclusive-NOR circuit EXNOR of the data-write-verify circuit 38 produces an output of Low level “0”. In case that the unit of write is eight bits of nonvolatile memory cells MC0, at least one of eight exclusive-NOR circuits EXNOR produces an output of Low level “0”, the AND circuit AND produces an output of Low level “0”, and then a subsequent write pulse is applied to the nonvolatile memory cells MC0 corresponding to the unit of write of eight bits again. In case of sufficient write, the exclusive-NOR circuit EXNOR of the data-write-verify circuit 38 produces an output of High level “1”. In case that the unit of write is eight bits of nonvolatile memory cells MC0, eight exclusive-NOR circuits EXNOR produce outputs of High level “1”, the AND circuits AND produce outputs of High level “1”, and then the write on the nonvolatile memory cells MC0 of eight bits corresponding to the unit of write is completed.

As described above, in the write-verify read on the program flash PFL, a single piece of data from one nonvolatile memory cell MC0 of the third nonvolatile memory array 31 is supplied to the first input terminal In1 of the sense amplifier 36 through the corresponding sub-bit line SBL and the third selector 34 using the verify-read signal path VR_RD, which is exactly the same as the signal path NR_RD used in the normal data read. In parallel with this, a write-verify reference level produced by the reference cell, which is not shown, is supplied to the second input terminal In2 of the sense amplifier 36.

In MCU 1 of FIG. 1, the erasing action on the program flash PFL of FIG. 3 is started according to an erase command from the flash sequencer 7 to the program flash PFL of the flash memory module 6 through the peripheral bus PBUS and low-speed access port (LACSP) in connection with an erase request from CPU 2, the frequency of which is relatively low. In the erasing action on the nonvolatile memory of the program flash PFL, it is required to perform the erase-verify read to verify whether the nonvolatile memory has been erased correctly.

Further, for the program flash PFL of FIG. 3, it is required to perform the erasing action on all of the nonvolatile memory cells MC0 included in the third and fourth nonvolatile memory arrays 31 and 32 before writing a single piece of data into one nonvolatile memory cell MC0. All the nonvolatile memory cells MC0 included in the third and fourth nonvolatile memory arrays 31 and 32 are made the low threshold voltage of the state of Erased Data “1” shown in FIG. 6A by the erasing action. This erasing action needs the erase-verify action to verify whether Erased Data “1” of the low threshold voltage has been written into the nonvolatile memory cells MC0 correctly. In the erasing action, the nonvolatile memory cells MC0 are handled in groups of memory cells sharing a control gate (CG) and a memory gate (MG). To lower the threshold voltage (Vth) of a group of nonvolatile memory cells MC0, which correspond to the handling unit of the erasing action, an erasing pulse is applied under the voltage conditions of BL=Hi-Z (high-impedance state), CG=1.5 volts, MG=−10 volts, SL=6 volts and WELL=0 volt. After application of the erasing pulse, if it is judged from the result of the erase-verify read using the signal path VR_RD that the threshold voltage (Vth) of the memory cells is above the verify reference level, the erase is judged to be insufficient. In this case, the erasing pulse is applied again to the group of nonvolatile memory cells MC0, which corresponds to the handling unit of the erasing action, under the above voltage conditions. Further, after application of an additional erasing pulse, if it is judged from the result of the erase-verify read using the erasing signal path VR_RD that the threshold voltage (Vth) of the memory cells are above the verify reference level, the erase is judged to be sufficient.

In case of insufficient erase, the exclusive-NOR circuit EXNOR of the data-write-verify circuit 38 produces an output of Low level “0”. In case that the unit of erase is eight bits of nonvolatile memory cells MC0, at least one of eight exclusive-NOR circuits EXNOR produces an output of Low level “0”, the AND circuit AND produces an output of Low level “0”, and then a subsequent erasing pulse is applied to the nonvolatile memory cells MC0 corresponding to the unit of erase of eight bits again. In case of sufficient erase, the exclusive-NOR circuit EXNOR of the data-write-verify circuit 38 produces an output of High level “1”. In case that the unit of erase is eight bits of nonvolatile memory cells MC0, eight exclusive-NOR circuits EXNOR produce outputs of High level “1”, the AND circuits AND produce outputs of High level “1”, and then the erase on the nonvolatile memory cells MC0 of eight bits corresponding to the unit of erase is completed.

A single piece of data from one nonvolatile memory cell MC0 of the third nonvolatile memory array 31 is supplied to the first input terminal In1 of the sense amplifier 36 through the corresponding sub-bit line SBL and the third selector 34 as indicated by the verify-read signal path VR_RD of FIG. 3 exactly in the same way as in the case of normal data read using the signal path NR_RD. In parallel with this, an erase-verify reference level VR_Ref_DC generated by the reference cell Ref_Cell included in the program flash PFL as shown in FIG. 17 is supplied to the second input terminal In2 of the sense amplifier 36. The erase-verify reference level corresponds to a threshold voltage substantially intermediate in level between the low threshold voltage of the state of Erased Data “1” shown in FIG. 6A and the high threshold voltage of the state of Programmed Data “0” shown in FIG. 6B. It is preferable that the erase-verify reference level is closer to the low threshold voltage of the state of Erased Data “1” shown in FIG. 6A rather than a threshold voltage of the intermediate level.

As described above, in the erase-verify read on the program flash PFL, a single piece of data from one nonvolatile memory cell MC0 of the third nonvolatile memory array 31 is supplied to the first input terminal In1 of the sense amplifier 36 through the corresponding sub-bit line SBL and the third selector 34 using the verify-read signal path VR_RD, which is exactly the same as the signal path NR_RD used in the normal data read. In parallel with this, an erase-verify reference level VR_Ref_DC generated by the reference cell Ref_Cell, which is not shown in the drawing, is supplied to the second input terminal In2 of the sense amplifier 36.

### <<Details of the Blank-Check on the Data Flash>>

FIG. 11 is a diagram showing an arrangement of various types of data stored in the data flash DFL of the flash memory module (FMDL) 6 incorporated in the microcomputer (MCU) 1 shown in FIG. 1.

Referring to FIG. 11, three types of data 30A, data 30B, and data 30C are shown. Write data Data written into one twin cell, which consist of complementary data, are contained in the first portion of each type of data, and the second portion is blank, which is denoted by “Blank”. New complementary data can be additionally written into the many twin cells in a memory region, which correspond to the second portions in the blank state.

FIG. 12 is a flowchart showing a process flow for executing the blank-check on the various types of data shown in FIG. 11.

FIG. 13 is a diagram showing a configuration of the flash sequencer 7 suitable to execute the blank-check according to the process flow shown in FIG. 12.

The flash sequencer 7 shown in FIG. 13 is connected between CPU 2 and the data flash DFL of the flash memory module 6. Particularly, the flash sequencer 7 is connected with CPU 2 through a peripheral address bus PAB of the peripheral bus PBUS and a peripheral data bus PDB thereof. The flash sequencer 7 includes a sequence controller 71, a blank-check-setting register 72, a rising-edge detector 73, a blank-start-address-storing register 74, a falling-edge detector 75, a blank-termination-address-storing register 76 and a blank-check-detection register 77. The blank-check-setting register 72 can store the start address of a blank-check-target region and the capacity range (termination address) thereof in the data flash DFL, which are sent from CPU 2. The flash sequencer 7 is supplied with an access-base clock CLKP generated by PLL 11 incorporated in the microcomputer (MCU) 1 shown in FIG. 1 and a detection clock CLKI. The detection clock CLKI is supplied to latch control input terminals of the rising-edge detector 73 and falling-edge detector 75. In response to a rising-edge-detection signal from the rising-edge detector 73, a blank-check address from the sequence controller 71 is stored in the blank-start-address-storing register 74. On the other hand, in response to a falling-edge-detection signal from the falling-edge detector 75, the blank-check address from the sequence controller 71 is stored in the blank-termination-address-storing register 76. Besides, in response to a rising-edge-detection signal from the rising-edge detector 73, the blank-start signal B_S of the blank-check-detection register 77 is set to High level “1”, whereas in response to a falling-edge-detection signal from the falling-edge detector 75, the blank-termination signal B_E of the blank-check-detection register 77 is set to High level “1”.

First, in Step 40 of the process flow of FIG. 12, CPU 2 sends a request for a blank-check concerning various types of data stored in the data flash DFL, e.g. the data 30A of FIG. 11 to the flash sequencer 7.

In Step 41 of FIG. 12, the start address and capacity range of a blank-check-target region concerning the data 30A of FIG. 11 sent from CPU 2 are put in the blank-check-setting register 72 inside the flash sequencer 7.

In Step 42 of FIG. 12, CPU 2 issues a blank-check command to the sequence controller 71 inside the flash sequencer 7. Then, the sequence controller 71 in the flash sequencer 7 outputs, in turn, addresses of twin cells of the nonvolatile memory array of the data flash DFL to be checked in blank, which start with the start address of a blank-check-target region stored in the blank-check-setting register 72, to an internal address bus IAB. The check addresses of the twin cells output in turn to the internal address bus IAB are supplied to the twin cells of the nonvolatile memory array through the low-speed access port (LACSP) 61 of the data flash DFL in turn. The twin cells undergo the blank-check in turn, and thus results 61A of the blank-checks are created in the data flash DFL.

The result 61A of the blank-check of the data flash DFL is supplied, as a blank signal Blank, to the rising-edge detector 73 and falling-edge detector 75 in the flash sequencer 7 through the low-speed access port (LACSP) 61 and internal data bus IDB. Write data consisting of complementary data written into one twin cell are contained in the first portion of the data 30A of FIG. 11. Therefore, blank signals Blank from a twin cell at the start address of a blank-check-target region and a twin cell at the subsequent address show Low level “0” (Being used). In contrast, the second portion of the data 30A of FIG. 11 is blank, which is denoted by “Blank”. Therefore, blank signal Blanks from twin cells at and after a certain address between the start and termination addresses are of High level “1” (Unused blank state).

FIG. 14 is a diagram for explaining actions of the flash sequencer 7 shown in FIG. 13, showing waveforms in the parts of the flash sequencer 7.

The top two portions of FIG. 14 present the access-base clock CLKP generated by PLL 11 incorporated in the microcomputer (MCU) 1 shown in FIG. 1 and the detection clock CLKI, respectively.

The third portion of FIG. 14 from the top shows an address signal for a blank-check, which is output from the sequence controller 71 to the internal address bus IAB sequentially. The fourth portion of FIG. 14 shows the change of the blank signal Blank which is output from the data flash DFL to the internal data bus IDB.

The fifth and seventh portions of FIG. 14 show the change of the blank-start signal B_S and blank-termination signal B_E of the blank-check-detection register 77, respectively.

The sixth and eighth portions of FIG. 14 show a blank-start address stored in the blank-start-address-storing register 74 and a blank-termination address stored in the blank-termination-address-storing register 76, respectively. In the example shown in FIG. 14, an address signal (L+1) for a blank-check output to the internal address bus IAB corresponds to the start address of the blank of the second portion of the data 30A of FIG. 11. Also, in the example of FIG. 14, an address signal (N) for a blank-check output to the internal address bus IAB represents the termination address of the blank of the second portion of the data 30A of FIG. 11.

When the start and termination addresses of the blank of the second portion of the data 30A of FIG. 11 are detected, the blank-check on the data 30A of FIG. 11 is completed. Then, the blank-start signal B_S of the blank-check-detection register 77 is set to High level “1”. The blank-termination signal B_E of the blank-check-detection register 77 is set to High level “1” in response to the falling-edge-detection signal from the falling-edge detector 75. The sequence controller 71 then supplies a response signal of blank-check completion to CPU 2 through the peripheral data bus PDB of the peripheral bus PBUS. In response to the response signal, CPU 2 disables the blank-check command, which CPU 2 has issued in Step 42 of FIG. 12, in Step 43 of FIG. 12.

In case that the blank-check command is terminated in Step 43 of FIG. 12, CPU 2 verifies the blank-start signal B_S and blank-termination signal B_E of the blank-check-detection register 77 through the peripheral data bus PDB of the peripheral bus PBUS in the subsequent Step 44. Subsequently in Step 45, CPU 2 verifies the blank-start address stored in the blank-start-address-storing register 74 and the blank-termination address stored in the blank-termination-address-storing register 76 through the peripheral data bus PDB of the peripheral bus PBUS.

After the completion of the steps described above, the process of blank-check is finished in Step 46 of FIG. 12.

FIG. 18 is a diagram showing other arrangement of various types of data stored in the data flash DFL of the flash memory module (FMDL) 6 incorporated in the microcomputer (MCU) 1 shown in FIG. 1.

Write data Data written into one twin cell, which consist of complementary data, are contained in the first and second portions of the two types of data 50A and 50B shown in FIG. 18. The middle portions of these data are blank, which are denoted by “Blank”. New complementary data can be additionally written into the many twin cells in a memory region, which correspond to the middle portions in the blank state.

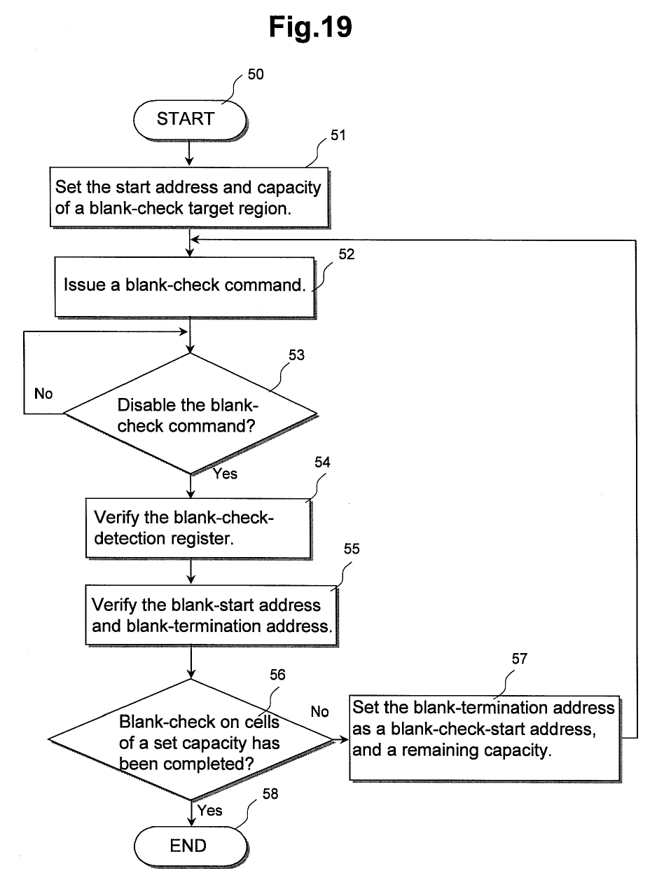

FIG. 19 is a flowchart showing a process flow for executing the blank-check on the middle portions of data as shown in FIG. 18 in blank state.

FIG. 20 is a diagram showing a configuration of the flash sequencer 7 suitable to execute the blank-check according to the process flow shown in FIG. 19. The process steps of Step 50 to Step 55 of FIG. 19 are exactly the same as those of Step 40 to Step 45 of FIG. 12, and therefore their descriptions are omitted. In Step 56 of FIG. 19, the sequence controller 71 of the flash sequencer 7 of FIG. 20 verifies whether or not the blank-check on a memory region has been completed to the end of write data Data in the second portion of the data 50A of FIG. 18. If not, the sequence controller 71 again sets, as a new blank-check-start address, the blank-termination address on the boundary between the middle portion of the blank state Blank and write data Data of the second portion of the data 50A of FIG. 18 in Step 57 of FIG. 19. Also, the sequence controller 71 sets the memory capacity of write data Data of the second portion as the capacity of a blank-check target region again. Thereafter, the process steps of Step 50 to Step 55 of FIG. 20 are carried out again, whereby the sequence controller 71 checks whether or not there is a blank in the write data Data of the second portion of data 50A of FIG. 18.

The flash sequencer 7 shown in FIG. 20 has a remarkable similarity in configuration to the flash sequencer 7 shown in FIG. 13. However, in the flash sequencer 7 shown in FIG. 20, a falling-edge-detection signal from the falling-edge detector 75 is supplied to the sequence controller 71 of the flash sequencer 7 in FIG. 20. Using the falling-edge-detection signal from the falling-edge detector 75, the blank-termination address on the boundary between the middle portion of the blank state Blank and write data Data of the second portion of the data 50A of FIG. 18 can be detected in Step 52 of FIG. 19. However, the sequence controller 71 handles the memory capacity of the write data Data of the second portion of the data 50A as the capacity of a blank-check-target region, and again sets the capacity as an entry of the capacity range in the blank-check-setting register 72. If none of check addresses of twin cells, which are outputs to the internal address bus IAB sequentially, reach an end address determined for a capacity range stored in the blank-check-setting register 72 on the second setting, the sequence controller 71 sets an unended flag NF of the blank-check-detection register 77 to High level “1”. Then, the sequence controller 71 sends a response signal of an uncompleted blank-check to CPU2 through the peripheral data bus PDB of the peripheral bus PBUS. CPU 2 never falsely disables the blank-check command based on a blank-termination address on the boundary described above in response to the response signal.

FIG. 21 is a diagram showing a configuration of the flash sequencer 7 suitable to handle blank-checks on two or more types of data as shown in FIG. 11 in one blank-check process.

The flash sequencer 7 shown in FIG. 21 first conducts a blank-check on twin cells concerning the first type of data 30A shown in FIG. 11. Then, the blank-start address and blank-termination address of the blank state Blank of the second portion of the data 30A are stored in the blank-start-address-storing register 74 and blank-termination-address-storing register 76, respectively. As to the second portion of the data 30A in the blank state Blank, the blank-start signal B_S and blank-termination signal B_E in the blank-check-detection register 77 have been set to High level “1”. The stored data of the address-storing registers 74 and 76 in connection with the blank state Blank in the second portion of the data 30A, and the blank-start signal B_S and blank-termination signal B_E of the blank-check-detection register 77 are transferred to a first region of the random access memory (RAM) 5 from the flash sequencer 7. The path for the transfer runs through the peripheral bus PBUS, bus interface circuit 4 and high-speed bus HBUS.

Subsequently, the flash sequencer 7 executes a blank-check in connection with the second type of data 30B shown in FIG. 11. Then, the blank-start address and blank-termination address in the second portion the blank state Blank of the data 30B are stored in the blank-start-address-storing register 74 and blank-termination-address-storing register 76, respectively. In connection with the second portion of the blank state Blank of the data 30B, the blank-start signal B_S and blank-termination signal B_E in the blank-check-detection register 77 are set to High level “1”. The stored data in the address-storing registers 74 and 76, and the blank-start signal B_S and blank-termination signal B_E in the blank-check-detection register 77, which are in connection with the second portion of the blank state Blank of the data 30B, are transferred to a second region of RAM 5 from the flash sequencer 7.

Finally, the flash sequencer 7 conducts a blank-check in connection with the third type of data 30C shown in FIG. 11. Then, the blank-start address and blank-termination address of the second portion of the blank state Blank of the data 30C are stored in the blank-start-address-storing register 74 and blank-termination-address-storing register 76, respectively. As to the second portion of the blank state Blank of the data 30C, the blank-start signal B_S and blank-termination signal B_E in the blank-check-detection register 77 are set to High level “1”. The stored data in the address-storing registers 74 and 76, and the blank-start signal B_S and blank-termination signal B_E in the blank-check-detection register 77, which are in connection with the second portion of the blank state Blank of the data 30C, are transferred to a third region of RAM 5 from the flash sequencer 7.

As described above, it becomes possible by using the flash sequencer 7 shown in FIG. 21 to handle blank-checks for two or more types of data as shown in FIG. 11 in one blank-check process according to one blank-check command from CPU 2.

### <<Partition of the Data Flash and Program Flash>>

As described above, the program flash PFL shown in FIG. 3 has a remarkable similarity in configuration to the data flash DFL shown in FIG. 2. Hence, in a preferred embodiment of the invention, the layout of the data flash DFL of FIG. 2 and program flash PFL of FIG. 3 in the flash memory module 6 of MCU 1 of FIG. 1 can be set appropriately.

FIG. 15 is a diagram for explaining how the locations of the data flash DFL and program flash PFL are set appropriately in the flash memory module (FMDL) 6 of MCU 1 of FIG. 1. The lowest portion of the flash memory module (FMDL) 6 shown in FIG. 15 includes a control-management area Cnt_Area. The control-management area Cnt_Area can hold various control codes of MCU 1, and its head portion includes initialization-control-code data INT_Data of MCU 1.

In system initialization at the time of system reset, e.g. power-on, of MCU 1 of FIG. 1, CPU 2 reads initialization-control-code data INT_Data included in the control-management area Cnt_Area of the lowest portion of the flash memory module (FMDL) 6 shown in FIG. 15 in response to an external reset signal RES.

The initialization-control-code data INT_Data thus read out is supplied to peripheral modules, e.g. the externally input/output ports 8 and 9, timer 10 and clock-pulse generator 11, whereby the action modes of the peripheral modules can be initialized. The initialization-control-code data INT_Data which CPU 2 reads out at that time contains the end address EA of the data flash DFL laid out in the flash memory module (FMDL) 6 of FIG. 15.

In system initialization at the time of system reset, e.g. power-on, of MCU 1 of FIG. 1, CPU 2 uses the read end address EA to appropriately set the locations of the data flash DFL and program flash PFL in the flash memory module (FMDL) 6. In the example of FIG. 15, a portion including a series of nonvolatile memory arrays, starting with the nonvolatile memory array MARY_00 specified by the first address in an upper left portion of the flash memory module 6 and ending with the nonvolatile memory array MARY_3M specified by the end address EA, is handled as the data flash DFL, the action mode of which is set initially. Therefore, the series of nonvolatile memory arrays of this portion will function as a data flash DFL for which the highly-reliable two-cell-to-one-bit writing method is adopted. Incidentally, according to the two-cell-to-one-bit writing method, complementary data of one bit are written into a twin cell composed of a pair of nonvolatile memory cells.

Next, CPU 2 sends, as the program flash PFL, a portion including a series of nonvolatile memory arrays, starting with the nonvolatile memory array MARY_40 subsequent to the nonvolatile memory array MARY_3M specified by the end address EA and ending with the last nonvolatile memory array MARY_NM, and fixes the action mode thereof initially. Hence, the series of nonvolatile memory arrays of this portion will function as a program flash PFL for which the one-cell-to-one-bit high-density writing method is adopted. Incidentally, according to the one-cell-to-one-bit writing method, a single piece of data of one bit is written into one nonvolatile memory cell.

As described above, partitioning of the data flash DFL and program flash PFL in the flash memory module (FMDL) 6 can be completed in system initialization at the time of power-on. Now, in the case of changing the partition between the data flash DFL and program flash PFL, CPU 2 rewrites the end address EA contained by the initialization-control-code data INT_Data in the control-management area Cnt_Area of the lowest portion of the flash memory module (FMDL) 6 shown in FIG. 15.

While the invention made by the inventor has been described above based on the embodiments thereof specifically, the invention is not so limited. It will be obvious that various changes and modifications may be made without departing from the scope of the invention.

As to the first aspect, e.g. the program flash for storing various software programs is not limited to the one-cell-to-one-bit writing method. A multivalued and high-density one-cell-to-multiple-bits writing method, by which e.g. quaternary data of two bits or larger is written into a nonvolatile memory cell, can be adopted.

Further, an arrangement that complementary data to be stored in the twin cells of the data flash are accompanied with ECC (Error-Correcting Code) and ECC is added to the multivalued data to be held by the program flash, may be made.

Other than a microcomputer with a built-in flash memory, the invention is widely applicable to a semiconductor integrated circuit which has a built-in nonvolatile memory and is desired to be used in a variety of applications as well as a semiconductor integrated circuit composed of a nonvolatile memory device.

As to the second aspect, e.g. the program flash for storing various software programs is not limited to the one-cell-to-one-bit writing method. A multivalued and high-density one-cell-to-multiple-bits writing method, by which e.g. quaternary data of two bits or larger is written into a nonvolatile memory cell, can be adopted.

Further, an arrangement that complementary data to be stored in the twin cells of the data flash are accompanied with ECC (Error-Correcting Code) and ECC is added to the multivalued data to be held by the program flash, may be made.

Other than a microcomputer with a built-in flash memory, the invention is widely applicable to a semiconductor integrated circuit which has a built-in nonvolatile memory and is desired to be used in a variety of applications as well as a semiconductor integrated circuit composed of a nonvolatile memory device.

1-22. (canceled)

23. A semiconductor integrated circuit,
comprising at least:
a first nonvolatile memory; and
a control unit electrically connected with the first nonvolatile memory,
wherein the first nonvolatile memory is arranged so that complementary data can be electrically written into nonvolatile memory cells in memory cell pairs,
each pair of nonvolatile memory cells can be brought to a blank state by electrically writing non-complementary data into the pair of nonvolatile memory cells before electrically writing complementary data into the pair of nonvolatile memory cells,
the control unit is set to a blank-check action mode in response to a check request to the control unit,
the control unit set to the blank-check action mode can control a blank-check action for detecting presence of a memory cell of the blank state in the first nonvolatile memory,
the control unit cancels the blank-check action mode in response to a cancel request to the control unit, and
the control unit controls the blank-check action on a portion of the first nonvolatile memory of a required memory size between the setting of the control unit to the blank-check action mode and the cancellation of the mode.

24. The semiconductor integrated circuit according to claim 23, wherein after the cancellation of the blank-check action mode, a normal data read on the first nonvolatile memory is enabled.

25. The semiconductor integrated circuit according to claim 24, wherein access information about a target region of the blank-check action in the first nonvolatile memory is set on the control unit before control of the blank-check action by the control unit, and
after setting of the access information on the control unit, the control unit starts the execution of the blank-check action on the target region of the first nonvolatile memory.

26. The semiconductor integrated circuit according to claim 23, further comprising at least: a central processing unit; and a second nonvolatile memory,
wherein the second nonvolatile memory is arranged so that data can be electrically written into nonvolatile memory cells on a cell-by-cell basis,
a program for the central processing unit can be stored in the second nonvolatile memory, and
after the central processing unit has executed a program stored in the second nonvolatile memory, data resulting from the execution can be stored in the first nonvolatile memory.

27. The semiconductor integrated circuit according to claim 26, further comprising a control unit, a built-in random access memory, a high-speed bus, and a peripheral bus,
wherein the first and second nonvolatile memories form a built-in nonvolatile memory,
the control unit is connected with a low-speed access port of the built-in nonvolatile memory through the peripheral bus,
the central processing unit is connected with the built-in random access memory, and a high-speed access port of the built-in nonvolatile memory through the high-speed bus,
the central processing unit can read data stored in the first nonvolatile memory and a program stored in the second nonvolatile memory through the high-speed bus and the high-speed access port of the built-in nonvolatile memory, and
the control unit stores data stored in the first nonvolatile memory and a program stored in the second nonvolatile memory in the built-in nonvolatile memory through the low-speed bus and low-speed access port in response to a direction from the central processing unit.

28. The semiconductor integrated circuit according to claim 26, wherein each cell of one pair of nonvolatile memory cells of the first nonvolatile memory and one nonvolatile memory cell of the second nonvolatile memory is arranged so that a nonvolatile storing action is conducted by injection of electrons into a charge-accumulating layer and emission of electrons from the charge-accumulating layer.

29. The semiconductor integrated circuit according to claim 26, wherein a first nonvolatile storing action and a first verify-read action are repeated on one cell of each pair of nonvolatile memory cells in the first nonvolatile memory, and
a second nonvolatile storing action and a second verify-read action are repeated on each nonvolatile memory cell in the second nonvolatile memory.

30. The semiconductor integrated circuit according to claim 26, wherein multivalued data of two bits or larger can be electrically written into one nonvolatile memory cell of the second nonvolatile memory.

31. The semiconductor integrated circuit according to claim 26, wherein locations of the first and second nonvolatile memories in the built-in nonvolatile memory can be set according to initialization-control-code data used for system initialization of the semiconductor integrated circuit.

32. A semiconductor integrated circuit,
comprising at least:
a first nonvolatile memory; and
a control unit electrically connected with the first nonvolatile memory,
wherein the first nonvolatile memory is arranged so that complementary data can be electrically written into nonvolatile memory cells in memory cell pairs,
each pair of nonvolatile memory cells can be brought to a blank state by electrically writing non-complementary data into the pair of nonvolatile memory cells before electrically writing complementary data into the pair of nonvolatile memory cells,
the control unit includes a controller, a blank-check-setting register, a blank-check-signal detector circuit, and a blank-address-storing register,
the controller stores access information about a target region for a blank-check action in the first nonvolatile memory supplied to the control unit in the blank-check-setting register,
the controller creates a blank-check address to be supplied to the first nonvolatile memory according to a request to the control unit and the access information stored in the blank-check-setting register,
a blank-check action for detecting presence of a memory cell of the blank state is executed according to the blank-check address in the first nonvolatile memory, and the first nonvolatile memory keeps producing a blank-check signal having a predetermined signal level while a memory cell of the blank state is present,
the blank-check signal produced by the first nonvolatile memory is supplied to the blank-check-signal detector circuit of the control unit, and
address information of a nonvolatile memory cell of the blank state, which is present in the target region for the blank-check action in the first nonvolatile memory is stored in the blank-address-storing register in response to an output signal of the blank-check-signal detector circuit.

33. The semiconductor integrated circuit according to claim 32, further comprising at least: a central processing unit; and a second nonvolatile memory,
wherein the second nonvolatile memory is arranged so that data can be electrically written into nonvolatile memory cells on a cell-by-cell basis,
a program for the central processing unit can be stored in the second nonvolatile memory, and
after the central processing unit has executed a program stored in the second nonvolatile memory, data resulting from the execution can be stored in the first nonvolatile memory.

34. The semiconductor integrated circuit according to claim 33, further comprising a control unit, a built-in random access memory, a high-speed bus, and a peripheral bus,
wherein the first and second nonvolatile memories form a built-in nonvolatile memory,
the control unit is connected with a low-speed access port of the built-in nonvolatile memory through the peripheral bus,
the central processing unit is connected with the built-in random access memory, and a high-speed access port of the built-in nonvolatile memory through the high-speed bus,
the central processing unit can read data stored in the first nonvolatile memory and a program stored in the second nonvolatile memory through the high-speed bus and the high-speed access port of the built-in nonvolatile memory, and
the control unit stores data stored in the first nonvolatile memory and a program stored in the second nonvolatile memory in the built-in nonvolatile memory through the low-speed bus and low-speed access port in response to a direction from the central processing unit.

35. The semiconductor integrated circuit according to claim 33, wherein each cell of one pair of nonvolatile memory cells of the first nonvolatile memory and one nonvolatile memory cell of the second nonvolatile memory is arranged so that a nonvolatile storing action is conducted by injection of electrons into a charge-accumulating layer and emission of electrons from the charge-accumulating layer.

36. The semiconductor integrated circuit according to claim 33, wherein a first nonvolatile storing action and a first verify-read action are repeated on one cell of each pair of nonvolatile memory cells in the first nonvolatile memory, and
a second nonvolatile storing action and a second verify-read action are repeated on each nonvolatile memory cell in the second nonvolatile memory.

37. The semiconductor integrated circuit according to claim 33, wherein multivalued data of two bits or larger can be electrically written into one nonvolatile memory cell of the second nonvolatile memory.

38. The semiconductor integrated circuit according to claim 33, wherein locations of the first and second nonvolatile memories in the built-in nonvolatile memory can be set according to initialization-control-code data used for system initialization of the semiconductor integrated circuit.

39. A method of operation for a semiconductor integrated circuit having at least a first nonvolatile memory, and a control unit electrically connected with the first nonvolatile memory,
wherein the first nonvolatile memory is arranged so that complementary data can be electrically written into nonvolatile memory cells in memory cell pairs,
each pair of nonvolatile memory cells can be brought to a blank state by electrically writing non-complementary data into the pair of nonvolatile memory cells before electrically writing complementary data into the pair of nonvolatile memory cells,
the control unit includes a controller, a blank-check-setting register, a blank-check-signal detector circuit, and a blank-address-storing register,
the controller stores access information about a target region for a blank-check action in the first nonvolatile memory supplied to the control unit in the blank-check-setting register,
the controller creates a blank-check address to be supplied to the first nonvolatile memory according to a request to the control unit and the access information stored in the blank-check-setting register,
a blank-check action for detecting presence of a memory cell of the blank state is executed according to the blank-check address in the first nonvolatile memory, and the first nonvolatile memory keeps producing a blank-check signal having a predetermined signal level while a memory cell of the blank state is present,
the blank-check signal produced by the first nonvolatile memory is supplied to the blank-check-signal detector circuit of the control unit, and
address information of a nonvolatile memory cell of the blank state, which is present in the target region for the blank-check action in the first nonvolatile memory is stored in the blank-address-storing register in response to an output signal of the blank-check-signal detector circuit.

40. The method according to claim 39, wherein the semiconductor integrated circuit further includes at least a central processing unit, and a second nonvolatile memory,
the second nonvolatile memory is arranged so that data can be electrically written into nonvolatile memory cells on a cell-by-cell basis,
a program for the central processing unit can be stored in the second nonvolatile memory, and
after the central processing unit has executed a program stored in the second nonvolatile memory, data resulting from the execution can be stored in the first nonvolatile memory.

41. The method according to claim 40, wherein the first and second nonvolatile memories form a built-in nonvolatile memory,
the semiconductor integrated circuit further includes a control unit, a built-in random access memory, a high-speed bus, and a peripheral bus,
the control unit is connected with a low-speed access port of the built-in nonvolatile memory through the peripheral bus,
the central processing unit is connected with the built-in random access memory, and a high-speed access port of the built-in nonvolatile memory through the high-speed bus,
the central processing unit can read data stored in the first nonvolatile memory and a program stored in the second nonvolatile memory through the high-speed bus and the high-speed access port of the built-in nonvolatile memory, and
the control unit stores data stored in the first nonvolatile memory and a program stored in the second nonvolatile memory in the built-in nonvolatile memory through the low-speed bus and low-speed access port in response to a direction from the central processing unit.

42. The method according to claim 40, wherein each cell of one pair of nonvolatile memory cells of the first nonvolatile memory and one nonvolatile memory cell of the second nonvolatile memory is arranged so that a nonvolatile storing action is conducted by injection of electrons into a charge-accumulating layer and emission of electrons from the charge-accumulating layer.

43. The method according to claim 40, wherein a first nonvolatile storing action and a first verify-read action are repeated on one cell of each pair of nonvolatile memory cells in the first nonvolatile memory, and
a second nonvolatile storing action and a second verify-read action are repeated on each nonvolatile memory cell in the second nonvolatile memory.

44. The method according to claim 40, wherein multivalued data of two bits or larger can be electrically written into one nonvolatile memory cell of the second nonvolatile memory.

45. The method according to claim 40, wherein locations of the first and second nonvolatile memories in the built-in nonvolatile memory can be set according to initialization-control-code data used for system initialization of the semiconductor integrated circuit.
